(19) United States
(12) Patent Application Publication
(10) Pub. No.: US 2012/0011360 A1
(43) Pub. Date: Jan. 12, 2012

(54) KEY MANAGEMENT SYSTEMS AND METHODS FOR SHARED SECRET CIPHERS

(76) Inventors: Daniel W. Engels, Colleyville, TX (US); Kenneth Alan Lauffenburger, Plano, TX (US); Troy Hicks, Allen, TX (US)

(21) Appl. No.: 13/160,388

(22) Filed: Jun. 14, 2011

Related U.S. Application Data
(60) Provisional application No. 61/354,697, filed on Jun. 14, 2010.

(51) Int. Cl. H04L 9/32; H04L 9/00; H04L 9/08; H04L 29/06

(52) U.S. Cl. 713/166; 380/277; 713/168; 380/278; 713/171

(57) ABSTRACT

Various embodiments are described herein for a Key Management System (KMS) and associated methods for providing authentication and secure shared key distribution capabilities without revealing a device's secret key. The KMS allows one or more accessing applications or devices residing on a variety of systems and associated with a plurality of organizations to efficiently authenticate other applications or devices with which they are in communication and to securely establish a shared secret between authenticated applications or devices. Secret keys may be cached throughout the KMS system for off-line and efficient operations. The KMS system enables authentication of devices and secure communication between these devices which may have been created and secured under different domains without those domains having an a priori relationship.

### CROSS-REFERENCE

This application claims priority from U.S. Provisional Patent Application Ser. No. 61/354,697 filed on Jun. 14, 2010.

### FIELD

The embodiments described herein generally relate to systems and methods for managing cipher keys in one or more domains and in particular to systems and method for managing cipher keys for shared secret ciphers in one or more domains.

### BACKGROUND

Automated machine-to-machine (or device-to-device) communications are becoming commonplace throughout monitoring and control applications. The broad deployment of technologies utilizing machine-to-machine communications, such as wireless sensor networks, has been coupled with an increased need to secure the communications between these devices.

For example, mobile devices and smart objects, such as cellular telephones, ad hoc sensor devices, and radio frequency identification (RFID) devices, are essential components in the ever more ubiquitous networked information systems that underlie a multitude of valuable applications and services. Information is constantly being captured by, generated by, and moving to and from mobile devices. This electronic information is increasingly critical and can include sensitive personal and business information used for financial, security, and other applications traditionally performed by large databases and servers. The use and dependence upon mobile devices for critical applications has made them targets of electronic, networked, and other attacks. Combined with their constant use of networked connectivity, these mobile electronic assets are vulnerable to attacks originating anywhere in the world. Consequently, mobile devices and smart objects require a similar level of security functionality as is provided by their resource rich server and database counterparts.

However, mobile devices and smart objects are resource limited. Therefore, many security services are typically supported by or provided by a local security domain authority. Domain authorities may provide a range of security services, such as session key establishment, identity authentication, and data integrity. The security services provided by a domain authority facilitate the secure communications and secure operations of mobile devices operating within its domain. This security is achieved primarily through the use of cryptography. As such, the security services rely upon cryptographic ciphers and are dependent upon the domain authority having, or accessing in some way, the cryptographic keys (public keys and/or secret keys) used by the devices within its domain.

Mobility complicates the delivery of security services, particularly as mobile devices move from one security domain to another, because of the need to securely distribute keys across security domains. Consequently, multi-domain security services are critical components in the use of secured mobile devices and smart objects. Mobile devices whose cryptographic keys are stored by the local domain authority obtain services easily since the local domain has the device's cryptographic keys required for the security services. However, foreign mobile devices require the local domain authority to be in communication with either the foreign device's home domain authority, typically the domain that assigned the device's keys, or a proxy for that device's home domain authority that has either the device's keys or sufficient cryptographic data to enable the desired security service. Accordingly, mobile and smart devices maintain security services and authentication across multiple domains in order to continuously provide their full capabilities. Furthermore, the widespread and ubiquitous adoption of mobile devices increases the need for domain authorities to communicate, as well as dramatically increasing the number of potential domain authorities with which each domain authority communicates.

The traditional approach to multi-domain security services, including identity authentication, is to maintain a peer-to-peer relationship between domain authorities. The establishment and maintenance of a relationship with another domain authority may involve complex and potentially expensive operations and procedures. As the number of domain authority relationships grows, the establishment and maintenance of these peer to-peer a priori relationships becomes unwieldy and difficult to maintain in practice. Furthermore, when a device from a new domain is encountered, secure services cannot be provided to that device until a relationship is established with the new domain, thereby limiting the benefits of mobility.

Secured communications require the use of a cryptographic algorithm, either symmetric or asymmetric, to prevent a range of attacks on the communications, the machines and the information systems themselves. In a broad range of applications it is often required that two machines, or devices, need to interact without prior knowledge of one another. In these cases, the devices normally use a trusted third party in order to authenticate one another's identity and to establish a secure communication channel.

For asymmetric ciphers, such as Elliptic Curve Cryptography (ECC) and RSA, a PKI (Public Key Infrastructure) system is commonly utilized. Such asymmetric ciphers use a public key and a private key. The public key is made available to anyone, while the private key is a secret key that is generally not shared with any other devices (except possibly the key generation system used by that device).

The PKI system may be used to generate and assign public-private keys to devices. Regardless of how keys are assigned to a device, a device authenticates itself to the PKI system, typically through some out of band method. By authenticating itself to the PKI system, the device receives a digital certificate signed by the PKI system that indicates that the PKI system has authenticated the device and the association of the public key with that device. The certificate is a file containing an encrypted portion, encrypted by the PKI authority's private key, which binds the device's identity to its public key. The device's certificate is stored on the device itself.

When two or more devices first interact they will exchange certificates. Each device will then use the appropriate PKI authority's public key to authenticate the certificate, thereby authenticating the identity of the other device. Each device determines if the authority is a trusted authority for that device, typically by consulting a list of trusted authorities with their public keys that is stored on the device.

If the devices trust the certificates, then they may use one another's public keys for secure communication. It is common that the first secure communication using the asymmetric cipher is the exchange of a private key for use with a symmetric cipher with the symmetric cipher used thereafter for secure communications.

The infrastructure to support this certificate mechanism requires only intermittent connectivity between PKI authorities. Multiple PKI authorities exist, however, there are only a few root certificate authorities to which all other authorities may authenticate and chain themselves. PKI authorities need not chain themselves to any PKI root authority.

A process exists for which a PKI authority authenticates a device and generates a certificate. This process may be unique for each authority. Each authority distributes its own public key, and devices may obtain these public keys directly from each authority.

By storing the authority keys within each device, the devices may operate without network connectivity since certificates are carried by each device. However, when a certificate is revoked (e.g., due to a security breach), the revocation of that certificate is handled through a separate channel, called a revocation list. A device may consult a revocation list (but is not required to do so), when it is authenticating the certificate of another device.

In this framework, truly secure operation and authentication requires the revocation list to be consulted when authenticating every device. Failure to consult the revocation list may result in a device being authenticated even though its certificate has been deemed to be invalid by the larger system (e.g. due to a security breach).

One issue with consulting the revocation list is the lack of infrastructure designed specifically to facilitate its communication to all devices. The net result is that the PKI system is effectively a single domain system with a single flat level of hierarchy, which limits the scalability of PKI systems.

Furthermore, in order to chain a PKI authority to a root PKI authority, a complex and expensive process is needed. This further limits the scalability and usability of the system, and it may allow for successful attacks in long chains.

Finally, while a PKI system has been made to work for the public-private key cryptographic ciphers, it does not work with symmetric or shared-key ciphers.

For symmetric ciphers, domain specific key management and authentication systems have been developed. Perhaps the most widely deployed and prototypical example of these systems is the Kerberos system developed at the Massachusetts Institute of Technology (MIT).

Kerberos is a trusted third party (TTP) system that uses symmetric ciphers to authenticate the identity of machines based upon knowledge of a shared secret with the Kerberos system and to securely assign a shared secret session key to machines requesting to communicate securely with one another. Kerberos is domain specific as it operates only within a specific security domain, or network of machines. The Kerberos system is defined in RFC 1510.

The Kerberos system uses a series of encrypted messages to prove to the Kerberos server that a machine knows a shared secret with the Kerberos server. Kerberos is used to authenticate all machines that wish to communicate (typically, Kerberos is used to authenticate two machines for a pair-wise communication, i.e. one machine to another machine).

After all machines are authenticated, the Kerberos server uses each machine's secret key that is shared with the Kerberos server to encrypt a message that includes a secret key to be shared with the other authenticated machines, called a session key, that is then sent to that machine.

Since all authenticated machines that wish to communicate are sent the same session key, they may use that key and a symmetric key cipher to communicate securely with one another.

One limitation of the Kerberos system is that it is computer system domain specific. For example, Kerberos does not work in a general public environment where devices may originate from any domain. A device must be registered with a domain's Kerberos system prior to the device requesting to be authenticated while it is communicating within that domain. Furthermore, Kerberos works with symmetric key ciphers only, and it does not work with asymmetric ciphers such as ECC or RSA.

### SUMMARY OF VARIOUS EMBODIMENTS

In one aspect, in at least one example embodiment described herein, there is provided a system for the provision of cryptographic key management services (KMS). The system comprises a KMS domain authority server layer including at least one KMS authority server configured to manage cryptographic keys for a first domain; and a root KMS server layer including at least one KMS root server, the root KMS server layer being linked to the authority KMS server layer, the at least one KMS root server being configured to communicate with applications and devices that make security requests to the system when there are no other layers in the system, wherein, the layers are organized in a hierarchy such that each layer has a different security level.

In at least one embodiment, the system may further comprise an intermediate KMS server layer including at least one KMS distribute server, the intermediate KMS server layer being linked to the root KMS server layer and wherein servers in at least one of the root KMS server layer and the intermediate KMS server layer are configured to communicate with applications and devices that make security requests to the system when there are no other layers in the system.

In at least one embodiment, the system may further comprise a resolver KMS server layer including at least one KMS local server, the resolver KMS server layer being linked to the intermediate KMS server layer and wherein servers in at least one of the root KMS server layer, the intermediate KMS server layer and the resolver KMS server layer are configured to communicate with applications and devices that make security requests to the system.

In at least one embodiment, the system may further comprise a resolver KMS server layer including at least one KMS local server, the resolver KMS server layer being linked to the root KMS server layer and wherein servers in at least one of the root KMS server layer and the resolver KMS server layer are configured to communicate with applications and devices that make security requests to the system.

In at least one embodiment, the at least one KMS authority server is connected to the at least one KMS root server.

In at least one embodiment, the KMS domain authority server layer further comprises a KMS top level domain server connected to the at least one KMS authority server and the at least one KMS root server.

In at least one embodiment, the intermediate KMS server layer comprises at least two sub-layers having different security levels.

In at least one embodiment, the at least one KMS authority server contains all of the cryptographic keys required for authenticating devices and applications that are associated with the first domain, the at least one KMS root server contains a subset of the cryptographic keys contained by the at least one KMS authority server and the at least one KMS distribute server contains a subset of the cryptographic keys contained by the at least one KMS root server.

In at least one embodiment, each layer is assigned a different security level and wherein the KMS domain authority server layer is assigned a higher security level than the root KMS server layer, the root KMS server layer is assigned a higher security level than the intermediate KMS server layer, and the intermediate KMS server layer is assigned a higher security level than the resolver KMS server layer.

In at least one embodiment, the layers are configured to propagate each security request from the device or application to servers in successively higher layers until a server is located with the required information to facilitate the security request.

In at least one embodiment, at least one server in the root KMS server layer, the intermediate KMS server layer and the resolver KMS server layer is configured to cache information including at least one of queries, query results, cryptographic keys and cryptographic conversations based on a specified set of security levels for each domain.

In at least one embodiment, the at least one server in the root KMS server layer, the intermediate KMS server layer and the resolver KMS server layer is configured to respond to the security request if the at least one server contains a cached query result that corresponds to the security request or if the at least one server contains cryptographic information that corresponds to the security request and is configured to calculate a result based on the stored cryptographic information.

In at least one embodiment, at least one server in at least one of the root KMS server layer, the intermediate KMS server layer and the resolver KMS server layer comprises a key store and is configured to perform computations required for a cryptographic conversation with the device or application.

In at least one embodiment, at least one KMS local server is configured to resolve domain names associated with the at least one KMS authority server to obtain direct access to the at least one KMS authority server thereby creating a two-level hierarchy within the system.

In at least one embodiment, at least one server at a given layer is configured to implement a PUSH operation to send cryptographic information comprising at least one cryptographic key or at least one cryptographic conversation to at least one server in a lower layer in the system provided the at least one server at the lower layer has an appropriate security level to receive the cryptographic information.

In at least one embodiment, at least one server at a given layer beneath the KMS domain authority server layer is configured to implement a PULL operation to receive cryptographic information comprising at least one cryptographic key or at least one cryptographic conversation from at least one server in a higher layer in the system provided the at least one server at the given layer has an appropriate security level to receive the cryptographic information.

In at least one embodiment, the root KMS server layer comprises a set of KMS root servers.

In at least one embodiment, the system is used to provide cryptographic services for multiple domains and wherein at least one KMS authority server is associated with each domain.

In at least one embodiment, the first domain is a parent domain and the system comprises a subsystem associated with a child domain wherein the subsystem comprises a second KMS domain authority server layer, a second root KMS server layer, a second intermediate KMS server layer; and a second resolver KMS server layer and wherein a KMS root server of the second root KMS server layer is connected to a KMS distribute server of the intermediate KMS server layer associated with the parent domain, whereby the child domain is nestled within the parent domain.

In at least one embodiment, if any of the servers in the child domain cannot service the security request, the KMS root server in the child domain is configured to propagate the security request to KMS servers associated with the parent domain having a security level equal to or higher than the security level of the intermediate KMS server layer associated with the parent domain.

In at least one embodiment, the at least one KMS root server is connected to a KMS root server associated with a parent domain and if any of the servers in the first domain cannot service the security request, the at least one KMS root server in the first domain is configured to propagate the security request to the KMS root server associated with the parent domain and if the KMS root server associated with the parent domain cannot service the security request, the KMS root server associated with the parent domain is configured to propagate the request to a KMS root server associated with another domain.

In at least one embodiment, the servers in the system are configured to use one of a Hummingbird symmetric cipher, an Advanced Encryption Standard cipher, an Elliptic Curve Cryptographic cipher and an RSA encryption cipher.

In at least one embodiment, the servers in the system are configured to use any one of a symmetric cipher or an asymmetric cipher and a public cryptographic technique or a private cryptographic technique.

In at least one embodiment, the at least one KMS authority server comprises distribution access control lists that specify cryptographic information that can be shared with certain servers associated with other layers in the system or certain servers, devices or applications associated with other domains.

In at least one embodiment, when the distribution control lists comprise a distribution white list, all entities requesting data from the at least one authority server must be authenticated and on the distribution white list in order to receive the data.

In at least one embodiment, when the distribution control lists comprise a distribution black list, all entities requesting data from the at least one authority server must be authenticated and not on the distribution black list in order to receive the data.

In at least one embodiment, the at least one KMS local server is configured to provide resolve services using at least one of a Domain Name System (DNS) and a Secure Domain Name System (DNSSEC).

In at least one embodiment, portions of cryptographic conversations are transmitted between the layers of the system to anonymously authenticate the device that makes the security request.

In another aspect, in at least one example embodiment described herein, there is provided a system for the provision of cryptographic key management services (KMS). The system comprises a KMS domain authority server layer including at least one KMS authority server configured to manage cryptographic keys for a domain; a root KMS server layer including at least one KMS root server, the root KMS server layer being linked to the authority KMS server layer; an intermediate KMS server layer including at least one KMS distribute server, the intermediate KMS server layer being linked to the root KMS server layer; and a resolver KMS server layer including at least one KMS local server, the resolver KMS server layer being linked to the intermediate KMS server layer. The servers in at least one of the root KMS server layer, the intermediate KMS server layer and the resolver KMS server layer are configured to communicate with applications and devices that make security requests to the system, and at least one server in at least one of the root KMS server layer, the intermediate KMS server layer and the resolver KMS server layer comprises a key store and is configured to perform computations required for a cryptographic conversation with the device or application to service the security request.

In another aspect, in at least one example embodiment described herein, there is provided a system for the provision of cryptographic key management services (KMS). The system comprises a KMS domain authority server layer including at least one KMS authority server configured to manage cryptographic keys for a first domain; a root KMS server layer including at least one KMS root server, the root KMS server layer being linked to the authority KMS server layer; an intermediate KMS server layer including at least one KMS distribute server, the intermediate KMS server layer being linked to the root KMS server layer; and a resolver KMS server layer including at least one KMS local server, the resolver KMS server layer being linked to the intermediate KMS server layer. Servers in at least one of the root KMS server layer, the intermediate KMS server layer and the resolver KMS server layer are configured to communicate with applications and devices that make security requests to the system, and the at least one KMS root server is configured to propagate the security request to a KMS root server or a KMS distribute server associated with a different system of another domain thereby allowing the system to authenticate and securely communicate with devices or applications associated with different domains.

In another aspect, in at least one example embodiment described herein, there is provided a system for the provision of cryptographic key management services (KMS). The system comprises a KMS domain authority server layer including a plurality of KMS authority servers, each KMS domain authority server being configured to manage cryptographic keys for different domains; a root KMS server layer including at least one KMS root server, the root KMS server layer being linked to the authority KMS server layer; an intermediate KMS server layer including at least one KMS distribute server, the intermediate KMS server layer being linked to the root KMS server layer; and a resolver KMS server layer including at least one KMS local server, the resolver KMS server layer being linked to the intermediate KMS server layer. The servers in at least one of the root KMS server layer, the intermediate KMS server layer and the resolver KMS server layer are configured to communicate with applications and devices that make security requests to the system, and the security requests are propagated to the KMS domain authority server of the domain associated with the device or application in order to provide authentication and distribution of at least one of cryptographic keys and cryptographic conversations between two or more of the different domains.

In another aspect, in at least one example embodiment described herein, there is provided a method for the provision of cryptographic key management services (KMS) in a system. The method comprises associating at least one KMS authority server with a KMS domain authority server layer having a first security level; configuring the at least one KMS authority server to manage cryptographic keys for a first domain; associating at least one KMS root server with a root KMS server layer having a second security level; linking the root KMS server layer to the authority KMS server layer; and configuring the at least one KMS root server to communicate with applications and devices that make security requests to the system when there are no other layers in the system.

In at least one embodiment, the method further comprises associating at least one KMS distribute server with an intermediate KMS server layer; linking the intermediate KMS server layer to the root KMS server layer; and configuring the servers in at least one of the root KMS server layer and the intermediate KMS server layer to communicate with applications and devices that make security requests to the system when there are no other layers in the system.

In at least one embodiment, the method further comprises associating at least one KMS local server with a resolver KMS server layer; linking the resolver KMS server layer to the intermediate KMS server layer; and configuring the servers in at least one of the root KMS server layer, the intermediate KMS server layer and the resolver KMS server layer to communicate with applications and devices that make security requests to the system.

In at least one embodiment, the method further comprises associating at least one KMS local server with a resolver KMS server layer; linking the resolver KMS server layer to the root KMS server layer; and configuring the servers in at least one of the root KMS server layer and the resolver KMS server layer to communicate with applications and devices that make security requests to the system.

In at least one embodiment, the method further comprises linking the at least one KMS authority server with the at least one KMS root server.

In at least one embodiment, the method further comprises associating a KMS top level domain server with the KMS domain authority server layer and linking the KMS top level domain server to the at least one KMS authority server and the at least one KMS root server.

In at least one embodiment, the method further comprises defining at least two sub-layers having different security levels in the intermediate KMS server layer.

In at least one embodiment, the method comprises providing the at least one KMS authority server with all of the cryptographic keys required for authenticating devices and applications that are associated with the first domain; providing the at least one KMS root server with a subset of the cryptographic keys contained by the at least one KMS authority server; and providing the at least one KMS distribute server with a subset of the cryptographic keys contained by the at least one KMS root server.

In at least one embodiment, the method further comprises assigning each layer a different security level and wherein the method comprises assigning the KMS domain authority server layer a higher security level than the root KMS server layer, assigning the root KMS server layer a higher security level than the intermediate KMS server layer, and assigning the intermediate KMS server layer a higher security level than the resolver KMS server layer.

In at least one embodiment, the method further comprises configuring the layers to propagate each security request from the device or application to servers in successively higher layers until a server is located with the required information to facilitate the security request.

In at least one embodiment, the method further comprises configuring at least one server in the root KMS server layer, the intermediate KMS server layer and the resolver KMS server layer to cache information including at least one of queries, query results, cryptographic keys and cryptographic conversations based on a specified set of security levels for each domain.

In at least one embodiment, the method further comprises configuring at least one server in the root KMS server layer, the intermediate KMS server layer and the resolver KMS server layer to respond to the security request if the at least one server contains a cached query result that corresponds to the security request or if the at least one server contains cryptographic information that corresponds to the security request and is configured to calculate a result based on the stored cryptographic information.

In at least one embodiment, the method further comprises providing a key store to at least one server in at least one of the root KMS server layer, the intermediate KMS server layer and the resolver KMS server layer and configuring the at least one server with the key store to perform computations required for a cryptographic conversation with the device or application.

In at least one embodiment, the method further comprises configuring at least one KMS local server to resolve domain names associated with the at least one KMS authority server to obtain direct access to the at least one KMS authority server thereby creating a two-level hierarchy within the system.

In at least one embodiment, the method further comprises configuring at least one server at a given layer to implement a PUSH operation to send cryptographic information comprising at least one cryptographic key or at least one cryptographic conversation to at least one server in a lower layer in the system provided the at least one server at the lower layer has an appropriate security level to receive the cryptographic information.

In at least one embodiment, the method further comprises configuring at least one server at a given layer beneath the KMS domain authority server layer to implement a PULL operation to receive cryptographic information comprising at least one cryptographic key or at least one cryptographic conversation from at least one server in a higher layer in the system provided the at least one server at the given layer has an appropriate security level to receive the cryptographic information.

In at least one embodiment, the method further comprises associating a set of KMS root servers in the root KMS server layer.

In at least one embodiment, the system is used to provide cryptographic services for multiple domains and the method further comprises associating at least one KMS authority server with each domain.

In at least one embodiment, the first domain is a parent domain and the method further comprises associating a subsystem with a child domain, associating a second KMS domain authority server layer, a second root KMS server layer, a second intermediate KMS server layer and a second resolver KMS server layer with the subsystem, and connecting a KMS root server of the second root KMS server layer to a KMS distribute server of the intermediate KMS server layer associated with the parent domain, whereby the child domain is nestled within the parent domain.

In at least one embodiment, if any of the servers in the child domain cannot service the security request, the method further comprises configuring the KMS root server in the child domain to propagate the security request to KMS servers associated with the parent domain having a security level equal to or higher than the security level of the intermediate KMS server layer associated with the parent domain.

In at least one embodiment, the at least one KMS root server is connected to a KMS root server associated with a parent domain and if any of the servers in the first domain cannot service the security request, the method further comprises configuring the at least one KMS root server in the first domain to propagate the security request to the KMS root server associated with the parent domain and if the KMS root server associated with the parent domain cannot service the security request, the method further comprises configuring the KMS root server associated with the parent domain to propagate the request to a KMS root server associated with another domain.

In at least one embodiment, the method further comprises configuring the servers in the system to use one of a Hummingbird symmetric cipher, an Advanced Encryption Standard cipher, an Elliptic Curve Cryptographic cipher and an RSA encryption cipher.

In at least one embodiment, the method further comprises configuring the servers in the system to use any one of a symmetric cipher or an asymmetric cipher and a public cryptographic technique or a private cryptographic technique.

In at least one embodiment, the method further comprises providing the at least one KMS authority server with distribution access control lists that specifies cryptographic information that can be shared with certain servers associated with other layers in the system or certain servers, devices or applications associated with other domains.

In at least one embodiment, when the distribution control lists comprise a distribution white list, the method further comprises requiring all entities requesting data from the at least one authority server to be authenticated and to be on the distribution white list in order to receive the data.

In at least one embodiment, when the distribution control lists comprise a distribution black list, the method further comprises requiring all entities requesting data from the at least one authority server to be authenticated and not on the distribution black list in order to receive the data.

In at least one embodiment, the method further comprises configuring the at least one KMS local server to provide resolve services using at least one of a Domain Name System (DNS) and a Secure Domain Name System (DNSSEC).

In at least one embodiment, the method further comprises transmitting portions of cryptographic conversations between the layers of the system to anonymously authenticate the device that makes the security request.

In another aspect, in at least one example embodiment described herein, there is provided a method of providing security services from a Key Management Services (KMS) system to a device requesting a service. The method comprises sending a query from a server interface in the KMS system to the device; obtaining an initialization vector (iv) and a device vector (dv) from the device at the server interface; generating a Tag Authentication Request (TAR) packet at the server interface based on a unique session identifier (sid), a type code identifying a type of response expected, the iv, and the dv; and sending the TAR packet from the interface server to a KMS server at a higher level in the KMS system to obtain the requested service.

In at least one embodiment, the method further comprises generating a secure session identifier (ssid) at the server interface and including the ssid in the query and the TAR packet.

In at least one embodiment, the method further comprises creating a session record at the KMS server in response to the TAR packet using the sid as a reference; initiating a search of a key list at the KMS server using parameters in the TAR packet; and sending an affirmative authentication (AA) packet from the KMS server to the server interface if the search was successful and a matching key was found, the AA packet having a type based on the type code.

In at least one embodiment, the method further comprises generating the AA packet at the KMS server by generating a random challenge vector; generating a reader_rsp vector and a first tag_rsp vector as challenge response vectors using the matching key and a Hummingbird encryption algorithm initialized with the iv; and including the sid, the challenge vector, the reader_rsp vector, and the first tag_rsp vector in the AA packet.

In at least one embodiment, the upon receiving the AA packet sent from the KMS server to the server interface, the method further comprises canceling a retry timer at the server interface if the retry timer was set when the TAR packet was sent by the server interface; and forwarding the challenge vector and reader_rsp vector from the server interface to the device.

In at least one embodiment, at the device the method further comprises generating a corresponding response vector using the challenge vector, the reader_rsp vector and a current encryption engine state at the device; comparing the corresponding response vector with the reader_rsp vector; and authenticating the server interface if the corresponding response vector and the reader_rsp vector match.

In at least one embodiment, the method further comprises generating a second tag_rsp vector based on the current state of the encryption engine at the device; transmitting the second tag_rsp vector from the device to the server interface; comparing the second tag_rsp vector from the device with the first tag_rsp vector received from the KMS server at the server interface; and authenticating the device at the server interface if the first and second tag_rsp vectors match.

In at least one embodiment, the method further comprises beginning a command phase when the first and second tag_rsp vectors match.

In at least one embodiment, the method further comprises transmitting the TAR packet using an IPsec transport mode AH.

In at least one embodiment, the method further comprises transmitting the AA packet from the KMS server using an IPsec transport mode ESP packet.

In at least one embodiment, the method further comprises using an IPsec AH digest at the KMS server to authenticate the TAR packet.

In at least one embodiment, the method further comprises employing a Hummingbird encryption protocol.

In at least one embodiment, the method further comprises generating the AA packet at the KMS server by generating a session key from a series of cipher text values using the iv, the dv and the matching key; generating a random challenge vector; generating a reader_rsp vector and a first tag_rsp vector as challenge response vectors using the matching key and a Hummingbird encryption algorithm initialized with the iv; generating an encoded genSessionKey command using a Hummingbird decryption process; and including the sid, the challenge response vector, the reader_rsp vector, the first tag_rsp vector, the session key and the encoded genSessionKey command in the AA packet.

In at least one embodiment, wherein upon receiving the AA packet sent from the KMS server to the server interface, the method further comprises canceling a retry timer at the server interface if the retry timer was set when the TAR packet was sent by the server interface; and forwarding the challenge vector and the reader_rsp vector from the server interface to the device.

In at least one embodiment, wherein upon receiving the AA packet sent from the KMS server to the server interface, the method further comprising storing the session key at the server interface.

In at least one embodiment, at the device the method further comprises generating a corresponding response vector using the challenge vector, the reader_rsp vector and a current state of a first encryption engine at the device; comparing the corresponding response vector with the reader_rsp vector; and authenticating the server interface if the corresponding response vector and the reader_rsp vector match.

In at least one embodiment, the method further comprises generating a second tag_rsp vector based on the current state of the first encryption engine at the device; transmitting the second tag_rsp vector from the device to the server interface; comparing the second tag_rsp vector from the device with the first tag_rsp vector received from the KMS server at the server interface; and authenticating the device at the server interface if the first and second tag_rsp vectors match.

In at least one embodiment, the method further comprises sending the encoded genSessionKey command from the server interface to the device; decoding the encoded genSessionKey command at the device using a current state of a Hummingbird encryption engine at the device; generating a second session key from a series of cipher text values at the device wherein the second session key matches the session key generated by the KMS server; and loading the second session key into the Hummingbird encryption engine at the device and initializing the Hummingbird encryption engine using the iv to ready the device for subsequent data transformations.

In at least one embodiment, the method further comprises loading an encryption engine at the server interface with the session key from the AA packet and initializing the encryption engine using the iv from the session record.

In at least one embodiment, the method further comprises using a current state of the encryption engine at the device to generate a first session key check vector and sending the first session key check vector to the server interface.

In at least one embodiment, the method further comprises using a current state of a second encryption engine at the server interface to generate a second session key check vector using a procedure similar to that used by the device; comparing the second session key check vector with the first session key check vector received from the device at the server interface; and validating the device if the first and second session key check vectors match.

In at least one embodiment, the method further comprises beginning a command phase when the first and second session key check vectors match.

In at least one embodiment, the method further comprises generating a first session key from a series of cipher text values at the device without reinitializing a first encryption engine at the device; and loading the first session key into the first encryption engine at the device and initializing the first encryption engine using the iv to prepare the device for subsequent data transformations.

In at least one embodiment, the method further comprises generating the AA packet at the KMS server by generating a second session key from a series of cipher text values using the iv, the dv and the matching key, the second session key matches the first session key generated by the device; and including the sid and the second session key in the AA packet.

In at least one embodiment, upon receiving the AA packet sent from the KMS server to the server interface, the method further comprises canceling a retry timer at the server interface if the retry timer was set when the TAR packet was sent by the server interface; loading a second encryption engine at the server interface with the second session key; initializing the second encryption engine using the iv from the session record; generating a random challenge vector at the server interface; generating a reader_rsp vector as a challenge response vector at the server interface using a Hummingbird encryption algorithm; and sending the challenge vector and the reader_rsp vector from the server interface to the device.

In at least one embodiment, upon receiving the AA packet sent from the KMS server to the server interface, the method further comprises storing the session key at the server interface.

In at least one embodiment, at the device the method further comprises generating a corresponding response vector using the challenge vector, the reader_rsp vector and the current state of the first encryption engine at the device; comparing the corresponding response vector with the reader_rsp vector; and authenticating the server interface if the corresponding response vector and the reader_rsp vector match.

In at least one embodiment, the method further comprises generating a first tag_rsp vector based on a current state of the first encryption engine at the device; transmitting the first tag_rsp vector from the device to the server interface; generating a second tag_rsp vector at the server interface; comparing the first tag_rsp vector from the device with the second tag_rsp vector; and authenticating the device at the server interface if the first and second tag_rsp vectors match.

In at least one embodiment, the method further comprises beginning a command phase when the first and second session key check vectors match.

In at least one embodiment, the method further comprises generating the AA packet at the KMS server by generating a first session key from a series of cipher text values using the iv, the dv and the matching key; generating a random challenge vector; generating a reader_rsp vector and a first tag_rsp vector as challenge response vectors using the matching key and a Hummingbird encryption algorithm initialized with the iv; formatting a setSessionKey tag command containing the first session key as a parameter; encoding the setSessionkey tag command using a preserved state of the Hummingbird encryption algorithm and a Hummingbird decryption algorithm; and including the sid, the challenge vector, the reader_rsp vector, the first tag_rsp vector, the first session key and the encoded setSessionKey tag command in the AA packet.

In at least one embodiment, upon receiving the AA packet sent from the KMS server to the server interface, the method further comprises: canceling a retry timer at the server interface if the retry timer was set when the TAR packet was sent by the server interface; and forwarding the challenge vector and the reader_rsp vector from the server interface to the device.

In at least one embodiment, at the device the method further comprises generating a corresponding response vector using the challenge vector, the reader_rsp vector and the current state of a first encryption engine at the device; comparing the corresponding response vector with the reader_rsp vector; and authenticating the server interface if the corresponding response vector and the reader_rsp vector match.

In at least one embodiment, the method further comprises generating a second tag_rsp vector based on the current state of the first encryption engine at the device; transmitting the second tag_rsp vector from the device to the server interface; generating a third tag_rsp vector at the server interface; comparing the second tag_rsp vector from the device with the third tag_rsp vector at the server interface; and authenticating the device at the server interface if the second and third tag_rsp vectors match.

In at least one embodiment, the method further comprises sending the encoded setSessionKey tag command from the server interface to the device if the second and third tag_rsp vectors match.

In at least one embodiment, the method further comprises encrypting the encoded setSessionKey tag command at the device which causes decoding of the command and the session key contained therein; and executing the setSessionKey tag command at the device by loading the session key into a Hummingbird encryption engine at the device and initializing the engine using the iv.

In at least one embodiment, the method further comprises loading the session key into a Hummingbird encryption/decryption engine at the device; initializing the Hummingbird encryption/decryption engine at the server interface using the iv that was previously stored in the session record; using a current state of the encryption engine at the device to generate a first session key check vector and sending the first session key check vector to the server interface; using a current state of the encryption engine at the server interface to generate a second session key check vector using a similar procedure as was used by the device; comparing the first and second session key check vectors; and validating the device if the first and second key check vectors match.

In at least one embodiment, the method further comprises beginning a command phase when the first and second session key check vectors match.

In at least one embodiment, the method further comprises generating the AA packet at the KMS server by including the sid and the matching key which is a secret key of the device.

In at least one embodiment, upon receiving the AA packet sent from the KMS server to the server interface, the method further comprises canceling a retry timer at the server interface if the retry timer was set when the TAR packet was sent by the server interface; storing the secret key in a session record referenced by the sid; loading a first encryption engine at the server interface with the secret key; initializing the first encryption engine using the iv from the session record; generating a random challenge vector at the server interface; generating a reader_rsp vector as a challenge response vector at the server interface using a Hummingbird encryption algorithm; and sending the challenge vector and the reader_rsp vector from the server interface to the device.

In at least one embodiment, at the device the method further comprises generating a corresponding response vector using the challenge vector, the reader_rsp vector and a current state of a second encryption engine at the device; comparing the corresponding response vector with the reader_rsp vector; and authenticating the server interface if the corresponding response vector and the reader_rsp vector match.

In at least one embodiment, the method further comprises generating a first tag_rsp vector based on a current encryption engine state at the device; transmitting the first tag_rsp vector from the device to the server interface; generating a second tag_rsp vector at the server interface; comparing the first tag_rsp vector from the device with the second tag_rsp vector; and authenticating the device at the server interface if the first and second tag_rsp vectors match.

In at least one embodiment, the method further comprises beginning a command phase when the first and second session key check vectors match.

In at least one embodiment, the KMS server is an intermediate KMS server and the method further comprises creating a session record at the intermediate KMS server in response to the TAR packet using the sid as a reference; initiating a search of a first key list at the intermediate KMS server using parameters in the TAR packet; and propagating the TAR packet to a root KMS server if the search fails.

In at least one embodiment, the method further comprises creating a second session record at the root KMS server in response to the TAR packet using the sid as a reference; initiating a search of a second key list at the root KMS server using the parameters in the TAR packet; and propagating the TAR packet to an authority KMS server if the search fails.

In at least one embodiment, the method further comprises creating a third session record at the authority KMS server in response to the TAR packet using the sid as a reference; initiating a search of a third key list at the authority KMS server using the parameters in the TAR packet; and sending an affirmative authentication (AA) packet to the root KMS server if the search was successful and a matching key was found, the AA packet having a type based on the type code.

In at least one embodiment, the method further comprises generating the AA packet at the authority KMS server by including the sid, and the matching key in the AA packet, wherein the matching key is the secret key of the device.

In at least one embodiment, upon receiving the AA packet sent from the authority KMS server to the root KMS server, the method further comprises at the root KMS server: canceling a first retry timer at the root KMS server if the first retry timer was set when the TAR packet was sent by the root KMS server; storing the secret key at the root KMS server if the root KMS server is a caching server; and transmitting the AA packet to the intermediate KMS server.

In at least one embodiment, upon receiving the AA packet sent from the root KMS server to the intermediate KMS server, the method further comprises at the intermediate KMS server: canceling a second retry timer at the intermediate KMS server if the second retry timer was set when the TAR packet was sent by the intermediate KMS server; storing the secret key at the intermediate KMS server if the intermediate KMS server is a caching server; generating a session key from a series of cipher text values using the iv, the dv and the matching key; generating a random challenge vector; generating a reader_rsp vector and a tag_rsp vector as challenge response vectors using the matching key and a Hummingbird encryption algorithm initialized with the iv; formatting a setSessionKey tag command containing the session key as a parameter; encoding the setSessionkey tag command using a preserved state of the Hummingbird encryption algorithm and a Hummingbird decryption algorithm; including the sid, the challenge vector, the reader_rsp vector, the tag_rsp vector, the first session key and the encoded setSessionKey tag command in a second AA packet; and sending the second AA packet to the server interface.

In at least one embodiment, the method further comprises creating a second session record at the root KMS server in response to the TAR packet using the sid as a reference; initiating a search of a second key list at the root KMS server using the parameters in the TAR packet; and sending a negative acknowledge packet to the intermediate KMS server since the root KMS server is an authoritative KMS server for this domain and is unable to find a matching key.

In at least one embodiment, the method further comprises consulting a list of alternate domains at the intermediate KMS server to check with for authorization; and sending the TAR packet to a second authority KMS server in the list of alternate domains to attempt for authentication when the negative acknowledge packet is received at the intermediate KMS server.

In at least one embodiment, the method further comprises generating a third session record at the second authority KMS server in response to the TAR packet using the sid as a reference; initiating a search of a third key list at the second authority KMS server using the parameters in the TAR packet; and sending an affirmative authentication (AA) packet to the intermediate KMS server if the search was successful and a matching key was found, the AA packet having a type based on the type code.

In at least one embodiment, the method further comprises generating the AA packet at the second authority KMS server by including the sid and the matching key in the AA packet, wherein the matching key is the secret key of the device.

In at least one embodiment, upon receiving the AA packet sent from the second authority KMS server to the intermediate KMS server, the method further comprises at the intermediate KMS server: canceling a retry timer at the intermediate KMS server if the retry timer was set when the TAR packet was sent by the intermediate KMS server; storing the secret key if the intermediate KMS server is a caching server; generating a session key from a series of cipher text values using the iv, the dv and the matching key; generating a random challenge vector; generating a reader_rsp vector and a tag_rsp vector as challenge response vectors using the matching key and a Hummingbird encryption algorithm initialized with the iv; formatting a setSessionKey tag command containing the session key as a parameter; encoding the setSessionkey tag command using a preserved state of the Hummingbird encryption algorithm and a Hummingbird decryption algorithm; including the sid, the challenge vector, the reader_rsp vector, the tag_rsp vector, the session key and the encoded setSessionKey in a second AA packet; and sending the second AA packet to the server interface.

In at least one embodiment, the method further comprises: generating a random challenge vector, a reader_rsp response vector and a first tag_rsp response vector at the KMS server using a matching key that corresponds to the device; generating a corresponding response vector and a second tag_rsp vector at the device; comparing the corresponding response vector with the reader_rsp vector at the device to authenticate the server interface; and comparing the second tag_rsp vector and the first tag_rsp vector at the server interface to authenticate the device.

In at least one embodiment, the method further comprises generating a session key and an encoded genSessionKey command at the KMS server using the matching key; decoding the encoded genSessionKey command at the device to generate a second session key at the device; generating a first session key check vector at the device; generating a second session key check vector at the server interface; and validating the device at the server interface if the first and second session key check vectors match.

In at least one embodiment, the method further comprises generating a first session key at the device; generating a second session key at the KMS server using a matching key that corresponds to the device; generating a random challenge vector, a reader_rsp response vector and a first tag_rsp response vector based on the second session key at the server interface; generating a corresponding response vector and a second tag_rsp vector at the device based on the first session key; comparing the corresponding response vector with the reader_rsp vector at the device to authenticate the server interface; and comparing the second tag_rsp vector and the first tag_rsp vector at the server interface to authenticate the device.

In at least one embodiment, the method further comprises generating a session key and an encoded setSessionKey command at the KMS server using the matching key; decoding the encoded setSessionKey command at the device to generate a second session key at the device; generating a first session key check vector at the device; generating a second session key check vector at the server interface; and validating the device at the server interface if the first and second session key check vectors match.

In at least one embodiment, the method further comprises sending the matching key that corresponds to the device from the KMS server to the server interface; generating a random challenge vector, a reader_rsp response vector and a first tag_rsp response vector based on the matching key at the server interface; generating a corresponding response vector and a second tag_rsp vector at the device based on the challenge vector; comparing the corresponding response vector with the reader_rsp vector at the device to authenticate the server interface; and comparing the second tag_rsp vector and the first tag_rsp vector at the server interface to authenticate the device.

In at least one embodiment, the method further comprises sending the TAR packet along a path to successively higher security level KMS servers according to a hierarchy of the KMS system until a matching key is found that corresponds to the device; generating an affirmative authentication packet at the higher security level KMS server at which the matching key was located; and propagating the affirmative authentication packet along the path to the server interface.

In at least one embodiment, the method further comprises sending the TAR packet to a higher security level KMS server to locate a matching key that corresponds to the device; consulting a list of alternate domains if a negative acknowledge packet is received from the higher security level KMS server in order to identify a KMS server in an alternate domain; sending the TAR packet to the KMS server in the alternate domain to locate the matching key; and repeatedly performing the consulting and sending steps until the matching key is located or every KMS server in the list of alternate domains has been checked.

In at least one embodiment, the method further comprises generating an affirmative authentication packet at the KMS server in the list of alternate domains if the matching key is located; and sending the affirmative authentication packet to the server interface if the matching key is located.

In at least one embodiment, the method comprises using a KMS local server, a KMS distribute server or a KMS root server as the server interface.

In another aspect, in at least one example embodiment described herein, there is provided a computer readable medium comprising a plurality of instructions executable on a processor of an electronic device for adapting the electronic device to implement a method of providing cryptographic key management servers (KMS) in a system wherein the method is defined according to any of the embodiments defined above.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and in which:

FIG. 1 is a block diagram of an example embodiment of a KMS system;

FIG. 2a is a block diagram of an example embodiment of a KMS system with nested roots;

FIG. 2b is a block diagram of an example of another embodiment of a KMS system with two parent KMS domains sharing a nested root child KMS domain;

FIG. 3 is a block diagram illustrating an example of another embodiment of a KMS system;

FIG. 4 is a block diagram illustrating the logical hierarchy of the KMS servers shown in FIG. 3;

FIG. 5 is a block diagram illustrating example components of an interface shown in FIG. 3;

FIG. 6 is a block diagram illustrating example components of a key authentication server shown in FIG. 3;

FIG. 7 is a flow diagram illustrating an example embodiment of a method for authenticating a tag performed by one or more components shown in FIG. 3;

FIG. 8 is a flow diagram illustrating an example embodiment of a method for generating a session key performed by one or more components shown in FIG. 3;

FIG. 9 is a flow diagram illustrating an example of another embodiment of a method for generating a session key performed by one or more components shown in FIG. 3;

FIG. 10 is a flow diagram illustrating an example of another embodiment of a method for generating a session key performed by one or more components shown in FIG. 3;

FIG. 11 is a flow diagram illustrating an example embodiment of a method for transmitting a secret to an interface performed by one or more components shown in FIG. 3;

FIG. 12 is a flow diagram illustrating an example embodiment of a method for authentication involving multiple key authentication servers performed by one or more components shown in FIG. 3;

FIG. 13 is a flow diagram illustrating an example of another embodiment of a method for authentication involving multiple key authentication servers performed by one or more components shown in FIG. 3;

FIG. 14 is a block diagram illustrating an example embodiment of a tag authentication process performed by some components of the KMS system of FIG. 3;

FIG. 15 is a block diagram illustrating an example embodiment of a portion of a KMS system for use in a fictional toll authority application; and

FIG. 16 is a block diagram illustrating another example embodiment of a KMS system that can connect multiple tool authority domains.

### DESCRIPTION OF VARIOUS EMBODIMENTS

It will be appreciated that for simplicity and clarity of illustration, where considered appropriate, reference numerals may be repeated among the figures to indicate corresponding or analogous elements. It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of various embodiments as described herein.

The embodiments of the systems and methods described herein may be implemented in hardware or software, or combinations of both. However, these embodiments may be implemented in computer programs executing on programmable computers each comprising at least one processor, a data storage device (including volatile and non-volatile memory and/or other storage elements), at least one input device, and at least one output device. For example and without limitation, the programmable computers may be a mainframe computer, server, personal computer, laptop, personal data assistant, tablet computer, embedded computer, or cellular telephone. Program code may be applied to input data to perform the functions described herein and generate output information. The output information may be applied to one or more output devices in known fashions.

Each program may be implemented in a high level procedural or object oriented programming and/or scripting language to communicate with a computer system. However, the programs can be implemented in assembly or machine language, if desired. In any case, the language may be a compiled or interpreted language. Each such computer program may be stored on a storage media or a device (e.g., read only memory (ROM) or magnetic diskette) readable by a general or special purpose programmable computer, for configuring and operating the computer when the storage media or device is read by the computer to perform the procedures described herein.

In some embodiments, the teachings herein may be implemented in dedicated hardware systems, or systems with at least a considerable amount of application specific hardware.

At least a portion of some of the embodiments described herein may also be considered to be implemented as a non-transitory computer-readable storage medium, configured with a computer program, wherein the storage medium so configured causes a computer to operate in a specific and defined manner to perform the functions described herein.

The high mobility of devices and smart objects makes it challenging for all possible a priori peer-to-peer relationships to be established and maintained in practice. One way to address this challenge in peer-to-peer relationships is for each domain authority to establish a single relationship with a single entity providing communication security services to registered domain authorities. One such service is the Key Management Service (KMS) system that is described herein. With a single pre-established relationship to the KMS system, a domain authority may provide security services to any mobile device that is within its domain even if it has no a priori relationship with that device's home domain authority.

The KMS system is a new secured data distribution system designed to support multi-domain security services for highly mobile devices and smart objects. The KMS system operates as a trusted third party. A domain authority registers with the KMS system in order to provide services to its devices when they are in foreign domains. When data is required for a security service, the request is sent through the KMS system which routes the request to the appropriate domain authority. Depending on the implementation, a domain authority can communicate a device's keys, a cryptographic conversation, other data, or nothing in response to each request received through the KMS system.

The KMS system is generally organized as a set of hierarchical and distributed KMS servers with several layers of organization. An application or device that requires a security service, such as an RFID interrogator authenticating the identity of a tag, issues a security service request to its local KMS resolver. KMS servers may cache information communicated from the domain authorities in order to improve system response times and to reduce the computational and communication load of the domain authority.

It should be noted that the terms “request” and “query” are used interchangeably herein and are meant to represent instances in which a device requests information for questions posed to the KMS system as well as instances in which a device requests services from the KMS system such as “update my key”.

Some example embodiments as described herein use the KMS system with the Hummingbird symmetric cipher. The Hummingbird cipher is described for example in U.S. Pat. No. 7,715,553 entitled “Encrypting a plaintext message with authentication”, the entire contents of which are hereby incorporated by reference herein for all purposes, U.S. patent application Ser. No. 12/781,648 entitled “System for encrypting and decrypting a plaintext message with authentication”, the entire contents of which are hereby incorporated by reference herein for all purposes, and U.S. patent application Ser. No. 12/779,496 entitled “System and method for securely identifying and authenticating devices in a symmetric encryption system” the entire contents of which are hereby incorporated by reference herein for all purposes.

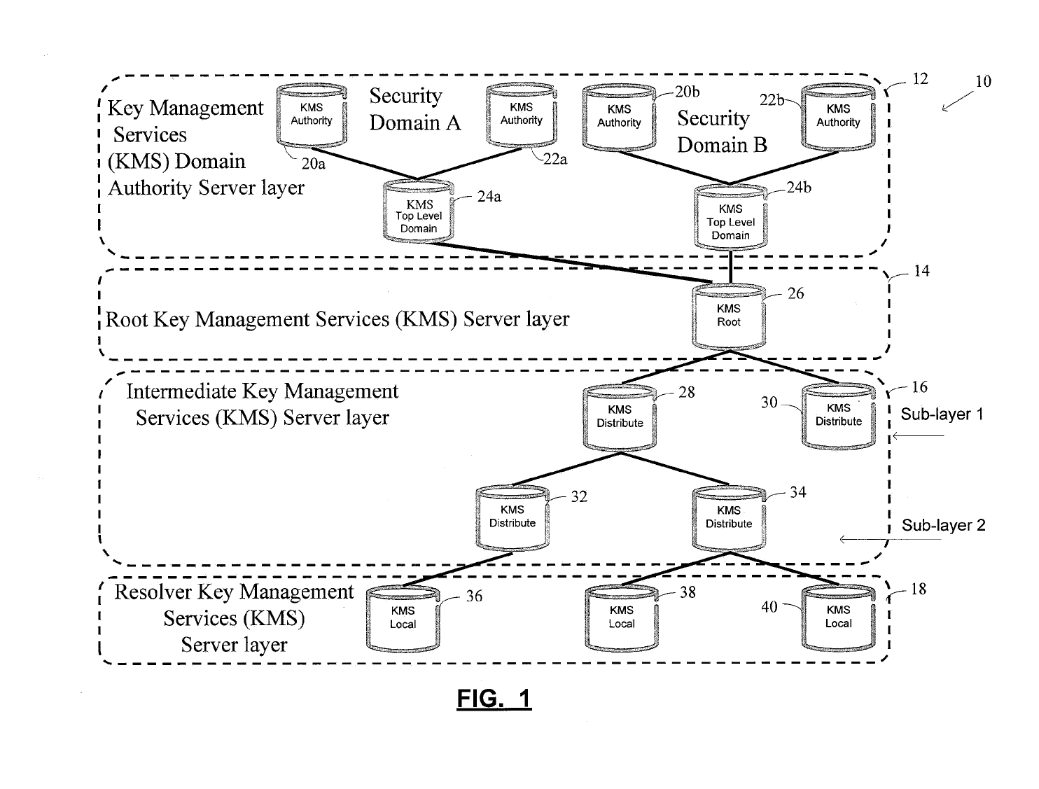

Referring now to FIG. 1, shown therein is a block diagram of an example embodiment of a KMS system 10. The KMS system 10 generally comprises a key management domain authority server layer 12, a root KMS layer 14, an intermediate KMS server layer 16 and a resolver KMS server layer 18. In this example, the key management services (KMS) domain authority server layer 12 comprises KMS authority servers 20a and 22a, and a KMS top level domain server 24a all associated with a security domain A. The KMS domain authority server layer 12 also comprises KMS authority servers 20b and 22b, and a KMS top level domain server 24b all associated with a security domain B. The root KMS server layer 14 comprises a KMS root server 26. The KMS root server 26 is connected or linked to the KMS top level domain server 24a and the KMS top level domain server 24b. The intermediate KMS server layer 16 comprises KMS distribute servers 28, 30, 32 and 34. The resolver KMS server layer 18 comprises KMS local servers 36, 38 and 40. It should be noted that the number of servers in each layer of the KMS system 10 can be varied depending on the scope of KMS system 10 and the number of devices that it interacts with to facilitate secure communication. Accordingly, there can be more than one KMS root server for example. The layers are organized in a hierarchical fashion with the key management domain authority server layer being the top layer and the resolver KMS server layer 18 being the bottom layer. A given layer is connected to the layers above and below it.

In at least some embodiments, the root KMS server layer 14 typically contains one level of highly connected servers that operate logically as a single KMS root server. Furthermore, in at least some embodiments, the intermediate KMS server layer 16 can have one or more sub-layers with each sub-layer containing one or more KMS distribute servers. The example in FIG. 1 shows sub-layer 1 and sub-layer 2 for the intermediate KMS server layer 16. Each sub-layer can be assigned a security level such that the sub-layer communicating with the root KMS server layer 14 has the highest security level and the last sub-layer has the lowest security level.

A KMS authority server manages the keys for its domain or a portion of its domain. A KMS authority server is recognized by the KMS system 10 as the master, or authoritative, source for keys and cryptographic conversations for its domain. A KMS authority server communicates only with a top level domain server (when it exists) or with a KMS root server. A KMS authority is the source of all cryptographic services provided by the KMS system 10.

A KMS top level domain server manages the KMS authority servers within a domain and all of its sub-domains. In small domains, the functionality of a KMS top level domain server may be physically performed by the same server that provides the functionality of a KMS authority server. Accordingly, a KMS top level domain server is optional in some cases.

A KMS root server is a top level server in the hierarchy of the KMS system 10 prior to the system 10 branching out along different servers in the intermediate KMS server layer 16 and the resolver KMS server layer 18 (this “branching out” can be referred to as a KMS distribution server hierarchy). A KMS root server is assigned the highest security level in the KMS distribution server hierarchy. A KMS root server communicates with a KMS top level domain server. In embodiments where there is more than one KMS root server, all of the KMS root servers are synchronized in their knowledge of KMS top level domain servers. As will be discussed in more detail below, a KMS root server can provide services for cryptographic keys and cryptographic conversations that it has cached in its local database. A KMS root server can also distribute cryptographic keys and other limited distribution data to lower security KMS distribution servers if the security level of the cryptographic keys or data is less than or equal to the maximum security level for which the destination KMS distribution server is authorized. A KMS root server may also provide additional functionality and services including, in some embodiments, the functionality of a local KMS server.

In cases where there is no KMS top level domain server, a KMS root server is connected to a KMS authority server. Furthermore, in this case where there are no other server layers, the KMS root server is configured to communicate directly with a device or application that makes a security request. Such a KMS system has a two-level KMS server hierarchy whereas the KMS system 10 has a four-level KMS server hierarchy. This is in contrast to prior art cryptographic systems which use a single level hierarchy (i.e., only an authority server). While there is no requirement that only KMS local servers communicate with devices and applications that make security requests, it is recommended in at least some cases that one or more local KMS servers be used to interact with devices and applications for security reasons rather than allowing a KMS root server to implement local server functionality.

A KMS distribute server is assigned a security level that indicates the maximum security level for which it is authorized. As will be discussed in more detail below, a KMS distribute server can be configured to provide services for cryptographic keys and cryptographic conversations that it has cached in its local database. A KMS distribute server can distribute cryptographic keys and other limited distribution data to lower security KMS distribution servers if the security level of the cryptographic keys or data is less than or equal to the maximum security level for which the destination KMS distribution server is authorized. A KMS distribute server may also provide additional functionality and services including, in some embodiments, the functionality of a local KMS server.

A KMS local server interacts directly with devices and applications that make security requests. However, there can be instances in which a KMS root server or a KMS distribute server can also communicate directly with a device or an application. A KMS local server is assigned the lowest security level in the path from a KMS root server to the KMS local server. A KMS local server is typically controlled by a local system entity.

In some embodiments, there may not be the intermediate KMS server layer 16. In these cases, the resolver KMS server layer 18, if it exists, is linked to the root KMS server layer 14 and at least one server in the resolver KMS server layer 18 or the root KMS server layer 14 is configured to communicate directly with a device or application that makes security requests to the KMS system 10.

In general, the various layers of the KMS system 10 are assigned different security levels such that the authority KMS server layer 12 is assigned a higher security level than the root KMS server layer 14, the root KMS server layer 14 is assigned a higher security level than the intermediate KMS server layer 16, and the intermediate KMS server layer 16 is assigned a higher security level than the resolver KMS server layer 18. For example, the KMS authority server 20 may contain cryptographic keys having security levels −1, 0, 1, and 2. The KMS root server 26 may contain cryptographic keys having security levels 0, 1, and 2, the KAS distribute server 28 may only contain cryptographic keys having security levels 1 and 2, and the KMS local server 36 may only contain cryptographic keys having security level 2. In this example, a higher security number is associated with a lower security level.

It should also be noted that security levels do not need to be sequential when traversing a set of KMS servers from a KMS root server to a KMS local server. For example, with a KMS root server assigned a security level of 0, the security level sequence of the KMS servers traversed between a KMS root server and a KMS local server may have the security level values of: 0 (root), 1 (distribution), 4 (distribution), 9 (distribution), and infinity (local). It should also be noted that if a KMS root server is assigned a security level of 0 (remember in this design a lower value means a higher level of security), this allows for a cryptographic key to be assigned a security level of −1 which means that the cryptographic key never leaves a KMS authority server.

The KMS system provides a set of services that support the security services provided by security domain authorities to their provisioned applications and devices. As such, the KMS system provides secure key and secure message distribution within and across security domains in a manner that is transparent to the domain authorities, applications, and devices. Applications and devices needing security services, such as identity authentication or secure session key establishment, normally provided by a domain authority will request these services from the KMS system 10. The KMS system 10 either routes these service requests to the appropriate domain authorities or provides the requested services directly. The KMS system 10 operates as a trusted intermediary, or a trusted third party, in the communications between these entities supporting the required security services.

Services provided by the KMS system 10 generally include identity authentication, origin authentication, confidentiality, data integrity, and service access control. These services are sufficient to enable all of the basic services provided by domain authority systems such as Kerberos and to securely communicate service requests to domain authorities and to securely disseminate their responses to authorized entities. Beyond these services, the KMS system 10 may contain extensions and custom capabilities for domain specific or multi-domain specific applications and services.

The KMS system 10 is designed to scale to support the ubiquitous smart objects and devices connected to the “Internet of Things”. The “Internet of Things” is a communications network that connects “smart objects”, e.g., objects with an embedded RFID tag such as a car with an electronic toll tag, to one another and other resources available over the global Internet as well as local networks. Accordingly, the core of the KMS system 10 consists of a set of distributed, hierarchically organized servers that provide KMS services in a scalable and reliable fashion. The root KMS server 26 interacts with the security domain authority servers 20, 22 and 24 while the KMS resolver servers 36, 38 and 40 act as the interface between the applications and devices and the KMS servers 20 to 34. The secured KMS distribute servers 28 to 34 operate in a distributed, hierarchical configuration between the KMS root server 26 and the KMS local servers (i.e. resolvers) 36, 38 and 40 to provide the scalability and reliability of the KMS system 10.

In order to improve the performance experienced by the applications and devices using the KMS system 10, any of the KMS servers 24 to 40 may cache data communicated from the KMS domain authority servers 20 and 22 in order to decrease the response times to service requests. The KMS servers 24 to 40 may also provide services on behalf of the domain authorities, effectively acting as their trusted proxies, to further increase system performance and reduce the workload experienced by the KMS authority servers 20 and 22. It is the policies set by the domain authorities that determine what information the authority communicates to the KMS system 10.

For example, one domain authority may communicate all of its public keys to the KMS system 10 and allow them to be cached, but all other data may not be cached or distributed beyond the provision of the requested service. Thus, the domain authority server is accessed for every service requested of that domain that does not require public keys only. This maintains a high level of control with the domain authority and does not require it to trust the elements of the key distribution service (i.e. elements in layers 14, 16 and 18 of the KMS system 10) to maintain any of its secret key material.

In contrast, another domain authority may have a policy that allows it to communicate all keys, including secret symmetric keys in addition to public keys, to the secured servers in the KMS system 10. Thus, various elements of the KMS system 10 can perform services on behalf of the domain authority. This reduces the functional load experienced by the domain authority server at the expense of the authority trusting elements at lower levels of the KMS system 10.

One of the security services that the KMS system 10 provides is data origin authentication combined with data integrity. Data origin authentication ensures that the cryptographic keys and other data obtained using the KMS system 10 is, in fact, communicated from the correct domain authority. Data integrity ensures that not only did the data originate at the correct domain authority but that it has not been modified in transit to the requesting application or device.

The KMS system 10 provides data origin authentication and data integrity through the use of “digital signatures” for the data. Digital signatures, as used herein, are cryptographically generated text, such as a certificate used with asymmetric ciphers or a cryptographic conversation used with symmetric ciphers, that validate the identity of the data author and validate the integrity of the data. Depending on the particular configuration and level of trust, at least one of the KMS servers 26 to 40 may validate digital signatures when they are received by that server. When a digital signature fails validation, the KMS servers 26 to 40 can delete that digital signature and its associated data. In addition, the KMS servers 26 to 40 may, as its policies dictate, take additional actions.

Most digital signatures will be generated using asymmetric ciphers such as RSA or Elliptic Curve Ciphers (ECCs), but symmetric ciphers may be used to generate a form of digital certificate, as well. When a KMS server can reliably obtain a domain authority's public key or establish a shared key directly with the domain authority, it can authenticate the domain authority's digital signatures and signed data. Typically, there is a single key, either a shared secret symmetric key or a private key in an asymmetric key pair, that signs a domain authority's data; however, multiple signing keys are possible for each domain authority. For example, there may be dedicated keys for each of several different digital signature algorithms.

A key that is used to sign a domain authority's data is associated with the domain itself and not with the domain's domain authority servers (i.e. KMS authority servers 20 and 22). This separation removes the dependency upon a single server, and when multiple servers are used, it removes the need to maintain the signing keys for each server in the domain.

The KMS system 10 is concerned with the security of KMS data, i.e., data that is maintained and transmitted through the KMS servers 26 to 40. Therefore, the data is protected both at rest, while it is cached in a KMS server, and in motion, when it is communicated within and by any KMS server in the KMS 10. In this way, the origin integrity and data integrity are secured end-to-end from the KMS authority servers 20 and 22 to the applications and devices that request their services.

Transactional security is used to insure data integrity and conversational authentication between the KMS servers 28 to 40 and between the KMS root server 14 and the domain KMS authority servers 20 and 22. This point-to-point security protects each communication channel. Dynamic secured communication channels may be established, or a long running secured communication channel, such as a Virtual Private Network (VPN), can be established between KMS servers 28 to 40 and between the KMS root server 26 and the domain KMS authority servers 20 and 22.

A KMS server can learn a domain authority's public key or establish a shared secret key with a KMS authority server either by having a trust anchor configured into the KMS server or by normal KMS resolution. A trust anchor is a key that has been manually configured by the KMS server's administrator. To discover a key reliably via KMS resolution, the target key itself is signed by either a preconfigured key in the KMS server (a trust anchor) or by another key that has been authenticated previously.

KMS servers authenticate domain origin and data integrity by forming an authentication chain from a newly learned key back to a previously known authentication key that either has been configured into the resolver or has been learned and verified previously. Therefore, the KMS servers are configured with at least one trust anchor. The trust anchors shall include either the public key of or a pre-established shared secret key with at least one KMS server that is logically closer to the KMS root server 26 or the KMS root server 26 itself.

The distribution of data into the KMS system 10 may be either in response to a service request from an application or device (a pull distribution of data) or as a preemptive distribution of data from the KMS authority servers 20 or 22 to preposition data within the KMS servers (a push distribution of data). A negative response to a request can still yield data, just not of the desired type. As such, the negative response to a request is afforded the protection of the origin authentication and data integrity mechanisms. Failure to authenticate a negative response affords an attacker the opportunity to deny services undetected. Therefore, negative responses to requests are protected with digital signatures to allow for origin authentication and data integrity checks.

The KMS system 10 provides services that protect the requests for information and data in addition to the data originating from the KMS authority servers 20 and 22. By allowing for bidirectional security, i.e., security of both the data and the requests for the data, the KMS system 10 provides mechanisms for the confidentiality and protection of both the data and the requests. This is in accordance with the design philosophy that the KMS servers are protected servers whose data is neither public nor generally available.

Requests made to the KMS system 10 may be protected with a digital signature in the same manner that data origin and integrity are protected. For entities, such as RFID interrogators, that make requests of the KMS system 10, the KMS servers may learn their public keys or establish shared secret keys with them either by having trust anchors configured into the KMS servers or by normal KMS resolution. This allows the local KMS resolver servers 36 to 40 to authenticate the requests prior to propagating the request through the KMS server hierarchy. Independently, each KMS server may validate the origin and integrity of the request as well, depending on the allocation of services amongst the various servers in the KMS system 10.

The KMS system 10 does not necessarily require all requests to be authenticated or secured. The KMS system 10 allows for each domain authority to specify data distribution restrictions that each KMS server will enforce. For that data which is not meant to be publicly available, the KMS servers shall protect it by limiting its distribution to authorized domains and devices as specified by the domain authority that authored the data.

One of the KMS authority servers 20 and 22 may provide for a level of confidentiality of its data with the use of distribution access control lists associated with data originating at that server. The distribution access control lists may specify domains or specific devices that may receive specific KMS data, i.e., distribution white lists. Similarly, these lists may specify lists of domains or specific devices that may not receive specific KMS data, i.e., distribution black lists.

Distribution white lists are created at the time data is communicated from a KMS domain authority server to the KMS system 10. When a distribution white list is present, all entities requesting the data are authenticated and on the distribution white list in order to be communicated the cached data. Otherwise, the request is sent to the appropriate KMS domain authority server 20 or 22.

Distribution black lists are created at the time data is communicated from one of the domain authority servers 20 or 22 to the KMS system 10. When a distribution black list is present, all entities requesting the data are authenticated and not on the distribution black list in order to be communicated the cached data. Otherwise, the request is sent to the appropriate KMS domain authority server 20 or 22.

Distribution access control lists can enable complete domains, including the KMS servers within them, to either have, or not to have, access to specific data. In this way, the KMS servers may limit the distribution of KMS data within the KMS system 10. Similarly, the KMS servers will control to which requests they respond; thereby limiting access to authorized devices and applications. In this way, secured communications between devices and applications can be controlled.

The KMS system 10 is designed to enable the secure distribution of secret keys for symmetric ciphers; therefore, it is expected that secret keys will be a principle data element communicated to and cached by at least some of the KMS servers in the KMS system 10. By propagating secret keys into the secured KMS servers and allowing these servers to perform key-based services on its behalf, a KMS domain authority server may reduce its communication and computational loads.

The secret key-based services supported by the KMS servers include identity authentication and secure session key establishment. These services allow devices utilizing the KMS system 10 to prove their identities to one another in a secure manner and to securely establish a shared secret for secure communications that do not require the further support of the KMS system 10. The precise operation of these services may be cryptographic cipher dependent. The KMS system 10 supports the use of multiple ciphers and the use of secure identifiers. A secure identifier is an identifier that protects against certain attacks such as tracking and tracing and is often implemented either as an encryption of a device's identity or as an anonymous secure identifier that depends only upon the device's secret key. The specific form of the secure identifier is dependent upon the security protocol and cipher used to generate it.

In its simplest form, the KMS system 10 connects multiple domain authority servers 20, 22 and 24 to the one or more root KMS servers in the KMS root server layer 14 which, in turn, connect to multiple intermediate KMS servers in the intermediate KMS server layer 16 that eventually connect to the servers in the KMS resolver server layer 18 that communicate with the applications and devices needing security services. The applications and devices request security services from the KMS domain authority servers 12 through the KMS system 10 which simply acts as a trusted third party conveying the requests to the appropriate authority and delivering the service to the requester.

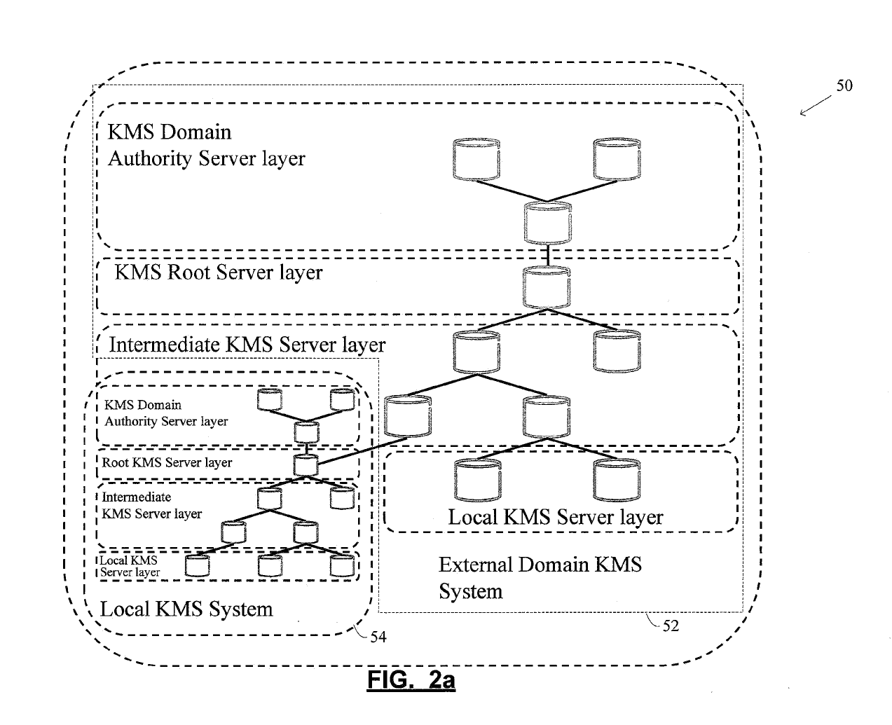

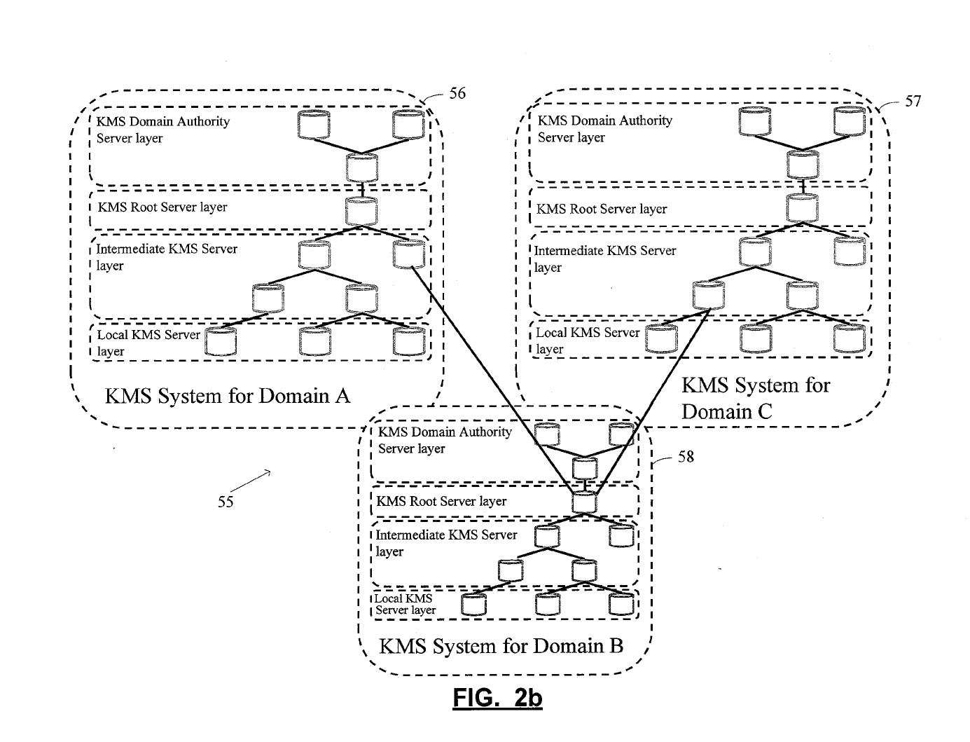

The hierarchical architecture shown in FIG. 1 works well when all security domains are connected to the same root KMS server layer 14 providing the same security scope for the KMS system 10, but there can be other implementations of the KMS system that will have KMS systems nested within KMS systems, a simplified version of which (for illustrative purposes), is shown in FIG. 2a. FIG. 2a is a block diagram of an example embodiment of a KMS system 50 with nested roots, which illustrates how a single KMS system can be nested within a larger KMS system in a hierarchical fashion. While a single nesting is shown in FIG. 2a, in practice there is no limit on the number of nestings that can be used. Furthermore, it should be understood that nestings are not required by a KMS system but can be incorporated so that the KMS system more closely mimics the actual physical security architecture (i.e. different corporate buildings and divisions) used by a corporation. The local KMS system 54 will have a root KMS server to which a local set of domain authority servers are connected. In addition, the local root KMS server is connected to an intermediate KMS server in an external, encompassing, security domain 52. In this way, the local root KMS server for the KMS system 54 acts as an intermediate KMS server within the external domain 52.

The local domain KMS authority servers connected to the local root KMS server are able to provide services to entities commissioned in the local domain 54, for example the access control cards for employees at a particular corporate location. However, when a mobile entity enters the local domain 54, such as a visiting employee based at another corporate location, the local domain authority KMS server will not be able to provide the desired services such as authenticating the visiting employee's access control card.

In this case, the local root KMS server accesses the external KMS servers in KMS system 52 in order to locate the appropriate domain authority KMS server that commissioned the visiting employee's access control card. Because of the hierarchical organization of the KMS servers, all requests flow to the root KMS server in KMS system 52. Therefore, security services for the visitor can be provided only if the visitor's local domain authority KMS server is registered with the external root KMS server of KMS system 52. Consequently, a domain KMS authority server in KMS system 52 may provide services to one of its mobile devices or applications located within another KMS system 54 if that KMS system 54 is within the hierarchical domain of the highest root KMS server of KMS system 52 to which the domain KMS authority server has registered.

This hierarchical encapsulation of KMS systems may appear to be restrictive in the design and use of a KMS system. However, when viewed in light of how security domains are created in practice, this hierarchy mimics the security domains as they exist naturally. Furthermore, this hierarchical structure enables security management that is not possible in an amorphous or otherwise unstructured system while limiting the complexity of the system design and management.

Referring to FIG. 2b, shown therein is a block diagram of an example of another embodiment of a KMS system 55 which has two parent domains 56 and 57 connected to a child domain 58. In FIG. 2b, KMS system 58 is nested within KMS system 56 while simultaneously KMS system 58 is nested within KMS system 57 where KMS system 56 and KMS system 57 overlap only at KMS system 58. This example illustrates that a rooted KMS system can be subordinate to more than one parent KMS system depending on the security design of the overall KMS system. In other words, a child KMS system can be nested simultaneously within multiple other KMS systems. Accordingly, in the encapsulation of entire KMS systems, it is possible to have a single KMS system that is encapsulated within two or more disjoint KMS systems.

It is possible for a KMS root server of a child domain to connect to a KMS intermediate server in the intermediate KMS server layers of all parent domains as is shown in FIG. 2b. However, in other embodiments, it is possible for the KMS root server of a child domain to connect to a KMS root server in the root KMS server layers of all parent domains. Alternatively, in other embodiments, it is possible for the KMS root server of a child domain to connect to a KMS intermediate server in the intermediate KMS server layer of one or more of the parent domains and also to connect to a KMS root server in the root KMS server layer of one or more of the other parent domains.

There is no functional difference as seen by an application in where a child KMS system connects into the KMS servers of a parent KMS system since a KMS root server of a child KMS system will look like another intermediate KMS server to a parent KMS system. However, the point at which the KMS root server of a child KMS system connects into a parent KMS system impacts the level of security that it can utilize. For example, consider a KMS root server of a child KMS system that is given a security level of 3 within a parent KMS System, but the KMS root server of the child KMS system connects to a KMS distribute server with a security level of 4. Since the KMS distribute server can never access cryptographic keys with a security level of 3, it will never pass cryptographic keys having a security level of 3 to the KMS root server of the child KMS system (a lower security number means a higher security level). However, if this KMS root server of the child KMS system (with a security level of 3) connects to a root KMS server of a parent KMS system or to a KMS distribute server with security level 1 or 2, then the root KMS server of the child KMS system will be able to receive cryptographic keys with a security level of 3.

It should be noted that a KMS system may be either private or public. In a private KMS system, only people, devices, and applications authorized and within the scope of the KMS system can make security requests of and get responses from the private KMS system. In a public KMS system, anyone can make a security request and get a response although there may be limitations on either the requests or the responses. In other words, a public KMS System provides services to anyone that asks. That is, the KMS authority servers have few, if any, restrictions to whom it provides services and the root KMS servers, the distribute KMS servers, and the local KMS servers have few, if any, restrictions on from whom they accept requests. However, in a private KMS system, the KMS authority servers have several restrictions to whom services are provided either because the restrictions are within the KMS authority servers themselves, there are restrictions on accessing or using the KMS distribution servers (i.e., the KMS root, KMS intermediate, and KMS local servers), or both. Private KMS systems are designed to provide services to a select set of people, applications, and devices, typically on a closed network.

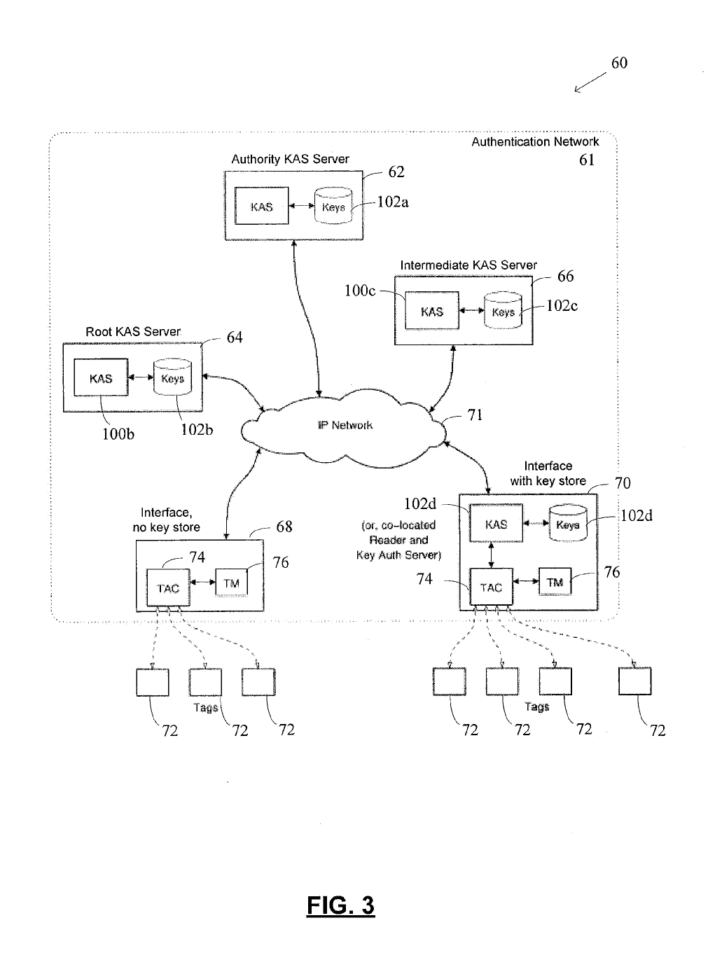

Referring to FIG. 3, illustrated therein is an example embodiment of an implementation of a KMS system referred to as a Key Authentication Services (KAS) system 60 for managing keys for shared secret ciphers. The KAS system 60 has an authentication network 61 within which a number of authentication components reside. These components are similar to the components of the KMS system 10 but are herein denoted as “KAS” rather than “KMS” to differentiate from the KMS system 10. FIGS. 1 and 2 provided a logical-based hierarchical architecture for a general KMS system showing how the system works in theory, while FIGS. 3 to 14 provide an example of an actual implementation design for a KMS showing one way that it can be realized and used in practice. The components of the authentication network 61 include three instances of KMS servers referred to as Key Authentication Servers “KAS”, namely a KAS Authority server 62, a root KAS server 64, an intermediate KAS server 66, a first KAS server interface 68 and a second KAS server interface 70. It should be noted that the interfaces 68 and 70 can also be referred to as a reader, an interrogator, an access point into a network, a gateway into a network, or a WIFI device used as a gateway.

A plurality of devices 72 that wish to be authenticated exist outside the authentication network 61 and communicate to the authentication network 61 through the interfaces 68 and 70. The devices 72 can also be referred to as tags in the case of using the KMS system to provide secure communication with RFID tags, such as those that are used in toll systems, for example.

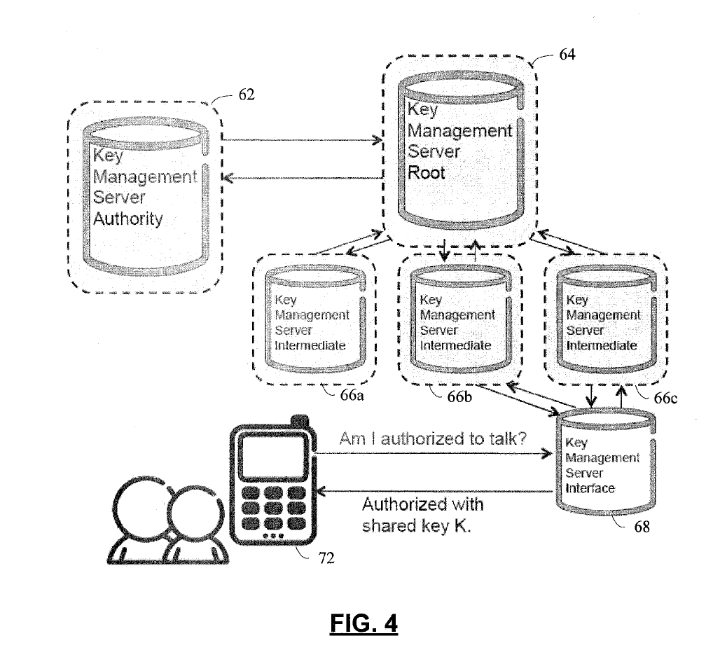

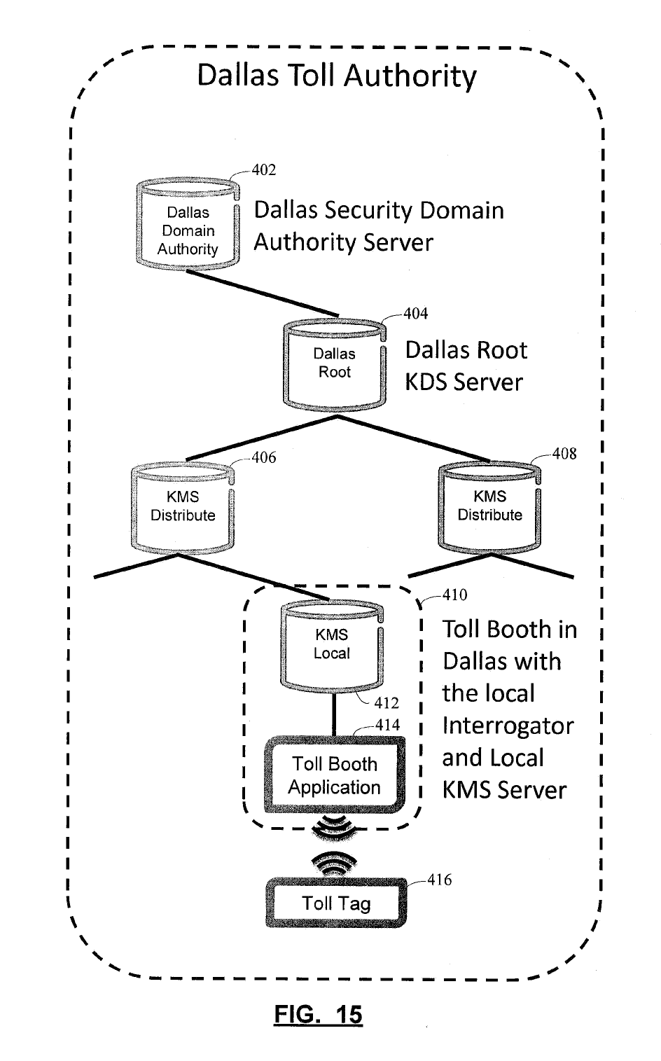

The KAS servers 62, 64, and 66, and the interfaces 68 and 70 are shown interconnected via an IP network 71. However at the authentication protocol level a hierarchical or other ordering or topology may exist as was shown in FIGS. 1 and 2. For example, the embodiment shown in FIG. 4 and the embodiment shown in FIG. 15 illustrate a hierarchical relationship between the KAS servers 62, 64, and 66.

The KAS Authority server 62 includes the main database within the authentication network 61. It contains all the keys for authenticating the tags 22.

At the next level, the root KAS server 64 contains a subset of keys that the KAS Authority server 62 contains.

At the next level, the intermediate KAS server 66 contains a subset of keys that the root KAS server 64 contains.

For example, the KAS Authority server 62 may contain keys of security levels −1, 0, 1, 2, and 3. The root KAS server 64 may contain keys of security levels 0, 1, 2 and 3, and the intermediate KAS server 66 may only contain keys of security level 3.

There may be more than one database storing keys of the same security level. In the example as shown in FIG. 4, there are three intermediate KAS servers 66, namely KAS servers 66a, 66b and 66c each including a database. Each of the databases may contain the same subset of keys or a different subset of keys for redundancy and efficiency reasons. The number of KAS servers and the content of each KAS server may depend on expected volume of “hits” (e.g., authentication requests) and/or the volume of keys of a particular security level. Generally, a larger number of KAS servers will provide a shorter response time for requests.

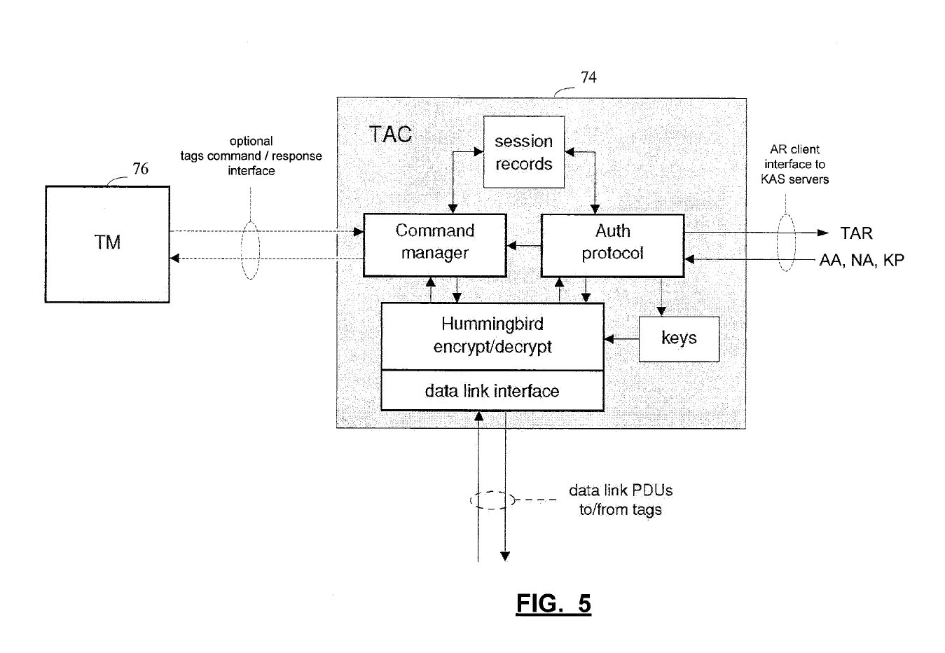

Referring now to FIG. 5, each of the interfaces 68 and 70 contains a tag access client (TAC) 74. The TAC 74 provides the encrypted data transport connection between each tag 72 and the network 61 and operates on the behalf of the tag 72 to manage mutual authentication between the tag 72 and the network 61 using authentication protocols (e.g. Hummingbird). The TAC 74 is a client function that communicates with one or more KAS servers 62, 64, and 66 within the network 61, which can validate tags 72 by matching keys.

The TAC 74 provides a link-level interface to a tag on one side, and an interface to the authentication network 61 on the other side. In addition, the TAC 74 provides logic necessary for handling the tag following a successful authentication, and any logic necessary for handling the case of a failed authentication.

In some embodiments, the TAC 74 may incorporate a Hummingbird encrypt/decrypt function for transformation of data transported across the data link between the TAC 74 and the tag. To use this function, the TAC 74 generally obtains a session key from one of the KAS servers 62, 64 and 66 in the KAS system 60. Because it terminates a data link to the tag, the TAC 74 generally resides within the device that provides the physical interface to the tag (e.g. a reader device).

Each of the interfaces 68 and 70 also has a Tag Manager 76. The Tag Manager 76 is an optional component to the KAS system 60. The Tag Manager 76 is a control/command application that controls tags 72 following authentication. The Tag Manager 76 does not play a part in key management or authentication of tags 72.

The interface 68 generally does not contain a KAS function. Therefore, the interface 68 may be referred to as a simple interface that cannot authenticate tags 72 on its own without help from one or more KAS servers 62, 64, and 66 in the authentication network 61. However, an interface, such as interface 70, may hold some keys in a key store for a short time (e.g. for the duration of a session) that were transmitted to it from one of the authentication servers. These keys are used for encryption and decryption of data that is transported to and from the tag 72

The interface 70 has an integrated KAS server component 100d and key storage database 102d. Accordingly, the Interface 70 can authenticate tags 72 on its own using keys that are provisioned to its key store 102d and searchable by its KAS server 100d functions.

Each of the KAS servers 62, 64 and 66 has a server component 100a, 100b and 100c, respectively, connected to a keys database 102a, 102b and 102c respectively.

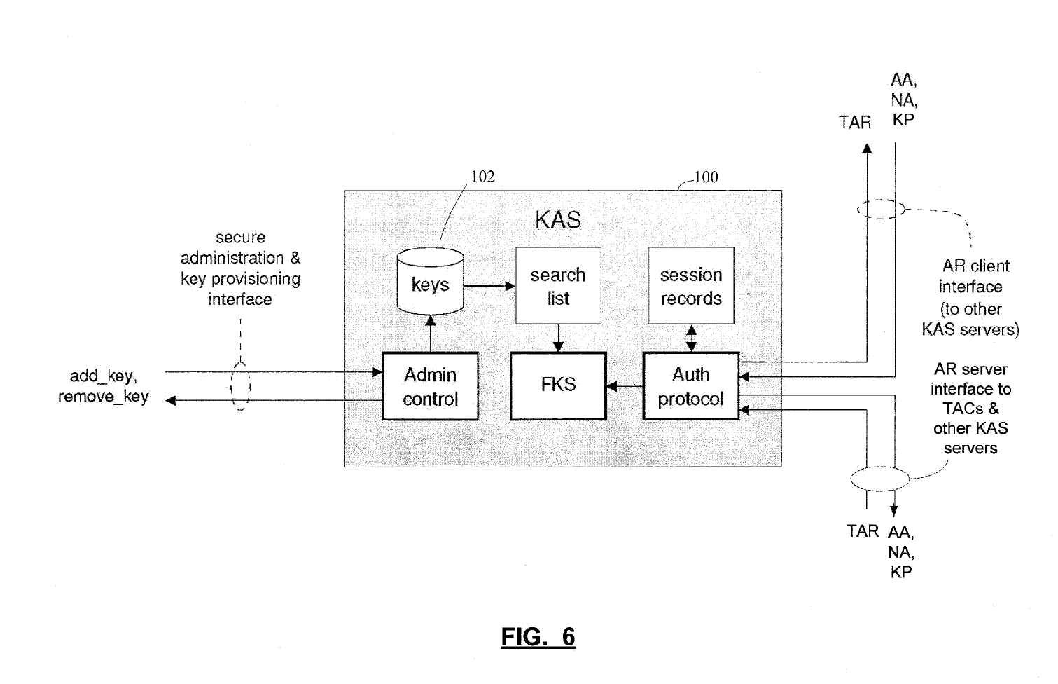

Referring now to FIG. 6, illustrated therein are components of an example embodiment of a KAS server component 100. The KAS server component 100 in each KAS server 62, 64 and 66 accepts authentication requests from interfaces 68 and 70, or the other KAS servers 62, 64 or 66. Each server component 100 may implement a FastKey search algorithm, in accordance with the Hummingbird encryption protocol, on a list of registered tag keys for the purpose of authenticating tags. Other search algorithms can be used in conjunction with using other encryption protocols.

If an authentication request results in a FastKey search that fails to match with a registered key, then depending on the configuration of the encryption protocol, the server component 100 may propagate the authentication request to one of the other KAS servers 62, 64, or 66 or simply notify the requesting interface 68/70 (or a particular KAS server 62, 64 or 66 if the search request originated from a KAS server) of the failed search. The fail notification (NA packet) may contain an optional reference to another KAS server 62, 64 or 66 that the requestor may use to redirect a subsequent authentication request.

If an authentication request results in a successful FastKey search, then the server component 100 notifies the requesting interface 68/70 or requesting KAS server 62, 64 or 66 of the key match. Depending on configuration, the server component 100 may additionally pass a key to the requesting interface 68/70 of the requesting KAS server 62, 64 or 66. Note that any key that is passed between network nodes is sent in a secure and confidential way.

Each server component 100 may operate as a non-caching server or a caching server. A non-caching server operates on a set of keys that is static, meaning that the keys may be added or deleted only through operator-controlled administration and provisioning. A caching server operates on a dynamic set of keys. The key cache contains keys that are populated automatically through interactions with other KAS servers 62, 64 or 66. Some keys on a caching server may be designated as static (i.e. non-cacheable). Some keys on a caching server may be added or deleted through operator-controlled administration and provisioning. Some keys on a caching server may be designated as static meaning that the keys may be deleted only through operator-controlled administration and provisioning.

In some embodiments, each server component 100 may be part of a server cluster having multiple peer server components 100. The multiple peer server components 100 can co-operatively perform a FastKey search on a partitioned set of keys.

In some embodiments, a single server component 100 or the cluster of server components 100 may be part of a hierarchical network as shown in FIG. 4. In such cases, an interface 68/70 or a caching server can recursively issue authentication requests to the KAS servers 62, 64 or 66 at successively higher levels until one of these KAS servers with access to keys of a sufficient security level is queried and is able to successfully authenticate the tag 72.

If a key is passed to a server component 100 as a result of an authentication request, and if the server component 100 is a caching server, then the key may be added to the cache for more efficient processing of subsequent authentication requests for the same tag. This operation may be useful in a hierarchical authentication network.

Each TAC 74 in interfaces 68 and 70 communicates with other components in the authentication network 61 using four packet types: Tag Authentication Request (TAR), Affirmative Authentication (AA), Negative Authentication (NA), and Key Provision (KP).

The TAC 74 transmits a TAR packet into the authentication network when the data link to the tag is established or when a logon event occurs. The TAR packet is processed by one or more of the servers in the authentication network 61.

If a FastKey search at one of the servers in the network 61 results in a successful key match, then that server will return an AA response to the requesting TAC 74 or the requesting KAS server 62, 64 or 66.

If a FastKey search at one of the servers in the network 61 fails and the TAR cannot be propagated to another server in the network 61, then the initial server at which the search failed returns an NA response to the requesting TAC 74 or the requesting KAS server 62, 64 or 66.

If a FastKey search at one of the servers in the network 61 results in a successful key match, then in addition to the AA response that server may also return a KP packet to the requesting TAC 74 or the requesting KAS servers 62, 64 or 66. If the KP is destined for one of the TACs 74 then the KP packet may contain a generated session key and state vector. If the KP is destined for one of the KAS servers 62, 64 or 66, then the packet contains the matched key (a permanent key for the tag 72).

The TAC 74 may maintain a retry timer and retry count for TAR packet transmissions. The retry timer is started when the TAR packet is transmitted. The TAR is retransmitted if neither an AA nor an NA response is received by the time the retry timer expires. The TAR is retransmitted a number of times governed by the retry count value.

Secure connections between each TAC 74 to each KAS server 62, 64 or 66 and between the KAS servers 62, 64 and 66 themselves may be implemented using IPsec. IPsec AH transport mode may be used for all authentication protocol packets that are traversing network nodes to ensure message integrity. The IPsec ESP additionally can be used for transport of the KP packet to provide confidentiality. IPsec requires matching Security Associations (SAs) to be set up between each pair of communicating entities at the points where IPsec connections terminate. This will include all interfaces 68 and 70 and all KAS servers 62, 64 or 66. Separate SAs will be required for AH and ESP in each direction. Eventually the SAs are established automatically using IKE or IKEv2 when system components boot up. Initially the SAs could be set up manually using an administration interface.

To avoid compromising the keys of the tags 72, the keys that are distributed to the interfaces 68 and 70 are not the permanent key for a particular tag 72 but a derivative of it that exists only while the session between one of the interfaces 68 and 70 and the tag 72 is active. A session key is generated using the Hummingbird encryption process using the tag's permanent secret key and the SSID and IV nonces. The SSID is a Secure Session Identifier which is a number that is chosen by the interface 68/70 to identify the communication session with the tag 72 and may be used in the initialization of the Hummingbird encryption engine. The IV is an Initialization Vector that is generated by the tag 72 and is used to initialize the Hummingbird encryption engine. Because the nonces are different in each session, the resulting session key is also different for each session.

A session key is generated at the tag 72 and the KAS servers 62, 64 or 66 using an identical procedure and using the same nonces and matching keys. Therefore, both entities generate the same shared secret without passing it between them.

When a session key is passed from the KAS servers 62, 64 or 66 to the interfaces 68 and 70, a state vector may also be passed to the interfaces 68 and 70 to synchronize its Hummingbird encryption engine with the one at the tag 72. It is not computationally practical to recreate the permanent key from the session key, nonce, and state vector. The interfaces 68 and 70 destroy the session key when the tag session terminates or when a session timer expires.

Each of the server components in the KAS servers 62, 64 or 66 includes a secure interface for operator-controlled key provisioning and other administration. A typical way to do this is using SOAP over HTTPS for web-based secure administration. The KAS servers 62, 64 or 66 accept add_key and remove_key key provisioning messages for updating their key caches 102a, 102b and 102c respectively. The add_key and remove_key key provisioning messages are encrypted.

When a remove_key message is processed, the KAS servers 62, 64 or 66 set the key value to all zeros (or some other null key value) and then send back a completion response.

When an add_key message is processed, the KAS servers 62, 64 or 66 set the key value to the specified value and then send back a completion response.

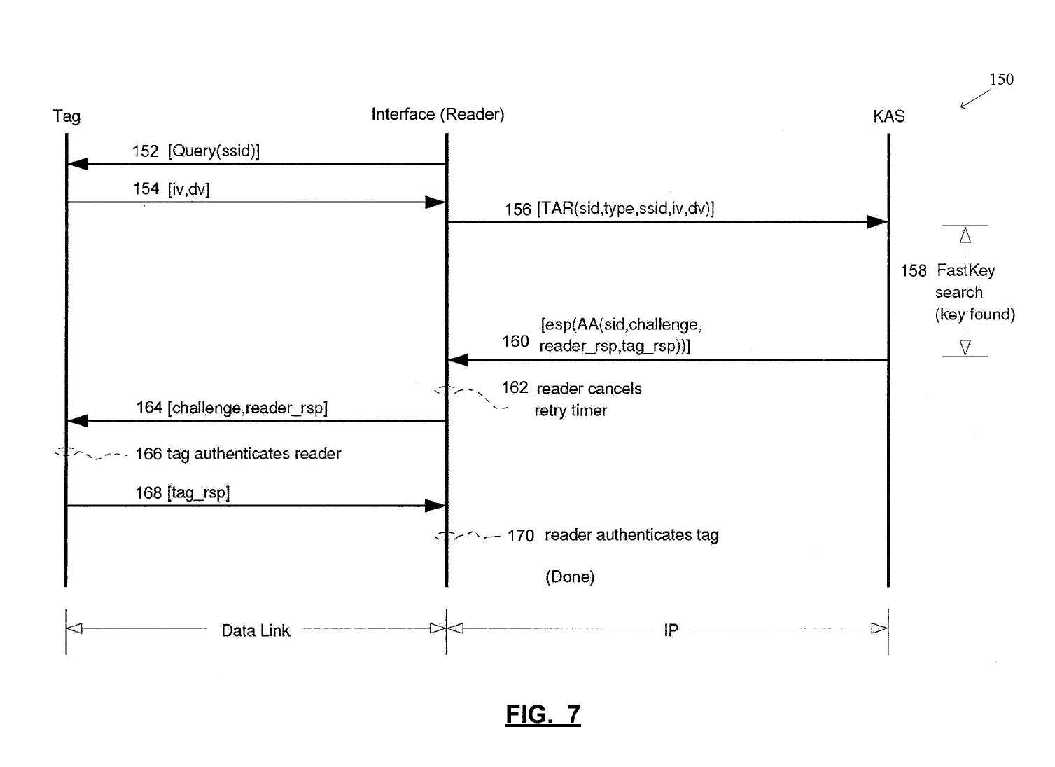

Referring now to FIGS. 7 to 13, a number of possible authentication scenarios will be described in greater detail for the particular implementation shown in FIGS. 3 to 6. Since the Hummingbird encryption protocol is used in this example implementation, various functions are used that are specific to the Hummingbird encryption protocol. It should be understood that other encryption protocols can also be used, and that these protocols will each have their own special functions that can be used in place of the encryption-related functions described in the following example. It should be noted that while a Secure Session Identifier (SSID) is used in methods 7 to 13 to generate a query or other packets, in an alternative version of methods 7 to 13, the SSID is not needed.

FIG. 7 shows an example embodiment of a method 150 performed by one of the interfaces 68 or 70 when the KAS system 60 is used for Tag authentication. In this scenario, the Tag 72 is authenticated using encrypted responses generated at the KAS servers 62, 64 or 66 which are passed down to the interface 68/70. No key is forwarded to the interface 68/70; therefore, the conversation between the interface 68/70 and the tag 72 ends at authentication.

Because no keys are forwarded to the interface 68/70, the scenario can be used in situations in which the interface 68/70 cannot be trusted with a key.

To provide for mutual authentication between one of the interfaces 68 and 70 and the tag 72, one of the KAS servers 62, 64 or 66 generates the challenge vector and the response vector for both the interface 68/70 and the tag 72 and pass these vectors to the appropriate interface 68/70. In this scenario, the interface 68 or 70 acts as a relay point between the KAS server 62, 64 or 66 and the tag 72. Because the interface 68/70 has no key, and the KAS server 62, 64 or 66 serves only as an authenticator, there is no provision for encrypted communication following authentication.

At step 152, the interface 68/70 broadcasts a query message onto the data link to the one or more of the tags 72. The query message contains the SSID value, which is a nonce value that the interface 68/70 generates. Communication between one of the tags 72 and the interface 68/70 can be based on a medium access control process or another anti-collision process so that one tag is using the communication medium at any one time. The interface 68/70 attempts to identify all tags by broadcasting a query to all tags. The tags participate in the anti-collision or medium access control process and as a result are individually identified. There can be many variants to this process as is known by those skilled in the art.

At step 154, each tag 72 receiving the query message generates a random initial vector (IV), and then using its secret key, generates a unique device vector (dv) value using the Hummingbird encryption algorithm initialized with the SSID and IV values. Taking turns, each of these tags 72 then transmits a query response packet containing these values back across the data link to the interface 68/70.

At step 156, the interface 68/70 receives a data link Packet Data Unit (PDU) containing the IV and dv parameters that were transmitted by the tag 72. The interface 68/70 creates a unique session identifier (sid), which it uses to identify and reference the session between itself and a particular tag 72. The SSID, IV, and dv values are stored in a record referenced by the sid.

The interface 68/70 initiates a tag authentication request (TAR) packet to one of the KAS servers 62, 64 or 66 that manages its local domain. The TAR packet contains the sid, a type code identifying the type of response expected, as well as the SSID, IV and dv parameters that collectively and secretly identify the tag 72. At the same time the interface 68/70 transmits the TAR packet it starts a retry timer and initializes a retry counter.

The TAR packet is transmitted using an IPsec transport mode AH packet so that the KAS servers 62, 64 or 66 can authenticate the interface 68/70 it was sent from.

At step 158, the lowest KAS server 66 in the logical hierarchy of the KAS system 60 receives the TAR packet that was sent to it from the interface 68/70. The TAR packet is authenticated using the IPsec AH digest. The KAS server 66 creates a session record using the sid as a reference. It then initiates a FastKey search of its key list using the parameters from the TAR packet. In the scenario shown in FIG. 7, the FastKey search is successful. If the search is not successful, then various steps can be taken including the best practices approach for encrypted conversations as is known by those skilled in the art. It should be noted that this applies to the other instances of searches described in the following examples in which the search can fail.

At step 160, because the FastKey search is successful, the KAS server 62, 64 or 66 that performed the search sends an affirmative response (AA) packet back to the interface 68/70. The type of AA packet returned is identified by the type code that was sent in the TAR packet. The response type may be further validated by the appropriate KAS server 62, 64 or 66. It should be noted that the term “appropriate KAS server” denotes which KAS server received the TAR, performs the required actions and communicates with the interface 68/70. Further, it should be noted that the notation “interface 68/70” means that one or both of the interfaces 68 and 70 are communicating with other elements within the KAS system 60 and that this notation is used throughout this description. To prepare the AA packet, the KAS server 62, 64 or 66 first generates a random challenge vector. Then, using the matching key found using the FastKey search, it generates challenge response vectors (reader_rsp, tag_rsp) using the Hummingbird encryption algorithm initialized with the SSID and IV values.

The AA packet may be transmitted using an IPsec transport mode ESP packet to prevent an eavesdropper from being able to spoof the responses.

At step 162, on reception of the AA packet sent by the KAS server 62, 64 or 66, the interface 68/70 uses the sid to reference the previously created session record and cancels the retry timer.

At step 164, the interface 68/70 forwards the challenge vector and the reader_rsp vector from the AA packet across the data link to the tag 72.

At step 166, the tag 72 receives the data link PDU containing the challenge vector and reader_rsp vector. Using its current encryption engine state, the tag 72 generates a corresponding response vector, which it compares to the reader_rsp vector from the received PDU. If they match, then the tag 72 has authenticated with the interface 68/70.

At step 168, from its current encryption engine state the tag 72 generates the tag_rsp vector and transmits it across the data link to the interface 68/70.

At step 170, the interface 68/70 receives the PDU containing the tag_rsp vector. The interface 68/70 compares the tag_rsp vector from the received PDU with the tag_rsp value it previously received from the AA packet. If they match, then the interface 68/70 has authenticated the tag 72. At this point the authentication phase is complete and the command phase begins.

At this point no additional secure data may be communicated across the data link between the interface 68/70 and the tag 72 because the interface 68/70 does not have a key.

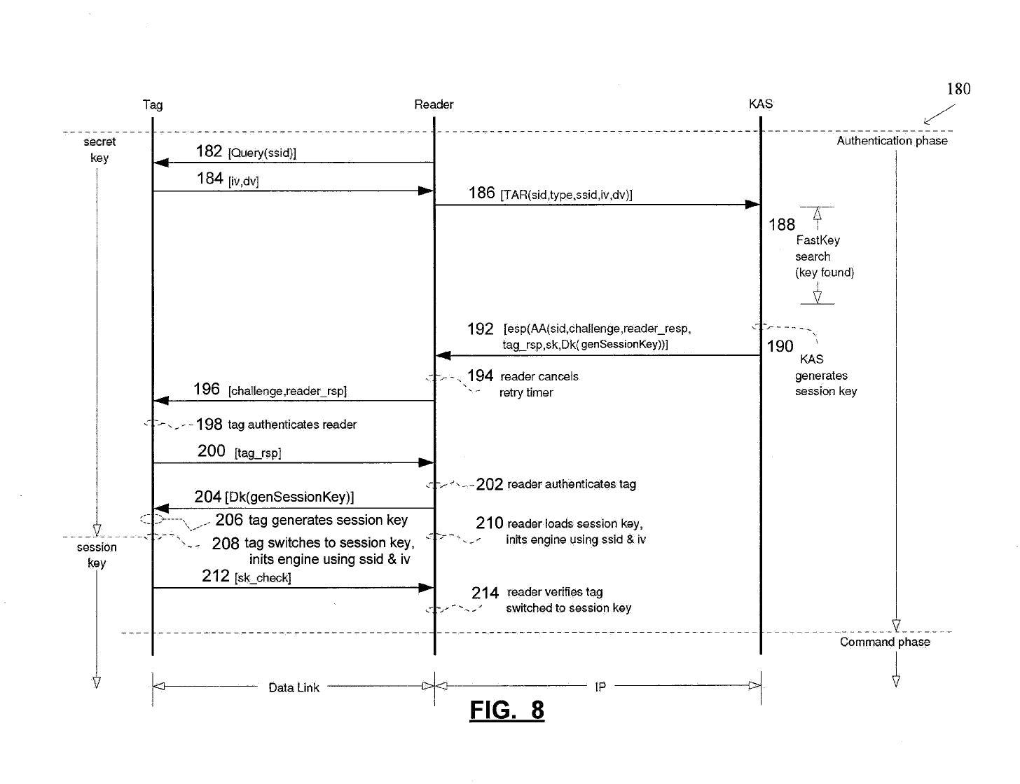

Referring now to FIG. 8, illustrated therein is an example embodiment of a method 180 for one of the tags 72 to generate a session key. In this scenario, during authentication, session keys are generated at the tag 72 and the KAS server 62, 64 or 66. Following initial authentication of the tag 72 at the KAS server 62, 64 or 66, the session key is forwarded from the KAS server 62, 64 or 66 to the interface 68/70. The interface 68/70 completes the mutual authentication.

As in the method 150 shown in FIG. 7, the KAS server 62, 64 or 66 generates the challenge vector and response vectors required for mutual authentication between the interface 68/70 and the tag 72. In addition the KAS server 62, 64 or 66 generates a session key with a value that is derived from the secret key of the tag 72 and the SSID and IV. This is passed to the interface 68/70 along with the challenge and response vectors.

The tag 72 generates a session key using the same procedure as the KAS server 62, 64 or 66, therefore resulting in the same key value. In this way the interface 68/70 and the tag 72 are provided the same session key, which the interface 68/70 and the tag 72 then use for secure communication following mutual authentication.

The method 180 starts at step 182, where the interface 68/70 broadcasts a query message onto the data link to the tag(s) 72. The query message contains the SSID value, which is a nonce value that the interface 68/70 generates.

At step 184, each tag 72 receiving the query message generates a random initial vector (IV), and then using its secret key, it generates a unique device vector (dv) value using the Hummingbird encryption algorithm initialized with the SSID and IV values. Taking turns, each of these tags 72 then transmits a query response packet containing these values back across the data link to the interface 68/70.

At step 186, the interface 68/70 receives a data link PDU containing the IV and dv parameters that were transmitted by the tag 72. The interface 68/70 creates a unique session identifier (sid), which it uses to identify and reference the session between the interface 68/70 and one of the tags 72. The SSID, IV, and dv values are stored in a record referenced by sid. The interface 68/70 initiates a tag authentication request (TAR) packet and sends it to the KAS server 62, 64 or 66 that manages its local domain.

The TAR packet contains sid, a type code identifying the type of response expected, and the SSID, IV, and dv parameters that collectively and secretly identify the tag 72. At the same time the interface 68/70 transmits the TAR packet it starts a retry timer and initializes a retry counter.

The TAR packet is transmitted using an IPsec transport mode AH packet so that the appropriate KAS server can authenticate the interface 68/70 it was sent from.

At step 188, the appropriate KAS server 62, 64 or 66 receives the TAR packet that was sent from the interface 68/70. The TAR packet is authenticated using the IPsec AH digest. The receiving KAS server 62, 64 or 66 creates a session record using the sid as a reference. It then initiates a FastKey search of its key list using the parameters from the TAR packet. In the scenario shown in FIG. 8, the FastKey search is successful.

At step 190, using the SSID, IV, dv parameters and the matched key, the appropriate KAS server 62, 64 or 66 generates a session key (sk) from a series of cipher text values. The resulting session key should match the one generated by the tag 72.

At step 192, because the FastKey search is successful, the KAS server 62, 64 or 66 sends an affirmative response (AA) packet back to the interface 68/70. The type of AA packet returned is identified by the type code that was sent in the TAR packet. The response type may be further validated by the KAS server 62, 64 or 66.

To prepare the AA packet, the KAS server 62, 64 or 66 generates a random challenge vector. Then, using the matching key found using the FastKey search it generates challenge response vectors (reader_rsp, tag_rsp) using the Hummingbird encryption algorithm initialized with the SSID and IV values (in practice these values can be generated by the KAS server 62, 64 or 66 prior to generation of the session key).

The KAS server 62, 64 or 66 also generates an encoded genSessionKey command. The command is encoded using the Hummingbird decryption process. The AA packet is assembled containing the sid, the challenge and response vectors, the session key, and the encoded genSessionKey command.

The AA packet is transmitted to the interface 68/70 using an IPsec transport mode ESP packet to maintain confidentiality of the session key.

At step 194, upon reception of the AA packet sent by the appropriate KAS server 62, 64 or 66, the interface 68/70 uses the sid to reference the previously created session record and cancels the retry timer.

At step 196, the interface 68/70 stores the session key in the session record referenced by sid. The interface 68/70 then forwards the challenge vector and the reader_rsp vector from the AA packet across the data link to the tag 72.

At step 198, the tag 72 receives the data link PDU containing the challenge vector and reader_rsp vector. Using its current encryption engine state, the tag 72 generates a corresponding response vector, which it compares to the reader_rsp vector from the received PDU. If they match, then the tag 72 has authenticated the reader.

At step 200, from its current encryption engine state the tag 72 generates the tag_rsp vector and transmits it across the data link to the interface 68/70.

At step 202, the interface 68/70 receives the PDU containing the tag_rsp vector. The interface 68/70 compares the tag_rsp vector from the received PDU with the tag_rsp value it previously received from the AA packet. If they match, then the interface 68/70 has authenticated the tag 72.

At step 204, the interface 68/70 forwards the encoded genSessionKey command it received from the AA packet to the tag 72.

At step 206, the tag 72 receives the encoded genSessionKey command and decodes it using the current state of its Hummingbird encryption engine. This then causes the tag 72 to generate a session key from a series of cipher text values. The session key it generates should match the session key generated in the same way by the appropriate KAS server 62, 64 or 66.

At step 208, the tag 72 loads the session key into the encryption engine and initializes the engine using the SSID and IV values to ready it for subsequent data transformations.

At step 210, the interface 68/70 loads the encryption engine with the session key from the AA packet and initializes the engine using the SSID and IV values from the session record.

At step 212, the tag 72 uses the current state of the encryption engine to generate a session key check vector (sk_check). The tag 72 sends this value across the data link to the interface 68/70.

At step 214, the interface 68/70 receives the PDU containing the session key check vector from the tag 72. The interface 68/70 uses the current state of the encryption engine to generate a session key check vector using the same procedure that was used by the tag.

The interface 68/70 compares the resulting vector with the vector received from the tag 72. If they match then the interface 68/70 has validated that the tag 72 has successfully switched to the session key and the session keys on the interface 68/70 and the tag 72 are the same.

At this point the authentication phase is complete and the command phase begins.

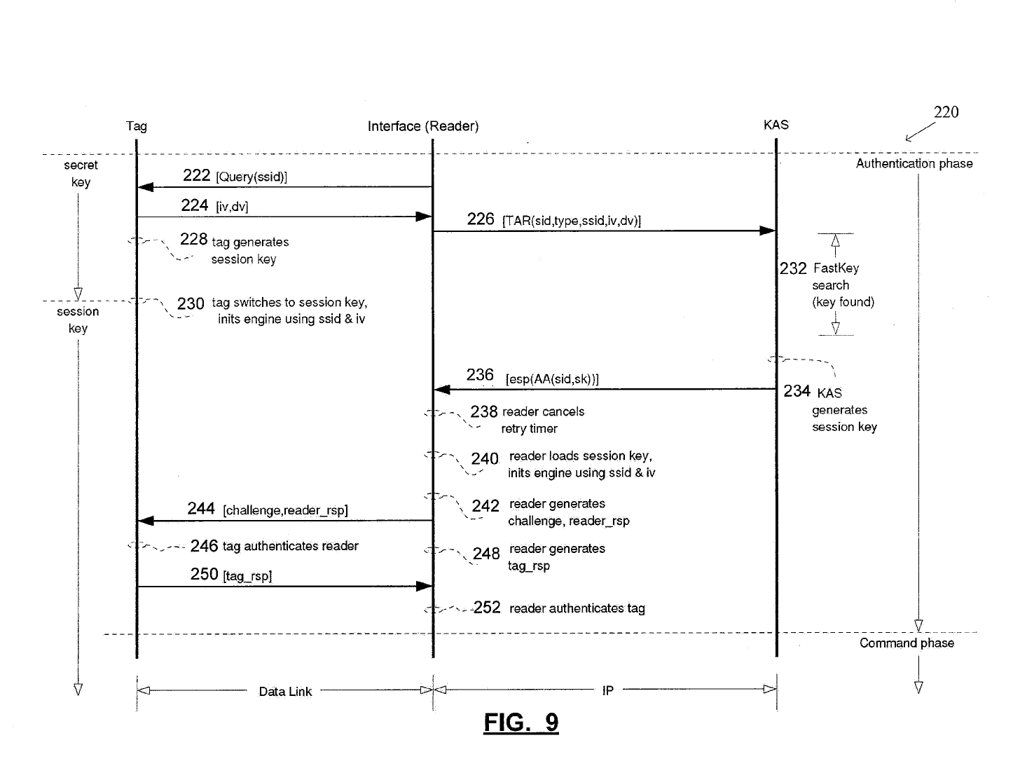

Referring now to FIG. 9, illustrated therein is a method 220 for one of the tags 72 to generate a session key. The method 220 is similar to method 180 except that the tag 72 automatically generates the session key and switches to it following its response to a query from the interface 68/70 (which in some cases is triggered by the type of query).

As in method 180, one of the KAS servers 62, 64 or 66 generates a session key and passes it to the interface 68/70. The session keys on the tag 72 and interface 68/70 should match. The mutual authentication process is then completed between the interface 68/70 and the tag 72 using the session key instead of the secret key. In this scenario the interface 68/70 generates the challenge vector and the response vectors for the interface 68/70 and the tag 72, thereby off-loading this work from the KAS server 62, 64 or 66. Because the interface 68/70 has a key, it can continue secured communication with the tag 72 following the authentication phase.

The method 220 starts at step 222, at which the interface 68/70 broadcasts a query message onto the data link to the tag(s) 72. The query message contains the SSID value, which is a nonce value that the interface 68/70 generates.

At step 224, each tag 72 receiving the query message generates a random initial vector (IV), and then using its secret key it generates a unique device vector (dv) value using the Hummingbird encryption algorithm initialized with the SSID and IV values. Taking turns, each of these tags 72 then transmits a query response packet containing these values back across the data link to the interface 68/70.

At step 226, the interface 68/70 receives a data link PDU containing the IV and dv parameters that were transmitted by the Tag 72. The interface 68/70 creates a unique session identifier (sid), which it uses to identify and reference the session between the interface 68/70 and a particular tag 72. The SSID, IV, and dv values are stored in a record referenced by sid.

The interface 68/70 initiates a tag authentication request (TAR) packet to one of the KAS servers 62, 64 or 66 that manages its local domain. The TAR packet contains sid, a type code identifying the type of response expected, and the SSID, IV, and dv parameters that collectively and secretly identify the tag 72. At the same time that the interface 68/70 transmits the TAR packet it starts a retry timer and initializes a retry counter. The TAR packet is transmitted using a IPsec transport mode AH packet so that the appropriate KAS server 62, 64 or 66 can authenticate the interface 68/70 that the TAR packet was sent from.

At step 228, without reinitializing its encryption engine, the tag 72 generates a session key from a series of cipher text values.

At step 230, the tag 72 then loads the session key into the encryption engine and initializes the engine using the SSID and IV values to ready it for subsequent data transformations.

At step 232, the appropriate KAS server 62, 64 or 66 receives the TAR packet that was sent to it from the interface 68/70. The TAR packet is authenticated using the IPsec AH digest. The appropriate KAS server 62, 64 or 66 creates a session record using the sid as a reference. It then initiates a FastKey search of its key list using the parameters from the TAR packet. In the scenario shown, the FastKey search is successful.

At step 234, using the SSID, IV, dv parameters and the matched key, the appropriate KAS server 62, 64 or 66 generates a session key from a series of cipher text values. The resulting session key should match the one generated by the tag 72.

At step 236, because the FastKey search is successful, the appropriate KAS server 62, 64 or 66 sends an affirmative response (AA) packet back to the interface 68/70. The type of AA packet returned is identified by the type code that was sent in the TAR packet. The response type may be further validated by the appropriate KAS server 62, 64 or 66. In this case the AA packet returned to the interface 68/70 only contains the sid and the session key (sk). The AA packet is transmitted using an IPsec transport mode ESP packet to maintain confidentiality of the session key.

At step 238, upon reception of the AA packet sent by the appropriate KAS server 62, 64 or 66, the interface 68/70 uses the sid to reference the previously created session record and cancels the retry timer.

At step 240, the interface 68/70 stores the session key, from the AA packet that was just received, in the session record referenced by sid. The interface 68/70 loads the encryption engine with the session key and initializes the engine using the SSID and IV values from the session record.

At step 242, the interface 68/70 generates a random challenge vector. Then it generates challenge response vector (reader_rsp) using the Hummingbird encryption algorithm.

At step 244, the challenge vector and reader_rsp vector are transmitted to the tag 72 across the data link.

At step 246, the tag 72 receives the data link PDU containing the challenge vector and reader_rsp vector. Using its current encryption engine state, the tag 72 generates a corresponding challenge response vector, which it compares to the reader_rsp vector from the received PDU. If they match, then the tag 72 has authenticated the interface 68/70.

At step 248, the interface 68/70 generates the tag_rsp vector, which is the response to the challenge that it expects from the tag 72.

At step 250, the tag 72 generates its own response vector (tag_rsp) based on its current state and transmits it across the data link to the interface 68/70.

At step 252, the interface 68/70 receives the PDU containing the tag_rsp vector from the tag 72 and compares it to the corresponding vector that it previously generated. If they match, then the interface 68/70 has authenticated the tag 72. At this point the authentication phase is complete and the command phase begins.

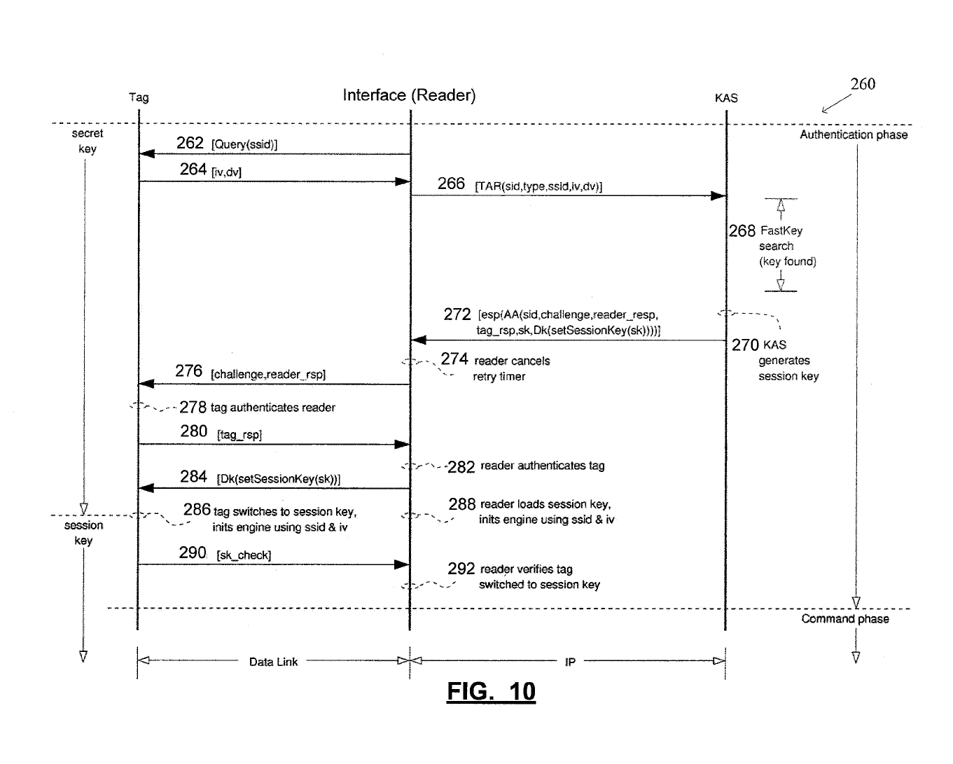

Referring now to FIG. 10, illustrated therein is an example embodiment of a method 260 wherein one of the KAS servers 62, 64 or 66 generates a session key.

In method 260, following initial authentication of the tag 72 at one of the KAS servers 62, 64 or 66, the appropriate KAS server 62, 64 or 66 generates encrypted authentication responses, then generates a session key, and encrypts the session key. This KAS server then forwards the encrypted responses and encrypted key to the interface 68/70. The interface 68/70 uses encrypted responses to perform mutual authentication. It then passes the encrypted session key to the tag 72. The interface 68/70 and the tag 72 then use the session keys for subsequent communication.

As it processes an authentication request, the KAS server 62, 64 or 66 generates a session key that will be used for secure communication between the interface 68/70 and the tag 72. To provide for mutual authentication between interface 68/70 and the tag 72, the appropriate KAS server 62, 64 or 66 generates the challenge vector and response vectors for both the interface 68/70 and the tag 72 and pass these vectors to the interface 68/70. Using secure transport, the appropriate KAS server 62, 64 or 66 then passes the challenge and response vectors and the session key to the interface 68/70. Additionally the session key is embedded within a setSessionKey command, which is encoded (decrypted) using the Hummingbird encryption algorithm to securely pass the session key between the interface 68/70 and the tag 72.

An advantage of the method 260 is increased security. Because the KAS server 62, 64 or 66 creates the session key, the procedure for its creation is controlled and maintained within the secure environment of the KAS server 62, 64 or 66 and could even be periodically changed for enhanced security.

However, in the method 260, the KAS server 62, 64 or 66 is responsible for a significantly larger amount of effort because it generates the challenge and response vectors, generate the session key, and format and then decrypt the setSessionKey command prior to sending the AA message to the interface 68/70.

The method 260 begins at step 262, in which the interface 68/70 broadcasts a query message onto the data link to the tag(s) 72. The query message contains the SSID value, which is a nonce value that the interface 68/70 generates.

At step 264, each tag 72 that receives the query message generates a random initial vector (IV), and then using its secret key it generates a unique device vector (dv) value using the Hummingbird encryption algorithm initialized with the SSID and IV values. Taking turns, each of these tags 72 then transmits a query response packet containing these values back across the data link to the interface 68/70.

At step 266, the interface 68/70 receives a data link PDU containing the IV and dv parameters that were transmitted by the tag 72. The interface 68/70 creates a unique session identifier (sid), which it uses to identify and reference the session between the interface 68/70 and a particular tag 72. The SSID, IV, and dv values are stored in a record referenced by sid.

The interface 68/70 then initiates a tag authentication request (TAR) packet to its logically nearest KAS server 66 in the hierarchy that manages its local domain. In practice, distribution white lists can be used by the KAS servers to determine which other servers or elements can be communicated with. As an example, this approach can be used for root KMS servers to communicate only with top level intermediate KMS servers and for authority KMS servers to communicate with only root KMS servers. The TAR packet contains sid, a type code identifying the type of response expected, and the SSID, IV, and dv parameters that collectively and secretly identify the tag 22. At the same time it transmits the TAR packet it starts a retry timer and initializes a retry counter.

The TAR packet is transmitted using an IPsec transport mode AH packet so that the KAS server 66 can authenticate the interface 68/70 that it was sent from.

At step 268, the KAS server 66 receives the TAR packet that was sent to it from the interface 68/70. The TAR packet is authenticated using the IPsec AH digest. The KAS server 66 creates a session record using the sid as a reference. It then initiates a FastKey search of its key list using the parameters from the TAR packet. The method 260 shown in FIG. 10 deals with the scenario when the FastKey search is successful by one of the KAS servers 62, 64, or 66.

At step 270, using the SSID, IV, dv parameters and the matched key, the appropriate KAS server 62, 64 or 66 generates a session key.

At step 272, the appropriate KAS server 62, 64 or 66 sends an affirmative response (AA) packet back to the interface 68/70 because the FastKey search is successful. The type of AA packet returned is identified by the type code that was sent in the TAR packet. The response type may be further validated by the appropriate KAS server 62, 64 or 66.

To prepare the AA packet, the appropriate KAS server 62, 64 or 66 first generates a random challenge vector. Then, using the matching key found using the FastKey search it generates challenge response vectors (reader_rsp, tag_rsp) using the Hummingbird encryption algorithm initialized with the SSID and IV values. The state of the Hummingbird encryption/decryption engine is preserved for the next step.

The appropriate KAS server 62, 64 or 66 then formats a setSessionKey tag command containing the session key as a parameter. Then, using the preserved state of the encrypt/decrypt engine, the appropriate KAS server 62, 64 or 66 encodes the entire command using the Hummingbird decryption algorithm. The resulting AA packet contains sid, the challenge vector, both challenge response vectors, the session key (sk), and the decrypted setSessionKey command containing the session key.

The AA packet is transmitted using an IPsec transport mode ESP packet to prevent an eavesdropper from being able to spoof the responses.

At step 274, upon reception of the AA packet sent by the appropriate KAS server 62, 64 or 66, the interface 68/70 uses the sid to reference the previously created session record and cancels the retry timer.

At step 276, the interface 68/70 forwards the challenge vector and the reader_rsp vector from the AA packet across the data link to the tag 72.

At step 278, the tag 72 receives the data link PDU containing the challenge vector and reader_rsp vector. Using its current encryption engine state, the tag 72 generates a corresponding response vector, which it compares to the reader_rsp vector from the received PDU. If they match, then the tag 27 has authenticated the interface 68/70.

At step 280, the tag 72 generates the tag_rsp vector based on its current encryption engine state and transmits the tag_rsp vector across the data link to the interface 68/70.

At step 282, the interface 68/70 receives the PDU containing the tag_rsp vector. The interface 68/70 generates a corresponding response vector and compares it to the tag_rsp vector from the received PDU. If they match, then the interface 68/70 has authenticated the tag 72.

At step 284, the interface 68/70 forwards the encoded setSessionKey command across the data link to the tag 72.

At step 286, the tag 72 receives the PDU containing the setSessionKey command from the data link. From its current encryption engine state the tag 72 encrypts the command code. Because the command was encoded using decryption, encryption of the command code causes decoding of the command and the session key that it contains.

The tag 72 executes the setSessionKey command. It does this by loading the session key into the Hummingbird encryption engine and initializes the engine using the saved SSID and IV vector values.

At step 288, the interface 68/70 loads the session key into an instance of the Hummingbird encryption/decryption engine and initializes the engine using the SSID and IV vector values it had previously stored in the session record.

At step 290, the tag 72 uses the current state of the encryption engine to generate a session key check vector (sk_check). The tag 72 sends this value across the data link to the interface 68/70.

At step 292, the interface 68/70 receives the PDU containing the session key check vector from the tag 72. The interface 68/70 uses the current state of the encryption engine to generate a session key check vector using the same procedure that was used by the tag 72. The interface 68/70 compares the resulting vector with the vector from the tag 72. If they match then the interface 68/70 has validated that the tag 72 has successfully switched to the session key and the session keys on the interface 68/70 and the tag 72 are the same.

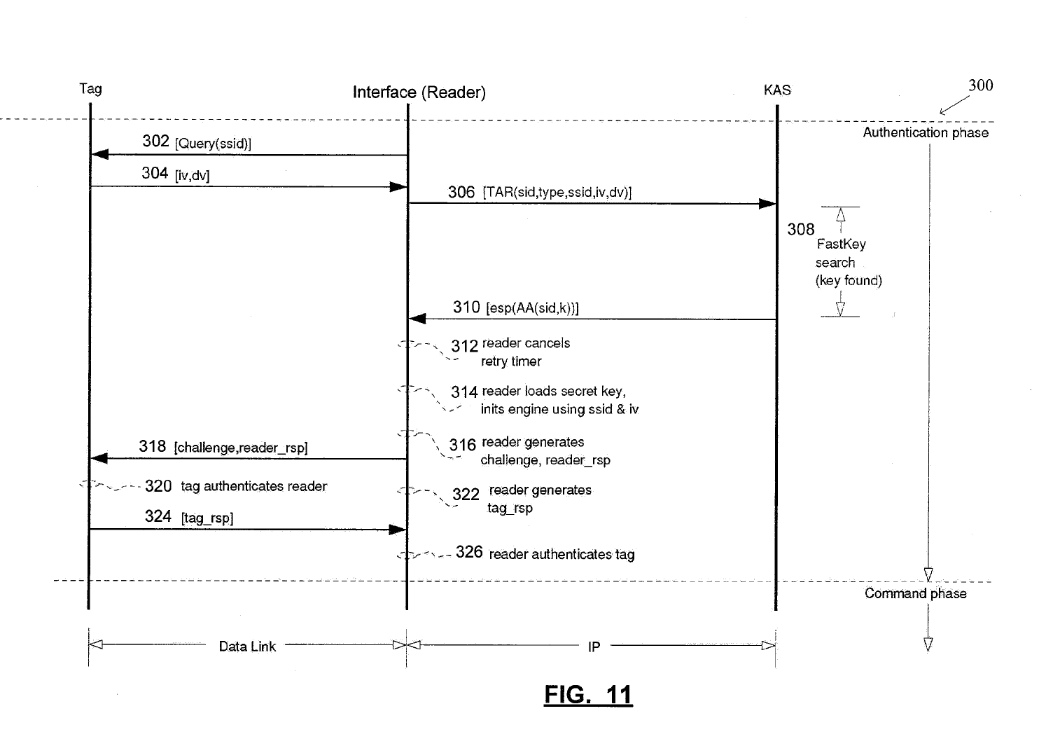

Referring now to FIG. 11, illustrated therein is a method 300 wherein the interface 68/70 is passed a secret key following the initial authentication of the tag 72 at one of the KAS servers 62, 64 or 66. The interface 68/70 uses the secret key to complete mutual authentication and for subsequent communication.

That is, following authentication of the reader (using IPsec AH) and initial authentication of the tag 72 using a FastKey search, the appropriate KAS server 62, 64 or 66 forwards the tag's secret key to the reader. The secret key is forwarded using IPsec ESP transport to maintain its secrecy. The interface 68/70 and the tag 72 are now able to commence mutual authentication using their shared secret.

Because the interface 68/70 has a key, it can continue secured communication with the tag 72 following the authentication phase. However, since the secret key is distributed beyond the perimeters and security of the authentication network 61, the level of security for method 300 may be decreased.

The method 300 begins at step 352, in which the interface 68/70 broadcasts a query message onto the data link to the tag(s) 72. The query message contains the SSID value, which is a nonce value that the interface 68/70 generates.

At step 304, each of the tags 72 that receives the query message generates a random initial vector (IV), and then uses its secret key to generate a unique device vector (dv) value using the Hummingbird encryption algorithm initialized with the SSID and IV values. Taking turns, each of these tags 72 then transmits a query response packet containing these values back across the data link to the interface 68/70.

At step 306, the interface 68/70 receives a data link PDU containing the IV and dv parameters that were transmitted by the tag 72. The interface 68/70 creates a unique session identifier (sid), which it uses to identify and reference the session between the interface 68/70 and a particular tag 72. The SSID, IV, and dv values are stored in a record referenced by sid.

The interface 68/70 initiates a tag authentication request (TAR) packet to one of the KAS servers 62, 64 or 66 that manages its local domain. The TAR packet contains sid, a type code identifying the type of response expected, and the SSID, IV, and dv parameters that collectively and secretly identify the tag 72. At the same time the interface 68/70 transmits the TAR packet it starts a retry timer and initializes a retry counter.

The TAR packet is transmitted using an IPsec transport mode AH packet so that the appropriate KAS server 62, 64 or 66 can authenticate the interface 68/70 that the TAR packet was sent from.

At step 308, the appropriate KAS server 62, 64 or 66 receives the TAR packet that was sent to it from the interface 68/70. The TAR packet is authenticated using the IPsec AH digest. The appropriate KAS server 62, 64 or 66 creates a session record using the sid as a reference. It then initiates a FastKey search of its key list using the parameters from the TAR packet. The method 300 shown in FIG. 11 proceeds on the assumption that the FastKey search is successful.

At step 310, the appropriate KAS server 62, 64 or 66 sends an affirmative response (AA) packet back to the interface 68/70 because the FastKey search is successful. The type of AA packet returned is identified by the type code that was sent in the TAR packet. The response type may be further validated by the appropriate KAS server 62, 64 or 66. In this case the AA packet returned to the interface 68/70 only contains the sid and the matched key, which is the tag's secret key (k). The AA packet is transmitted using an IPsec transport mode ESP packet to maintain confidentiality of the secret key.

At step 312, upon reception of the AA packet sent by the appropriate KAS server 62, 64 or 66, the interface 68/70 uses the sid to reference the previously created session record and cancels the retry timer.

At step 314, the interface 68/70 stores the secret key in the session record referenced by sid. The interface 68/70 loads the encryption engine with the secret key and initializes the engine using the SSID and IV values from the session record.

At step 316, the interface 68/70 generates a random challenge vector. Then it generates a challenge response vector (reader_rsp) using the Hummingbird encryption algorithm.

At step 318, the challenge vector and reader_rsp vector are transmitted to the tag 72 across the data link.

At step 320, the tag 72 receives the data link PDU containing the challenge vector and reader_rsp vector. Using its current encryption engine state, the tag 72 generates a corresponding challenge response vector, which it compares to the reader_rsp vector from the received PDU. If they match, then the tag 72 has authenticated the interface 68/70.

At step 322, the interface 68/70 generates the tag_rsp vector, which is the response to the challenge that it expects from the tag 72.

At step 324, the tag 72 generates its own response vector (tag_rsp) based on its current state and transmits the response vector across the data link to the interface 68/70.

At step 326, the interface 68/70 receives the PDU containing the tag_rsp vector from the tag 72 and compares it to the corresponding vector that it previously generated. If they match, then the interface 68/70 has authenticated the tag 72. At this point the authentication phase is complete and the command phase begins.

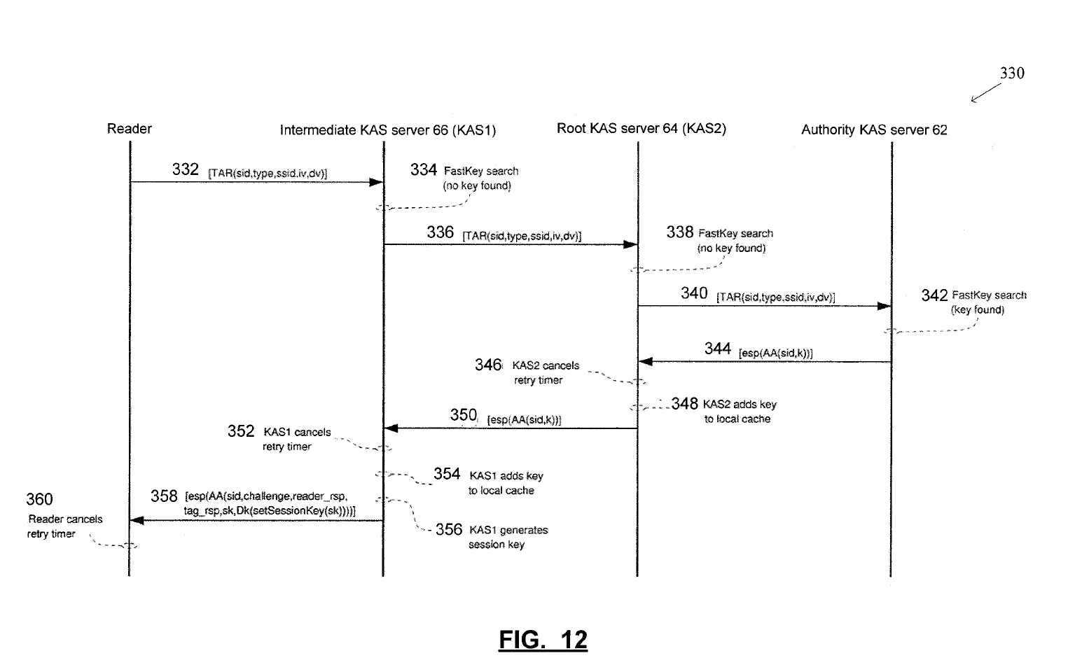

Referring now to FIG. 12, illustrated therein is an example embodiment of a method 330 for authentication of tags 72 involving multiple KAS servers and TAR propagation. This method 330 describes how authentication requests are handled within a hierarchical network of KAS servers.

The intermediate KAS server 66 and the root KAS server 64 are caching servers that manage the validation of a tag 72 for the interface 68/70 and/or KAS servers below them in the hierarchy. The method 330 operates on the assumption that, neither the root KAS 64 nor the intermediate KAS 66 holds the key to the tag 72 being validated in its key-search cache at the time that the authentication request occurs. Therefore, the authentication request is propagated up the hierarchy.

In this example, the authoritative KAS server 62 or an upstream (i.e. higher in the hierarchy) caching KAS server happens to hold the key in its key-search cache when the request reaches it. Since these KAS servers can validate the key, the AA response from one of these KAS servers contains the key to the tag 72 and sends it to the downstream KAS server that propagated the request, assuming that the downstream KAS server is authorized to receive the key. The downstream root KAS server 64 populates the key into its key-search cache to more efficiently handle subsequent authentications of the same tag 72. For the same reason, and assuming that the intermediate KAS server 66 is authorized to receive the key, the root KAS server 64 passes the key to the intermediate KAS server 66.

In this scenario, the interface 68/70 making the authentication request is just downstream of the intermediate KAS server 66. Therefore, the AA response from the intermediate KAS server 66 is appropriate for an interface, and not a KAS server. In this case, the AA response contains a session key (see method 260).

To maintain security within the authentication network 61, propagated TAR and AA packets are protected using IPsec. The propagated TAR packets are transmitted using IPsec transport mode AH. AA packets are transmitted using IPsec transport mode ESP encapsulation to add confidentiality.

Generally, only the steps involved in the communication between the interface 68/70 and the KAS servers are shown for simplicity and described below as the steps between the interface 68/70 and the tag 72 have been described in the previous methods.

The method 330 begins at step 332 wherein the intermediate KAS server 66 receives the TAR packet that was sent to it from the interface 68/70. The TAR packet is authenticated using the IPsec AH digest. The intermediate KAS server 66 creates a session record using the sid as a reference.

At step 334, the intermediate KAS server 66 initiates a FastKey search of its key list using the parameters from the TAR packet. In the scenario shown, the FastKey search at KAS server 66 is not successful.

At step 336, the intermediate KAS server 66 propagates the failed key search request to the root KAS server 64. A TAR packet containing the parameters originally sent by the interface 68/70, which now reside in the session record is forwarded to the root KAS server 64. The type field contains an indicator that identifies the packet as a propagated TAR packet.

The TAR packet is transmitted using a IPsec transport mode AH packet so that the KAS server 64 can authenticate the packet source as KAS server 66.

The intermediate KAS server 66 starts a retry timer and initializes a retry counter.

At step 338, the root KAS server 64 receives the TAR packet that was propagated from the intermediate KAS server 66. The root KAS server 64 creates a session record using the sid as a reference. It then initiates a FastKey search of its key list using the parameters from the TAR packet. In the scenario shown in the diagram above, the FastKey search at the root KAS 64 also fails to match a key.

At step 340, the root KAS server 64 propagates the failed key search request to the authority KAS server 62. The root KAS server 64 forwards the TAR packet to the authority KAS server 62 in the same manner that the TAR packet was forwarded from the intermediate KAS server 66 to the root KAS server 64. The root KAS server 64 starts a retry timer and initializes a retry counter.

At step 342, the authority KAS server 62 receives the TAR packet that was propagated from the root KAS server 64. The authority KAS server 62 creates a session record using the sid as a reference. It then initiates a FastKey search of its key list using the parameters from the TAR packet. In the example of method 330 shown, it is assumed that the FastKey search at the authority KAS server 62 is successful.

At step 344, the authority KAS server 62 sends an affirmative response (AA) packet back to the root KAS server 64 because the FastKey search is successful. The type of AA packet returned is identified by the type code that was sent in the TAR packet. The response type may be further validated by one of the KAS servers 62, 64, or 66.

In this case the AA packet returned to the root KAS server 64 contains the sid and the matched key, which is the secret key (k) of the tag 72. The AA packet is transmitted using an IPsec transport mode ESP packet to maintain confidentiality of the secret key. It should be noted that in an alternative scenario, the root KAS server 64 may not be authorized to receive the secret key to the tag 72. In this case a session key may be returned to the root KAS server 64 instead of the secret key of the tag 72.

The root KAS server 64 receives the AA packet sent from the authority KAS server 62 and uses the sid to reference the session record for that tag 72. The root KAS server 64 finds that the AA packet matches with the previously propagated TAR packet.

At step 346, the root KAS server 64 cancels the retry timer in the session record.

At step 348, if the root KAS server 64 is a caching server, it adds the key from the AA packet to its local key search cache, allowing it to authenticate the tag 72 containing that key on its own for subsequent authentication requests.

At step 350 the root KAS server 64 determines from the data in the session record that it an AA packet is to be returned to the intermediate KAS server 66. In this case it transmits an AA packet to the intermediate KAS server 66 containing the sid and the key that was passed to it from the authority KAS server 62.

The AA packet is encapsulated in an IPsec ESP transport mode packet for confidentiality. It should be noted that in an alternative scenario, the intermediate KAS server 64 may not be authorized to receive the secret key to the tag 72. In this case a session key may be returned to the intermediate KAS 66 instead of the tag's secret key. The intermediate KAS 66 receives the AA packet sent from the root KAS server 64 and uses the sid to reference the session record for that tag 72. The intermediate KAS server 66 finds that the AA packet matches with the previously propagated TAR packet.

At step 352, the intermediate KAS server 66 cancels the retry timer in the session record.

At step 354, if the intermediate KAS server 66 is a caching KAS server, it adds the key from the AA packet to its local key search cache, allowing it to authenticate the tag 72 containing that key on its own for subsequent authentication requests.

At step 356, the intermediate KAS server 66 determines from the data in the session record that it can now respond to the interface 68/70 that originated the authentication request. In this case the interface 68/70 is expecting a session key that it can share with the tag 72 to complete the authentication process and carry on further communications with the tag 72, as described earlier in method 260. Using its Hummingbird encryption engine, the intermediate KAS server 66 generates a session key.

At step 358, the intermediate KAS server 66 prepares an AA packet containing the challenge, challenge response vectors, session key, and encoded setSessionKey tag command as described in method 260. The AA packet is transmitted to the interface 68/70 using an IPsec transport mode ESP packet. The interface 68/70 receives the AA packet sent from the intermediate KAS server 66 and uses the sid to reference the session record for that tag 72. The interface 68/70 finds that the AA packet matches with a previously transmitted TAR packet.

At step 360, the interface 68/70 cancels the retry timer in the session record.

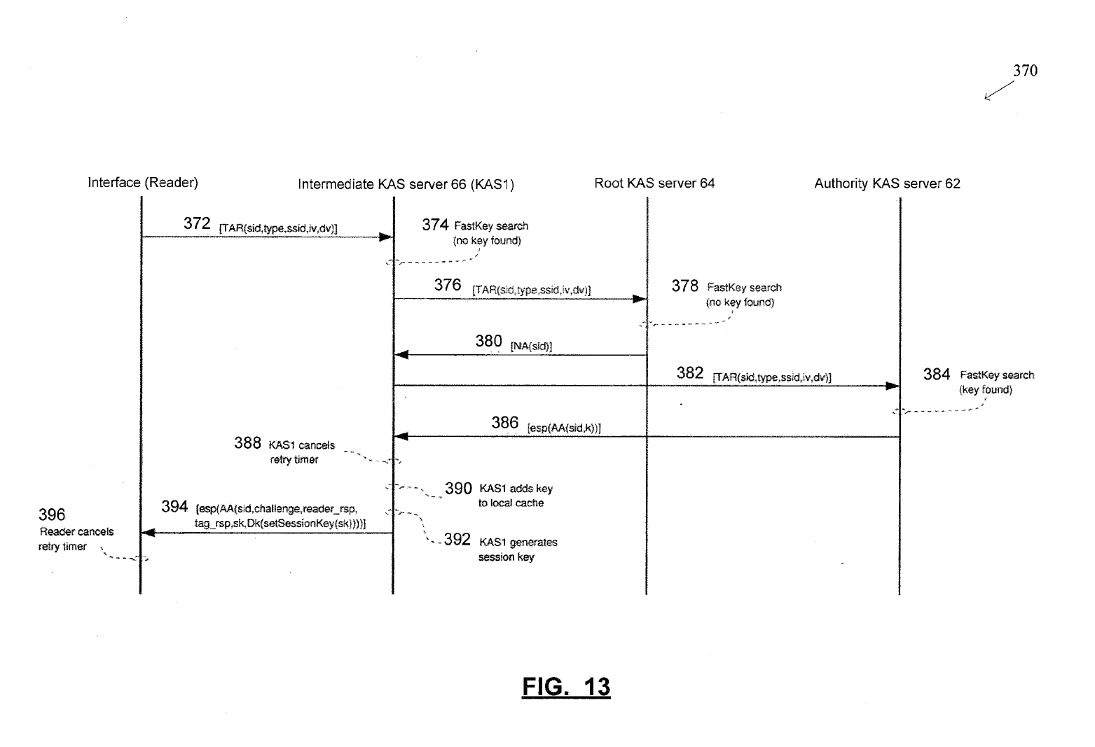

Referring now to FIG. 13, illustrated therein is an example embodiment of a method 370 for handling authentication requests (TAR) within the hierarchy of the KAS servers 62, 64 and 66. In the method 370 as described, the intermediate KAS server 66 and the root KAS server 64 serve the same domain. The root KAS server 64 is the authoritative KAS for that domain. The authority KAS server 62 is a KAS server within a second domain (as described in the KMS system of FIG. 2a).

In this example, neither the intermediate KAS server 66 nor the root KAS server 64 holds the key to the tag being validated in its key-search cache at the time that the authentication request occurs. Accordingly, the authentication request is redirected elsewhere within the hierarchy of the authentication network.

Because it can validate the key, the AA response from the authority KAS server 62 contains the key to the tag (assuming the downstream KAS server is authorized to receive it). The downstream KAS server in this case, the intermediate KAS server 66, populates the key into its key-search cache to more efficiently handle subsequent authentications of the same tag.

In this scenario, the interface 68/70 making the authentication request is just downstream of the intermediate KAS server 66. Therefore the AA response from the intermediate KAS server 66 is appropriate for an interface, and not a KAS server. In this case, the AA packet contains a session key (similar to method 260 above).

To maintain security within the authentication network, the propagated TAR and AA packets are protected using IPsec. The propagated TAR packets are transmitted using IPsec transport mode AH. The propagated AA packets are transmitted using IPsec transport mode ESP encapsulation to add confidentiality.

The steps involving communication between the interface 68/70 and the KAS servers 62, 64 and 66 are described below. The communication that generally occurs between the interface 68/70 and the tag 72 has already been discussed in the previous methods.

At step 372, the intermediate KAS server 66 receives the TAR packet that was sent to it from the interface 68/70. The TAR packet is authenticated using the IPsec AH digest. The KAS server 66 creates a session record using the sid as a reference.

At step 374, the intermediate KAS server 66 initiates a FastKey search of its key list using the parameters from the TAR packet. The method 370 assumes that the FastKey search at KAS1 is not successful in this example.

At step 376, the intermediate KAS server 66 propagates the failed key search request to the root KAS server 64. A TAR packet containing the parameters originally sent by the interface 68/70, which now reside in the session record, is forwarded to the root KAS server 64. The type field contains an indicator that identifies the packet as a propagated TAR packet. The TAR packet is transmitted using an IPsec transport mode AH packet so that the root KAS server 64 can authenticate the packet source as the intermediate KAS server 66. The intermediate KAS server 66 starts a retry timer and initializes a retry counter.

At step 378, the root KAS server 64 receives the TAR packet that was propagated from the intermediate KAS server 66. The root KAS server 64 creates a session record using the sid as a reference. It then initiates a FastKey search of its key list using the parameters from the TAR packet. In the scenario of method 370, the FastKey search at the root KAS 16 also fails to match a key.

At step 380, the root KAS server 64 returns a negative acknowledge (NA) packet to the intermediate KAS server 66 since the root KAS server 64 is the authoritative KAS for this domain and it is unable to match the key. That is, the tag is not a member of this domain and cannot be authenticated here. The intermediate KAS server 66 receives the NA packet and uses the sid to reference the session record and cancel the retry timer.

The intermediate KAS server 66 is configured to try other domains in the case that an authentication request fails within its primary domain. At step 382, the intermediate KAS server 66 consults a list of alternate domains to check with for authorization and the KAS server 66 re-issues the TAR packet to the second KAS server in its list of alternate domains to attempt for authentication. This first KAS server, KAS server 64, was the KAS server that was immediately upstream of the intermediate KAS server 66 and the second KAS server is the KAS server that is two places upstream of the intermediate KAS server 66 in the KAS hierarchy. In this case the second upstream KAS server is the authority KAS server 62.

At step 384, the authority KAS server 62 receives the TAR packet that was sent to it from the intermediate KAS server 66. The authority KAS server 62 creates a session record using the sid as a reference. It then initiates a FastKey search of its key list using the parameters from the TAR packet. The steps described below assume that the FastKey search at the authority KAS server 62 is successful.

At step 386, the authority KAS server 62 sends an affirmative response (AA) packet back to the intermediate KAS server 66 since the FastKey search is successful. The intermediate KAS server 66 receives the AA packet sent from the intermediate KAS server 66 and uses the sid to reference the session record for that tag. The intermediate KAS server 66 finds that the AA packet matches with the previously propagated TAR packet.

At step 388, the intermediate KAS server 66 cancels the retry timer in the session record.

At step 390, if the intermediate KAS server 66 is a caching KAS server, it adds the key from the AA packet to its local key search cache, allowing it to authenticate the tag containing that key on its own for subsequent authentication requests.

At step 392, the intermediate KAS server 66 determines from the data in the session record that it can now respond to the interface 68/70 that originated the authentication request. In this case the interface 68/70 is expecting a session key that it can share with the tag to complete the authentication process and carry on further communications with the tag, as described earlier in method 260. Using its Hummingbird encryption engine, the intermediate KAS server 66 generates a session key.

At step 394, the intermediate KAS server 66 prepares an AA packet containing the challenge, challenge response vectors, session key, and encoded setSessionKey tag command as described in method 330.

The AA packet is transmitted to the interface 68/70 using an IPsec transport mode ESP packet. The interface 68/70 receives the AA packet sent from the intermediate KAS server 66 and uses the sid to reference the session record for that tag. The interface 68/70 finds that the AA packet matches with a previously transmitted TAR packet.

At step 396, the interface 68/70 cancels the retry timer in the session record.

In some embodiments, the KMS system may anticipate the domains at which the tag 72 may be authenticated and push the key to the appropriate domains. For example, if a particular tag 72 is associated with a package being delivered to a known destination, the key associated with the tag 72 may be pushed to domains en route to the destination so that the key is available locally when the tag 72 attempts to authenticate itself with the local authentication networks en route. For example, if the package is supposed to enter the field of interface 68/70 where it will need to be identified and authenticated, the secret key for the package may be pushed by the authority KAS server 62 to the intermediate KAS server 66 that supports interface 68/70. When the package communicates with either interface 68 or 70, the TAR packet will be sent to the intermediate KAS server 66. If the intermediate KAS server 66 has the key it will successfully find it upon doing a FastKey search. If the key is not prepositioned, then the intermediate KAS server 66 will fail the FastKey search and pass the TAR packet to the root KAS server 64 which will ultimately need to pass the TAR packet to the authority KAS server 62 (if the package is from that authority's domain) or send requests to a higher level KAS system to which it is connected.

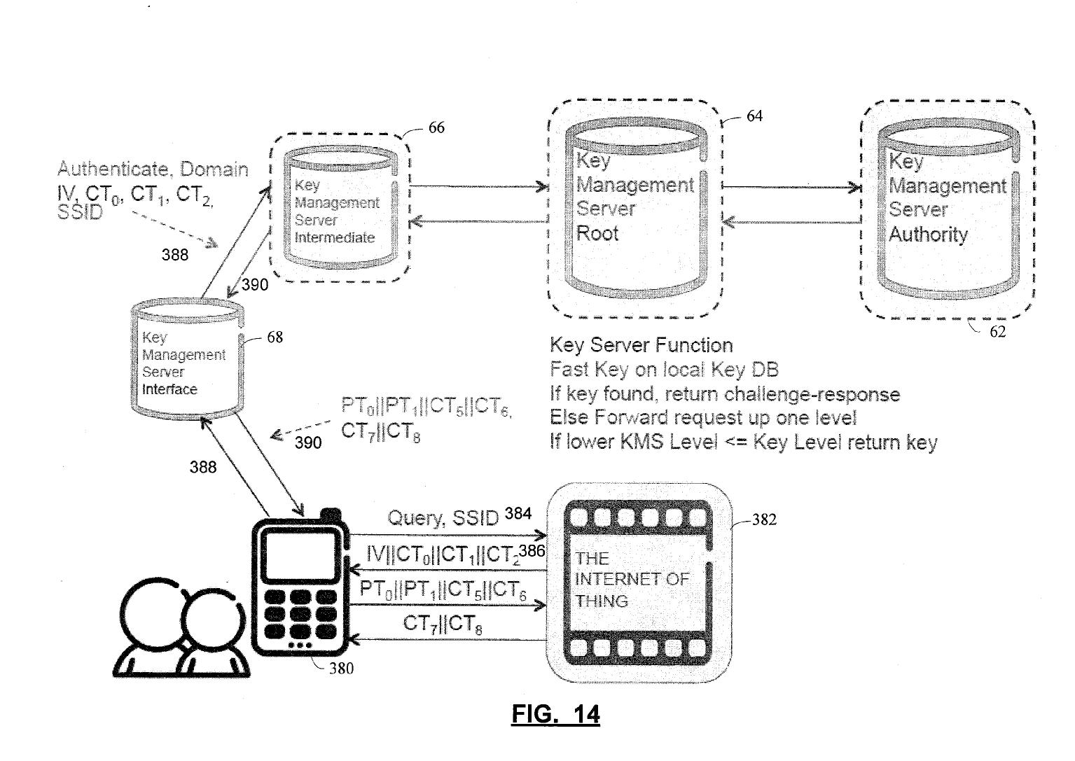

Referring to FIG. 14, shown therein is an example embodiment of a tag authentication process performed by some components of the KAS system 60. FIG. 14 demonstrates the basic movement of the security requests up the hierarchy of the KAS system 60. A device 380 wishes to communicate with another device 382 represented by The Internet of Things (IoT). Accordingly, the device 380 sends a query 384 to the device 382 and receives a secure identifier response 386. The device 380 wishes to authenticate the identity of the IoT device 382, so it sends a security request 388 to the KMS interface (i.e. resolver) server 68. The security request 388 includes the query 384 and the Secure ID 386 of the device 382. The KMS interface server 68 performs a FastKey search and assuming it does not find the appropriate key, the KMS interface server 68 propagates the security request 388 up the hierarchy of the KMS system. This process is repeated until the key is found and the interface challenge and tag response vectors (CTi) 390 are generated and sent back down through the KMS hierarchy to the device 380. The device 380 then authenticates itself and the identity of the IoT device 382. This example corresponds to an instantiation of the method 150 shown in FIG. 7.

To further describe the operation of the KMS system, an electronic toll collection example will now be discussed. Vehicle tolling systems have progressed from human operated toll booths to coin operated booths to electronic toll collection. Electronic toll collection systems are typically based upon RFID technologies that allow for electronic toll collection to occur while the vehicle is traveling at normal highway speeds. In RFID-based electronic toll collection systems, toll tags are affixed to each vehicle and interrogators, also called tag readers, are placed in locations, such as toll booths, where tolls are to be collected. The toll tags are analogous to the devices or tags 72 that have been described for the KAS system 60, while the tag readers are analogous to the interfaces 68 and 70 that have been described for the KAS system 60.

Open road tolling systems take advantage of RFID capabilities to allow for the electronic toll collection to occur without inhibiting the free flow of the traffic through a toll booth, thereby, reducing congestion and improving overall operational efficiency. In open road tolling systems, interrogators are placed at fixed locations on the toll road, typically entrance and exit ramps as well as locations along the length of the toll road. Interrogators at these fixed toll locations are connected via a network to the toll authority that manages the toll road.

Each toll authority issues a toll tag for each vehicle registered with that toll authority. Today, the tags that are increasingly being used are passive RFID tags that harvest all of their operational power from the interrogator's communication signal. This small amount of harvested power limits the communication range to a few meters, and the high speed nature of open road tolling (communicating with toll tags at highway speeds) limits the communication time to a few tens, or possibly even a few hundreds, of milliseconds. Consequently, fast security that is possible to implement on the toll tags is limited to using low power, fast symmetric key ciphers such as Hummingbird or Grain.

The RFID systems in use for electronic toll collection were initially read-only identity tags. These simple tags allow for easy tag identification, but are susceptible to a broad array of attacks including counterfeiting and replay attacks. Counterfeiting and replay attacks allow unauthorized users, i.e., thieves, to unlawfully use a tag owner's identifier and, thus, not pay the toll themselves. Consequently, newer systems utilize symmetric key ciphers and specific security functionality to mitigate attacks on the system.

The primary security functionality that is required is tag identity authentication and interrogator authentication for write access to the tag. Tag identity authentication requires the reader to cryptographically challenge the tag either after it has identified the tag or as part of the identification process. The interrogator authentication is needed to limit write access for toll authorities that write information into the tags such as the last toll passed. In addition to authentication, secure identifiers, such as an encrypted tag identifier, may be used during the identification process to limit tracking and tracing attacks on the vehicle based upon its toll tag.

Due to the mobile nature of vehicles and the use of symmetric key ciphers on the toll tags, a KMS system is required to distribute the tag secret keys to the toll booth and open road tolling applications as the keys are needed. Referring to FIG. 15, shown therein is a block diagram illustrating an example embodiment of a portion of a KMS system 400 for use in a fictional toll authority application. The fictional Dallas Toll authority manages all toll roads in and around the Dallas-Fort Worth Metroplex. The Dallas toll authority maintains a Dallas domain authority server 402 that manages the secret keys for all toll tags that are commissioned by and authorized for use within the Dallas toll authority's toll road network. The Dallas domain authority server 402 is registered with the Dallas root KMS server 404 that connects to a hierarchy of KMS servers 406, 408 and 410 that are controlled by the Dallas toll authority. At each tolling location, a local KMS server 412 interfaces with a security application 414 at the tolling location that manages the tag authentication and other security functionality. The security application interacts with the financial and legal applications operating at that tolling location to allow for billing and notification of unauthorized vehicles using the toll road.

For simplicity, it is initially assumed that all KMS servers are physically and logically secured, even the local KMS servers and resolvers, and it is assumed that the tolling locations are physically secured. This allows the security applications to obtain, but not cache, the secret keys of the various tags. Thus, secret keys may be cached at each level of the KMS server hierarchy for this example.

The basic operation of the KMS system 400 is as follows. A tag 416 enters the field of the interrogator 410, powers up, and communicates its identity to the interrogator 410. If the identity of the tag 416 is sent in the clear, finding the secret key of the tag 416 is a simple database lookup. If the tag identity is secured, then a more complex operation that requires the secret key of the tag 416 is used to determine the identity of the tag 416. The Hummingbird cipher has a secure identification protocol that enables an efficient anonymous secure identity that can be used with the KMS system 400. For simplicity, it is assumed that the tag 416 communicates its identity in the clear.

The local security application 414, upon receiving the identity of the tag 416, will issue a request to the local KMS server 412 (i.e. a KMS resolver) seeking the secret key for the identified tag 416. If the local KMS server 414 has the secret key for the identified tag 416 (e.g. because the vehicle had been through that tolling location recently), the local KMS server 412 returns the secret key to the security application 414. The security application 414 then proceeds with its desired security functionality.

When the local KMS server 412 does not have the secret key, it passes the request up the KMS system hierarchy to an intermediate level KMS server 406 or 408. It is likely that one of the KMS servers 406 or 408 operating above the local KMS server in the hierarchy also communicate with local KMS servers at tolling locations physically nearby to the requesting KMS server 412. Thus, it is likely that the secret key of the tag 416 will be cached at one or more of the intermediate KMS servers 406 and 408 that may service the request and return the secret key back through the local KMS server 412 to the security application 414.

In the event that the secret key of the tag 416 is not cached by any KMS server in the hierarchical path traversed by the request, the request will be sent to the Dallas Domain KMS authority server 402. This is expected to happen the first time the toll tag 416 is used along a particular route or when the toll tag 416 is used after the caches of the KMS servers 406 to 412 have been cleared of data for this particular toll tag 416 (due to a time-to-live timeout, for example).

The response time of the KMS system 400 depends in part upon the KMS server level at which the request is processed. Therefore, the worst case response time is likely to occur when the request is serviced by the Dallas domain KMS authority server 402.

The response time can be minimized by limiting the number of levels in the KMS system hierarchy between the local KMS server 412 and the Dallas domain KMS authority server 402. The response time may be further decreased by prepositioning the data within the various KMS servers 404 to 412 of the KMS system 400. By pushing data from the Dallas domain KMS authority server 402 to some, or all, of the other KMS servers in the KMS system 400, the keys will be pre-cached, and the performance improvement experienced from caching within a DNS system should be similarly achieved by the KMS system.

A longstanding desire for drivers, if not for the multitude of toll authorities arrayed across geographically connected areas, is to have a single toll tag commissioned within one toll authority's domain, such as the Dallas Toll authority, and to have that tag work within another toll authority's domain, such as the Austin Toll authority (and the San Antonio Toll authority domain and the Houston Toll authority domain and all of the other toll domains regularly traveled to by drivers based in Dallas). By maintaining a Texas statewide KMS system that operates as the parent KMS system to all of the local toll authorities (the child KMS systems), all of the toll authority domains may be easily linked through the Texas root KMS server layer to allow for a single toll tag commissioned in any of the toll authority domains to be used within all of the toll authority domains connected to the statewide KMS system.

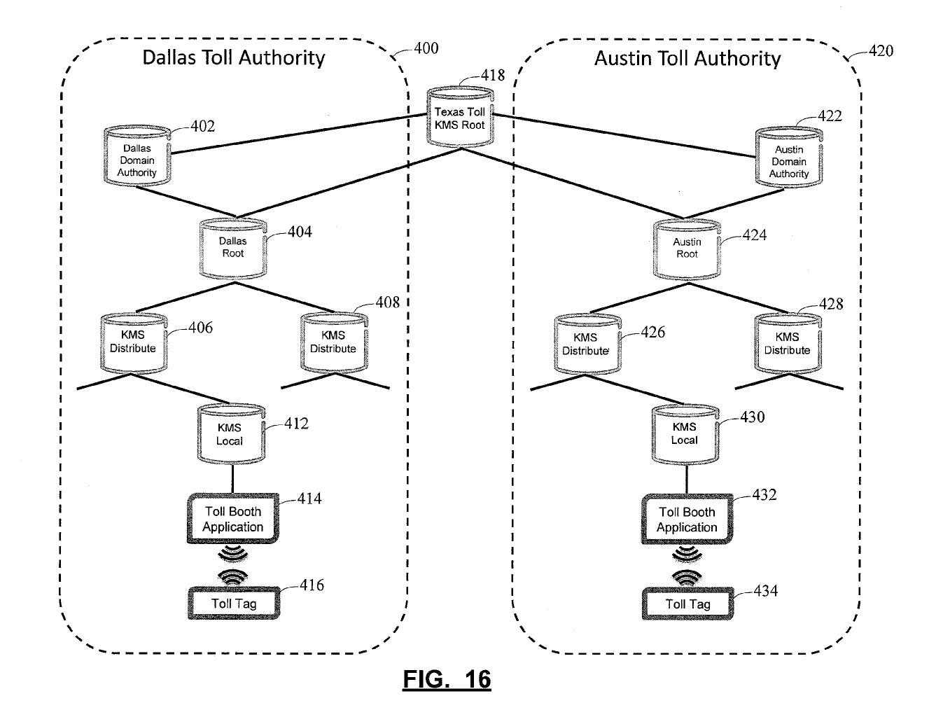

An example of a KMS system that can connect multiple toll authority domains 400 and 420 via a statewide KMS system with root KMS server 418 is illustrated in FIG. 16. In particular, FIG. 16 shows the Dallas Toll Authority domain 400 and the Austin Toll Authority domain 420 both connected to a Texas root KMS server 418. Both the Dallas root KMS server 404 and the Austin root KMS server 424 are connected directly to the Texas root KMS server 418. In this way, the Dallas and Austin domain root servers 404 and 424 act as second level KMS servers.

In addition to the domain root KMS servers 404 and 424, both the Dallas Domain Authority server 402 and the Austin Domain Authority server 422 are registered with the Texas root KMS server. In this way, all of the local Domain Authority servers 402 and 422 are reachable from the Texas root KMS server 418. Therefore, with a single point of agreement (the Texas Authority) all of the toll authority domains may support security services for their toll tags as their tags travel throughout the state of Texas.

Since most toll tags primarily stay within a single toll authority domain and only occasionally travel to other domains it is unlikely that all toll authorities will broadcast, or push, all of their toll tag keys to every other authority to enable pre-caching of keys. It is more likely to distribute a key only upon a request originating from another domain. Thus, as a vehicle with a Dallas Authority toll tag travels into Austin, which is a three hour drive south of Dallas, the Austin KMS system 420 is unlikely to have the Dallas toll tag key cached within it. Thus, for that first toll tag-interrogator conversation, the request made of the Austin KMS system 420 will be communicated through the Austin KMS system 420 starting with the Toll Booth application 432 making the request to the local KMS server 430 which passes the request to the KMS distribute server 426 which passes the request to the Austin root KMS server 424 which passes the request to the Texas Toll KMS root server 418 which passes the request to the Dallas Domain Authority server 402 where it will be answered.

In this case, each Austin KMS server 424, 426 and 430 searches its local cache of keys, and upon not finding a match, passes the request to a KMS server closer to the Dallas domain authority KMS server 402. Once the required information is located in the Dallas domain authority KMS server 402, it will propagate from the Dallas domain authority KMS server 402 to the Texas toll KMS root server 418 to the Austin root KMS server 424 to the KMS distribute server 426 to the KMS local server 430 to the secure toll booth application 432. Caching of the information may be done at the Texas Toll KMS root server 418, the Austin KMS Root server 424, the KMS distribute server 426, and the KMS local server 430.

Accordingly, as can be seen in this example, security requests flow up a KMS system from an application towards the authority servers. Security requests may be cached and logged by the KMS servers that process them. The logs may be sent back to the appropriate domain authorities. A request never flows away from a root KMS server downstream in a KMS system, but always upstream towards a root KMS server, or at least sideways (i.e. within a KMS distribute server sub-layer). This is why an authority KMS server is connected to a root KMS server in order for the authority KMS server to receive the security requests. The data from the KMS authority server is typically sent back through the path that the security request traversed on its way to the KMS authority server (or the KMS server that answered the security request). Accordingly, data flows away from a KMS root server and a KMS authority server downstream in a KMS system. Thus, in this example, the Austin domain authority 422 does not receive the cryptographic key and any other data sent from the Dallas domain authority 402 (or any other authority). However, the cryptographic key and data from the Dallas domain authority 402 can be cached by each of the Austin KMS servers that processed the security request (i.e. KMS servers 424, 426 and 430).

Based upon the performance characterizations of a typical network communications system, it is possible that a naive security policy and implementation will result in the request taking seconds to be answered. While a one to two second delay may be acceptable for gated toll booth installations, this is far more time than is available in open road tolling installations. Therefore, the open road tolling applications are designed assuming that keys will not always be available in time for all security services to be executed.

Additional concerns that exist with the distribution of symmetric keys beyond the domain within which they are created include the security of those keys and the liability of having those keys compromised within another domain (and having another domain's keys compromised within a local domain). To this end ephemeral, or temporary, keys can be used to limit both risk and liability. Similarly, cryptographic conversations using secure identifiers may be used to limit both risk and liability.

Passive RFID tags are capable of both generating and remembering ephemeral keys. Thus, the Dallas Toll authority 400 may configure all of its toll tags to generate a new ephemeral key after every 100 successful interrogations. Alternatively, the Dallas Toll authority server 402 may explicitly command a toll tag to generate a new ephemeral key or to use a given ephemeral key. By using ephemeral keys, the consequences of compromising those ephemeral keys are limited.

When higher levels of security are desired by an authority, such as mitigation of tracking and tracing attacks, ephemeral keys can play an even greater security role. In this example it is assumed that the toll tag returns its identity in the clear allowing for the tag to be tracked and traced. Secured identifiers are required to allow for the secure identification and the secure tracking and tracing of a toll tag while thwarting illicit track and trace attacks.

Ciphers such as Hummingbird are capable of generating secure identifiers that are dependent upon the secret ephemeral key only. Consequently, by using the right cipher and ephemeral keys, the identity of a toll tag need never be communicated through a KMS system. Thus, by using ephemeral keys for anonymous identification the compromise of a single KMS server does not compromise the identity of the toll tag nor does it give an attacker the opportunity to make requests regarding a specific identifier.

The caching of keys, the pushing of keys to be cached and a limited KMS server hierarchy enable short response times from the KMS system. Furthermore, the use of ephemeral keys, particularly with anonymous identification, will limit the risk and liability of using the KMS system. However, in order for this to happen, the policies governing the lifecycle and use of the keys must be compatible with the desired security level for the applications and the caching capabilities and other services that are provided within the KMS system.

If the domain authority policy does not trust the KMS system, then instead of communicating keys (ephemeral or otherwise) to the KMS system, the Domain Authority server can communicate a cryptographic conversation, or portion thereof, that utilizes the appropriate key. A cryptographic conversation is the sequence of messages that are communicated to a toll tag and received from a toll tag in response. For example, under certain authentication protocols it is possible to issue a challenge to a tag and know what the response from the tag will be if the tag is not counterfeit and uses the correct key. By sending both the challenge message and the valid response message to an interrogator, as described previously in the various methods, the KMS system supports a basic authentication service.

The complication arises because of the use of initialization vectors (IVs), or nonces, during the cryptographic conversations to prevent replay attacks. Since nonces should be used only once (nonce is short for “number used once”), caching a cryptographic conversation based upon a nonce does not improve the system performance. A cryptographic conversation based on a nonce should never be repeated. In this case, it may be possible to use a structured nonce, such as a simple counter or an LFSR (Linear Feedback Shift Register) or a PRNG (Pseudo-Random Number Generator), to generate the nonce. Since the nonce sequence is known by the Domain Authority, it would be possible for the Domain Authority to generate multiple conversations based on the nonce sequence and to communicate these conversations to the KMS system through a push or in response to a pull or normal request. This prepositions future conversations within the KMS servers to allow for improved system performance with a reduced load on the Domain Authority server.

In some security policies, the ephemeral key is changed after every use and utilizes a random nonce generated by the device. We'll assume that the Domain Authority KMS server does not trust the KMS system; therefore, all authentications of that domain's device's identities involve the Domain Authority KMS server. For these policies, the KMS system provides several benefits with its use including needing a relationship only with the KMS system (such as the Texas KMS system in the above example) and not with each other domain individually.

Accordingly, provided herein are descriptions of at least one embodiment of a KMS system, which is a hierarchical, distributed system for the management of cryptographic keys. The functionality of various embodiments of the KMS system includes at least one of the discovery and distribution of cryptographic keys, distribution of revocation lists, distribution access control lists for data and keys, data integrity, data origin authentication, negative response generation (e.g., invalid cipher text) integrity and origin authentication, request origin authentication, request integrity, authentication (validation) of one or more devices through each device's secret key, secure authentication without revealing secrets (e.g., secret keys), the secure assignment of temporary shared secrets (e.g., session shared secret keys), timely revocation of keys and authentications, and anonymous secure communications.

At least some embodiments of the KMS system described herein make it possible for devices to communicate securely without any device revealing to other devices either its secret key or its identity, and without the need for certificates. As such, the KMS system may be used with either symmetric or asymmetric ciphers.

According to at least some embodiments, a KMS system is maintained as a distributed hierarchical database system where each KMS server is a node in the system. The network accessible servers and services may be owned and provided by any of a plurality of enterprises/organizations and may be hosted on any of a variety of systems.

The KMS servers may be logically arranged in a hierarchical fashion, with root KMS servers being at the foundational level of the hierarchy. The KMS services may be provided by a plurality of distributed KMS root servers that are managed by one or more entities. Multiple logical KMS root servers, or sets of distributed KMS servers logically providing a single root services, may exist.

In at least some embodiments, a single public KMS system is provided which is rooted by a single set of KMS root servers. At least some alternative embodiments extend a public KMS system with any number of private KMS systems that each has their own unique set of KMS root servers, by connecting at least one of the private KMS systems to at least one public KMS system.

The KMS server hierarchy is logically a tree topology in some embodiments; however, any multi-level topography configuration is generally workable for the system. A leveled graph with multiple connections from one node to the nodes in the level above it and multiple connections to the nodes in the level below it in the hierarchy may exist in some embodiments to provide a more robust communication network.

According to at least some embodiments, the KMS root servers are, by definition, at a security level 0, and by convention are referred to as being at the top level with all other KMS servers being at lower security levels (i.e., with larger security level values) except the authority KMS servers which are at a higher security level to the root KMS servers (i.e., with a security level value less than 0). A KMS server's security level is an indication of the trust that is imparted to that KMS server. Therefore, a KMS server at a specific security level may not have a lower level of security than those servers lower than it in the hierarchy (i.e., with larger security level values).

In some embodiments, the KMS system may be implemented based upon the Domain Name System (DNS). In some embodiments, the KMS system may be implemented based upon the Secure Domain Name System (DNSSEC). For example, a set of root KMS servers would exist as the top-level domain resolvers. A basic use of this rooted hierarchy would be to allow each query that needs the authoritative server to provide an answer to go from the device making the query through the hierarchy of KMS servers, through a root server, and to the correct authoritative server. Security levels within this KMS hierarchy will be enforced such that a KMS server cannot have a higher authorized security level than any KMS server above it in the hierarchy.

In some embodiments of the KMS system, authoritative servers are used that manage and maintain cryptographic keys for a specific domain. An authoritative server is a KMS server that gives answers that have been configured by an original source, such as the KMS server's system administrator. KMS authoritative servers may communicate directly with one or more KMS root servers. KMS authoritative servers can communicate with KMS top level domain servers and with KMS root servers.

In some embodiments, a KMS system maintains multiple domains, with at least one KMS authority server within each domain. A KMS authority server may connect to one or more KMS Top Level Domain Authority servers for its domain or it may connect to one or more KMS root servers or it may connect to one or more KMS Top Level Domain Authority servers for its domain and one or more root KMS servers. A KMS Top Level Domain authority server may connect to one or more root KMS servers. The one or more KMS root servers connected to KMS top level domain servers or KMS authority servers may exist in different scopes (i.e., the KMS root servers may be in different KMS systems). For example, a KMS system within Facility A may have its KMS Top Level Domain authority server connected to the KMS root server of the KMS system in Facility A and to the KMS root server of the KMS system in Facility B. The result is that the KMS authority server in Facility A may provide services to devices and applications that are within Facility B.

In some embodiments, a KMS system may be nested within one or more other KMS systems, with at least one KMS authority server and at least one KMS root server within each KMS system. For example, the KMS root server of a parent KMS system can be connected to the KMS root server of one or more child KMS systems where the security level of the parent KMS root server is higher than the security level of the children KMS root servers. The children KMS systems are fully encapsulated within the scope of the parent KMS system. FIG. 16 provides an example of this encapsulation. In an alternative embodiment, the root server of a child KMS system can be connected to one or more KMS intermediate servers of the parent KMS system. FIG. 2a and FIG. 2b provide examples of this encapsulation.

By encapsulating KMS systems, the children KMS systems gain access to the services provided by the Authority KMS servers connected to the parent KMS system's KMS root servers. Note that neither the parent KMS system nor any of its other children KMS systems gain access to the services provided by the KMS authority servers contained within its children KMS systems unless those KMS Authority servers connect to the parent's KMS root server.

In at least some embodiments, key management services are provided by the KMS servers. An application or device may issue a query to its local KMS server requesting one of several services, such as validation, authentication, or requesting a shared key. The query may contain a domain within which to search for the key for the particular device to be validated.

In some cases, the KMS servers will pass the query up the hierarchy and to the KMS authority servers. The KMS authority servers may then respond to the query.

In the case of multiple nested KMS systems, a query can be passed up to a root KMS server in a child KMS system, and if the required information is not found at the child's KMS root server and the KMS domain authority server that is needed to answer the query is not connected to the child's KMS root server, the query can be passed to a KMS root server of a parent domain as illustrated in FIG. 16 or to a KMS intermediate server of a parent domain connected to the child's KMS root server as illustrated in FIG. 2a and FIG. 2b. If the required information is not found at the parent's KMS root server or its KMS intermediate servers that may be passed the query, then the KMS root server of the parent domain can pass the request to the KMS authority server for the domain that is being queried. If the correct domain for the query is unknown or possible answers may exist in multiple KMS domain authority servers, then each KMS root server that receives the query may pass the query to each of the KMS authority servers connected to it in an effort to find a domain appropriate for the query.

In theory, KMS authority servers are sufficient for the operation of the KMS system. However, such a system would place a tremendous computational burden on the KMS authority servers and require continuous networked operation, which may be undesirable in some operating conditions. Therefore, in order to provide at least one of improved operational efficiency, reduced computational load on the authoritative servers, reduced KMS network traffic, increased performance in end-user applications, and to enable non-networked KMS operation of occasionally or intermittently connected systems, caching at the KMS servers may be used. For example, a KMS server may cache KMS queries, query results and cipher keys for a period of time, and may respond to a query if the result is stored in its local cache or calculate the result based upon a stored key in its cache. KMS servers may also cache additional information, such as IP addresses, that may improve the performance of the system.

Each KMS server may be authorized to store data and information associated with a specified set of security levels for each domain. This means that the KMS server may be authorized to receive and cache keys and answers from that domain provided that the keys are of the authorized security level and below. For example, a KMS system may be operable such that a key authorized to be stored at a KMS server of level 2 may be stored at KMS servers at level 0 (i.e., the root servers), level 1 KMS servers and level 2 KMS servers only.

A KMS server may implement the full functionality of an authoritative KMS server for those keys and answers stored within it. Answers to queries are cached and the KMS server will return the cached answer or a derived answer based upon a cached key, and possibly an indication that the answer was cached (i.e., an indication is provided that the answer did not come from the authoritative server).

In some embodiments, KMS servers implement a KMS domain resolver to resolve key domain names. One possible implementation is to simply implement or use DNS and have the domain names be the machine names of the authoritative KMS servers. The KMS servers would then have direct access to each of the authoritative servers, in effect creating a two-level hierarchy.

In order to create a more robust, secure, and efficient hierarchy, the domain resolver may be implemented within (and as part of) the basic functionality of the KMS servers.

However, there are also other factors that contribute to the robustness of the KMS system. These factors include the ability to have redundant systems that perform the same logical functionality. For example, the root KMS server may be implemented as multiple servers that are highly synchronized, and physically distributed (i.e. distributed in different physical locations) on a network such as the Internet. Robustness also exists from the multiple paths possible to access one or more of the root KMS servers. While logically some of the figures provided herein show a tree structure, in practice servers will be arranged logically in “layers” according to their security level and the servers from one layer will be highly connected to the servers in the layer above and the layer below it. Additional connections may exist within a layer and between servers that are not in adjacent layers. Thus, if one server within a layer is attacked or taken down, connectivity to the layer is maintained by these redundant links between layers, e.g. some embodiments of the KMS system can be implemented such that each server in layer i have communication links with at least 2 servers in layer I−1 and at least 2 servers in layer i+1. This layered approach can be enforced through the application of various security levels to the KMS servers.

Another redundancy occurs when data is cached within the KMS servers. A “time to live” is associated with the data cached in the KMS servers, meaning data may have anywhere from zero time left for existence to infinite time meaning the data remains valid forever. Despite this “time to live”, valid data may still be served up to requests even if some KMS servers or even the KMS authority server is under attack or off-line or otherwise unreachable. In some cases it may even be possible to use invalid data (i.e. data whose time to live has expired) in a response, but that should be stated in the response given from a KMS server.

As mentioned, the Hummingbird cryptographic protocol can be used with the KMS system. The Hummingbird cryptographic protocol has some unique properties in its use, for example the Secure Identifier (which may be the concatenation of four values: IV, CT0, CT1, and CT2) where the CT (or Cipher Text) values depend upon only the IV and the secret key. This anonymous secure identifier provides a level of security that is not possible with traditional approaches that encrypt some or all of a device's identifier (or simply sends the identifier in the clear which is done by public key ciphers and is commonly practiced in protocols using symmetric ciphers).

If a KMS server is compromised, the identities and keys associated with that server are also compromised. However, with the use of Hummingbird and anonymous secure identifiers, a compromise yields the anonymous secure identifiers and possibly the key. No identity information is required to be present. Thus, if keys are updated (e.g. rolled) in accordance with good practice, the identity remains unknown. Furthermore, if only the secure communication is sent (e.g. the anonymous secure identifier) then going through a compromised KMS server yields no information on the identity of the devices that communicate with the KMS server and, because the IV should change over time, the next time the IV changes, the compromised KMS server will not know if the new secure identifier belongs to a secure identifier that was previously handled or is a new device with new key making requests.

While various example embodiments were described herein that use the Hummingbird cryptographic protocol, other types of ciphers can be used with a KMS system. For instance it is also possible to use with a KMS system asymmetric ciphers, other hybrid ciphers (of which Hummingbird is one example), block ciphers, stream ciphers, or any other type of cipher that uses either symmetric or asymmetric keys. For example, the KMS system can be used with the Advanced Encryption Standard (AES), Elliptic Curve Cryptography (ECC) and RSA encryption algorithms. In general, any symmetric or asymmetric cipher and any public or private key cryptographic technique can be used with a KMS system.

Another feature of the anonymous secure identification approach is that it allows for a public key cipher to use an anonymous secure identifier instead of an “in the clear identifier” for the certificates and digital signatures. This allows for a hybrid approach of asymmetric and symmetric ciphers in an on-line environment. In this case, there are two keys and two algorithms that are used to protect an identity. The symmetric key is used in the KMS system to resolve and authenticate a certificate based upon a secure identifier. The symmetric key may be unique to the tag or a group key. The asymmetric keys are then used to authenticate the certificate. The KMS system can be used to check for certificate revocations efficiently. The certificate values change every time because the secure identifier changes with the IV thereby preventing track and trace of the certificates.

The Hummingbird encryption protocol has a fast key lookup facility which can be used to perform an efficient brute force search of a known set of keys. Symmetric keys may change over time or be one of a large number of group keys. Symmetric keys will propagate into the KMS servers (in the root and intermediate layers) where they will be cached. The number of cached keys potentially may be in the realm of millions. The Hummingbird FastKey algorithm searches these keys fast to identify the key to use for authentication. Other ciphers, such as AES, are very slow in their brute force searches, so using a secure identifier when there are thousands of keys may be impractical for ciphers such as AES. However, the Hummingbird encryption protocol enables efficient KMS operation and services when the number of keys to be distributed throughout a security layer is very large.

The KMS system can also be designed to allow for the prepositioning of keys and secure conversations within the KMS system. This can be done through a PUSH operation of keys or conversations from a KMS authority server or at least one PULL operation from a specific KMS server. In the PUSH operation, an authority KMS server sends a key or a conversation (or the plural of these) into the KMS system. The key (as an example) may propagate to all of the KMS servers of a specific level, or it may be possible to send it along a designated path. The path may be difficult to ascertain in practice, but if the end KMS server is known, that KMS server can initiate a request (thereby performing a PULL operation). A PULL operation is unique in that a KMS server, not an end device or end application using the KMS system, initiates the request. Of course an application may initiate a set of requests that mimic the results of a PULL operation, but that is a set of normal requests coming from an entity using the KMS system, not from within the KMS system itself. The PULL operation originates from within the KMS system itself.

In secure conversations, secure identifiers are one message in a longer secure conversation. When the Ns in the secure identifiers are based upon time (or any counter that steps in a predictable pattern such as adding one or an LFSR), the conversations may be pre-generated by a KMS authority server and PUSHed (or PULLed or simply requested if allowed by the security policy) into the KMS system. The PULL operation is advantageous since a security policy should not allow applications to make requests with Ns that are too far beyond the range of what is expected. For example, an IV that is the wall clock time may have an associated use policy that states that the IV should always be within 10 minutes of the wall clock time in GMT or else some action is taken such as to ignore the request. More generally, the policy should limit the range of acceptable Ns to some number of Ns in the sequence beyond (or potentially before) where the sequence is expected by a KMS authority server to be. Thus, in continuing with this example, all requests from applications with the IV more than 10 minutes away from the current GMT time should be treated as violating policy and should be ignored. And, all requests with an IV smaller than the last valid IV used should have a policy treating them as well. A PUSH or PULL operation allows for the KMS system to preposition secure identifiers and their associated conversations that are beyond the 10 minutes policy interval.

It should be understood by those skilled in the art that audit loops can be used with the various embodiments of the KMS system described herein.

Another advantage of, and service that may be provided by the KMS system, is that each KMS domain authority server may perform a certificate or digital signature validation for a device, application, or other entity from a different domain a priori and send its own certificate or digital signature for that external entity when requested. As an example of how this would function consider a Web Server that has a public key associated with it. Applications within security domain A may wish to securely access the Web Server that is in security domain B. The application will receive from the Web Server its public key and certificate. The application will then send a query into the KMS system to authenticate the validity and non-revocation of the certificate and public key. The KMS system will normally utilize the domain B authority server for this query. However, since the application is in domain A it may not trust the domain B authority. Instead, the application wishes to utilize a trusted domain authority.

Since the application is in domain A, it can be assumed that it trusts its domain A KMS authority server. Therefore, the application will utilize the KMS system to make a request of the domain A KMS authority server to authenticate the validity and non-revocation of the certificate and public key. The domain A KMS authority server may answer the query with its own certificate for the Web Server. It should be noted that the certificate binds an identity to a public key, so the certificate from the domain A KMS authority server validates the public key (which should be the same public key sent by the Web Server itself) and the Web Server identity.

By utilizing its trusted domain KMS authority server for all public key certificates, the application allows the domain A KMS authority server to manage its security policies in real time. The authority may validate a public key and certificate simply by, for example, verifying that the chain is authentic as is done for certificates today. The authority may also perform its own independent authentication process that goes beyond simply validating a certificate. The extent of the process is determined by the domain's security policy.

The use of certificates and digital signatures generated by a trusted domain authority KMS server by any application, software, or device eliminates the burden of each application, software, or device to independently verify certificates from entities it does not or should not trust. This minimizes the functional requirements of these systems and devices allowing for very low resource devices to operate with a level of security normally obtained only from high resource devices. Since the domain KMS authority server may perform its authentication a priori, i.e., before a request is made of it, it may have in depth processes for highly secured transactions and less stringent processes for lower security transactions. This also allows for a tiered security approach based on the process used for authentication with certificates generated from in-depth processes having a high level of security (or trust) associated with them and certificates generated from simple processes such as verifying a certificate chain having a low level of security (or trust) associated with them.

It should be noted that a domain is a security domain wherein there exists at least one domain authority (or simply an authority). In the general sense, and often in practice, a domain may have multiple authorities operating within it, and, at least for the logical orientation of a KMS system (such as in FIG. 1), a KMS Top Level Domain Authority server will be connected to each KMS authority server within a domain. The KMS Top Level Domain Authority server for each domain will also be connected to the KMS Root server in the KMS system 10.

The KMS system can address the problem of providing security services to mobile devices that operate outside of their home network. Thus, KMS authority servers are in a domain, while the KMS root and distribution servers may exist outside of that domain and may exist only in the “global” domain (i.e. the ultimate top level domain). A KMS system operates within a certain “scope”. The public global KMS system has a global scope that allows anyone or any device to connect to it anywhere in the world and have services provided by the KMS system (specifically by the KMS authority servers connected to the KMS root server or on their behalf by the root KMS servers or any intermediate or local KMS server). The KMS system for company A has a scope that encompasses company A. Only applications, devices, and people within company A, and more specifically operating within the physical confines of company A property or logically operating on company A's network, can access the KMS system of company A.

As a further example, there can be 3 domains in Company A: one for Research, one for Engineering and one for Marketing and Operations. Each domain will have its own KMS authority server. There will also be a KMS Root server (or servers). Each of the three KMS authority servers for Company A will be connected to the KMS root server for Company A (note a Top Level Domain server is not used in this example but could have been used). There will be KMS distribute servers and KMS local servers for Company A's KMS system. The Local KMS servers know only about the KMS distribute servers and the KMS root server in Company A. Thus, if a device asks a KMS local server for Company A to provide a service using a key from outside of Company A (let's say Company B), the KMS local server can ask only the KMS distribute and Root servers for Company A for this service. At this time none of the KMS servers for Company A can access the KMS servers for Company B because they know nothing about them and there is no general discovery service for them. However, the KMS system for Company A may access the Domain Authority servers for Company B if and only if the KMS authority servers for Company B are registered with the KMS root server of Company A or the KMS root server for Company A is connected to a KMS system with a larger scope (i.e. the KMS system for Company A is nested within the KMS system of Company B) and that allows access to the KMS authority servers of Company B.

It should be noted that the steps of the methods described herein are only for illustrative purposes. In some cases, it may be possible to add, remove, modify or rearrange the order in which the steps are performed without departing from the functionality and structure of the KMS system and its components described herein.

Furthermore, various particular example embodiments of the KMS system and its components are described herein, it should be understood that modifications, adaptations, and other implementations are possible without departing form the spirit and scope of the KMS system and its functionality and structures described herein.

1. A system for the provision of cryptographic key management services (KMS), wherein the system comprises:
a KMS domain authority server layer including at least one KMS authority server configured to manage cryptographic keys for a first domain; and
a root KMS server layer including at least one KMS root server, the root KMS server layer being linked to the authority KMS server layer, the at least one KMS root server being configured to communicate with applications and devices that make security requests to the system when there are no other layers in the system,
wherein, the layers are organized in a hierarchy such that each layer has a different security level.

2. The system of claim 1, wherein the system further comprises an intermediate KMS server layer including at least one KMS distribute server, the intermediate KMS server layer being linked to the root KMS server layer and wherein servers in at least one of the root KMS server layer and the intermediate KMS server layer are configured to communicate with applications and devices that make security requests to the system when there are no other layers in the system.

3. The system of claim 2, wherein the system further comprises a resolver KMS server layer including at least one KMS local server, the resolver KMS server layer being linked to the intermediate KMS server layer and wherein servers in at least one of the root KMS server layer, the intermediate KMS server layer and the resolver KMS server layer are configured to communicate with applications and devices that make security requests to the system.

4. The system of claim 1, wherein the system further comprises a resolver KMS server layer including at least one KMS local server, the resolver KMS server layer being linked to the root KMS server layer and wherein servers in at least one of the root KMS server layer and the resolver KMS server layer are configured to communicate with applications and devices that make security requests to the system.

5. The system of claim 3, wherein the at least one KMS authority server is connected to the at least one KMS root server.

6. The system of claim 3, wherein the KMS domain authority server layer further comprises a KMS top level domain server connected to the at least one KMS authority server and the at least one KMS root server.

7. The system of claim 2, wherein the intermediate KMS server layer comprises at least two sub-layers having different security levels.

8. The system of claim 3, wherein the at least one KMS authority server contains all of the cryptographic keys required for authenticating devices and applications that are associated with the first domain, the at least one KMS root server contains a subset of the cryptographic keys contained by the at least one KMS authority server and the at least one KMS distribute server contains a subset of the cryptographic keys contained by the at least one KMS root server.

9. The system of claim 3, wherein each layer is assigned a different security level and wherein the KMS domain authority server layer is assigned a higher security level than the root KMS server layer, the root KMS server layer is assigned a higher security level than the intermediate KMS server layer, and the intermediate KMS server layer is assigned a higher security level than the resolver KMS server layer.

10. The system of claim 3, wherein the layers are configured to propagate each security request from the device or application to servers in successively higher layers until a server is located with the required information to facilitate the security request.

11. The system of claim 10, wherein at least one server in the root KMS server layer, the intermediate KMS server layer and the resolver KMS server layer is configured to cache information including at least one of queries, query results, cryptographic keys and cryptographic conversations based on a specified set of security levels for each domain.

12. The system of claim 11, wherein the at least one server in the root KMS server layer, the intermediate KMS server layer and the resolver KMS server layer is configured to respond to the security request if the at least one server contains a cached query result that corresponds to the security request or if the at least one server contains cryptographic information that corresponds to the security request and is configured to calculate a result based on the stored cryptographic information.

13. The system of claim 3, wherein at least one server in at least one of the root KMS server layer, the intermediate KMS server layer and the resolver KMS server layer comprises a key store and is configured to perform computations required for a cryptographic conversation with the device or application.

14. The system of claim 3, wherein the at least one KMS local server is configured to resolve domain names associated with the at least one KMS authority server to obtain direct access to the at least one KMS authority server thereby creating a two-level hierarchy within the system.

15. The system of claim 3, wherein at least one server at a given layer is configured to implement a PUSH operation to send cryptographic information comprising at least one cryptographic key or at least one cryptographic conversation to at least one server in a lower layer in the system provided the at least one server at the lower layer has an appropriate security level to receive the cryptographic information.

16. The system of claim 3, wherein at least one server at a given layer beneath the KMS domain authority server layer is configured to implement a PULL operation to receive cryptographic information comprising at least one cryptographic key or at least one cryptographic conversation from at least one server in a higher layer in the system provided the at least one server at the given layer has an appropriate security level to receive the cryptographic information.

17. The system of claim 1, wherein the root KMS server layer comprises a set of KMS root servers.

18. The system of claim 1, wherein the system is used to provide cryptographic services for multiple domains and wherein at least one KMS authority server is associated with each domain.

19. The system of claim 3, wherein the first domain is a parent domain and the system comprises a subsystem associated with a child domain wherein the subsystem comprises a second KMS domain authority server layer, a second root KMS server layer, a second intermediate KMS server layer; and a second resolver KMS server layer and wherein a KMS root server of the second root KMS server layer is connected to a KMS distribute server of the intermediate KMS server layer associated with the parent domain, whereby the child domain is nestled within the parent domain.

20. The system of claim 19, wherein if any of the servers in the child domain cannot service the security request, the KMS root server in the child domain is configured to propagate the security request to KMS servers associated with the parent domain having a security level equal to or higher than the security level of the intermediate KMS server layer associated with the parent domain.

21. The system of claim 1, wherein the at least one KMS root server is connected to a KMS root server associated with a parent domain and if any of the servers in the first domain cannot service the security request, the at least one KMS root server in the first domain is configured to propagate the security request to the KMS root server associated with the parent domain and if the KMS root server associated with the parent domain cannot service the security request, the KMS root server associated with the parent domain is configured to propagate the request to a KMS root server associated with another domain.

22. The system of claim 1, wherein the servers in the system are configured to use one of a Hummingbird symmetric cipher, an Advanced Encryption Standard cipher, an Elliptic Curve Cryptographic cipher and an RSA encryption cipher.

23. The system of claim 1, wherein the servers in the system are configured to use any one of a symmetric cipher or an asymmetric cipher and a public cryptographic technique or a private cryptographic technique.

24. The system of claim 1, wherein the at least one KMS authority server comprises distribution access control lists that specify cryptographic information that can be shared with certain servers associated with other layers in the system or certain servers, devices or applications associated with other domains.

25. The system of claim 24, wherein when the distribution control lists comprise a distribution white list, all entities requesting data from the at least one authority server must be authenticated and on the distribution white list in order to receive the data.

26. The system of claim 24, wherein when the distribution control lists comprise a distribution black list, all entities requesting data from the at least one authority server must be authenticated and not on the distribution black list in order to receive the data.

27. The system of claim 3, wherein the at least one KMS local server is configured to provide resolve services using at least one of a Domain Name System (DNS) and a Secure Domain Name System (DNSSEC).

28. The system of claim 1, wherein portions of cryptographic conversations are transmitted between the layers of the system to anonymously authenticate the device that makes the security request.

29. A system for the provision of cryptographic key management services (KMS), wherein the system comprises:
a KMS domain authority server layer including at least one KMS authority server configured to manage cryptographic keys for a domain;
a root KMS server layer including at least one KMS root server, the root KMS server layer being linked to the authority KMS server layer;
an intermediate KMS server layer including at least one KMS distribute server, the intermediate KMS server layer being linked to the root KMS server layer; and
a resolver KMS server layer including at least one KMS local server, the resolver KMS server layer being linked to the intermediate KMS server layer,
wherein servers in at least one of the root KMS server layer, the intermediate KMS server layer and the resolver KMS server layer are configured to communicate with applications and devices that make security requests to the system, and
wherein at least one server in at least one of the root KMS server layer, the intermediate KMS server layer and the resolver KMS server layer comprises a key store and is configured to perform computations required for a cryptographic conversation with the device or application to service the security request.

30. A system for the provision of cryptographic key management services (KMS), wherein the system comprises:
a KMS domain authority server layer including at least one KMS authority server configured to manage cryptographic keys for a first domain;
a root KMS server layer including at least one KMS root server, the root KMS server layer being linked to the authority KMS server layer;
an intermediate KMS server layer including at least one KMS distribute server, the intermediate KMS server layer being linked to the root KMS server layer; and
a resolver KMS server layer including at least one KMS local server, the resolver KMS server layer being linked to the intermediate KMS server layer,
wherein servers in at least one of the root KMS server layer, the intermediate KMS server layer and the resolver KMS server layer are configured to communicate with applications and devices that make security requests to the system, and
wherein the at least one KMS root server is configured to propagate the security request to a KMS root server or a KMS distribute server associated with a different system of another domain thereby allowing the system to authenticate and securely communicate with devices or applications associated with different domains.

31. A system for the provision of cryptographic key management services (KMS), wherein the system comprises:
a KMS domain authority server layer including a plurality of KMS authority servers, each KMS domain authority server being configured to manage cryptographic keys for different domains;
a root KMS server layer including at least one KMS root server, the root KMS server layer being linked to the authority KMS server layer;
an intermediate KMS server layer including at least one KMS distribute server, the intermediate KMS server layer being linked to the root KMS server layer; and
a resolver KMS server layer including at least one KMS local server, the resolver KMS server layer being linked to the intermediate KMS server layer,
wherein servers in at least one of the root KMS server layer, the intermediate KMS server layer and the resolver KMS server layer are configured to communicate with applications and devices that make security requests to the system, and
wherein the security requests are propagated to the KMS domain authority server of the domain associated with the device or application in order to provide authentication and distribution of at least one of cryptographic keys and cryptographic conversations between two or more of the different domains.

32. A method for the provision of cryptographic key management services (KMS) in a system, wherein the method comprises:
associating at least one KMS authority server with a KMS domain authority server layer having a first security level;
configuring the at least one KMS authority server to manage cryptographic keys for a first domain;
associating at least one KMS root server with a root KMS server layer having a second security level;
linking the root KMS server layer to the authority KMS server layer; and
configuring the at least one KMS root server to communicate with applications and devices that make security requests to the system when there are no other layers in the system.

33. The method of claim 32, wherein the method further comprises:
associating at least one KMS distribute server with an intermediate KMS server layer;
linking the intermediate KMS server layer to the root KMS server layer; and
configuring the servers in at least one of the root KMS server layer and the intermediate KMS server layer to communicate with applications and devices that make security requests to the system when there are no other layers in the system.

34. The method of claim 33, wherein the method further comprises:
associating at least one KMS local server with a resolver KMS server layer;
linking the resolver KMS server layer to the intermediate KMS server layer; and
configuring the servers in at least one of the root KMS server layer, the intermediate KMS server layer and the resolver KMS server layer to communicate with applications and devices that make security requests to the system.

35. The method of claim 32, wherein the method further comprises:
associating at least one KMS local server with a resolver KMS server layer;
linking the resolver KMS server layer to the root KMS server layer; and
configuring the servers in at least one of the root KMS server layer and the resolver KMS server layer to communicate with applications and devices that make security requests to the system.

36. The method of claim 34, wherein the method further comprises linking the at least one KMS authority server with the at least one KMS root server.

37. The method of claim 34, wherein the method further comprises associating a KMS top level domain server with the KMS domain authority server layer and linking the KMS top level domain server to the at least one KMS authority server and the at least one KMS root server.

38. The method of claim 33, wherein the method further comprises defining at least two sub-layers having different security levels in the intermediate KMS server layer.

39. The method of claim 34, wherein the method comprises:
providing the at least one KMS authority server with all of the cryptographic keys required for authenticating devices and applications that are associated with the first domain;
providing the at least one KMS root server with a subset of the cryptographic keys contained by the at least one KMS authority server; and
providing the at least one KMS distribute server with a subset of the cryptographic keys contained by the at least one KMS root server.

40. The method of claim 34, wherein the method further comprises assigning each layer a different security level and wherein the method comprises assigning the KMS domain authority server layer a higher security level than the root KMS server layer, assigning the root KMS server layer a higher security level than the intermediate KMS server layer, and assigning the intermediate KMS server layer a higher security level than the resolver KMS server layer.

41. The method of claim 34, wherein the method further comprises configuring the layers to propagate each security request from the device or application to servers in successively higher layers until a server is located with the required information to facilitate the security request.

42. The method of claim 41, wherein the method further comprises configuring at least one server in the root KMS server layer, the intermediate KMS server layer and the resolver KMS server layer to cache information including at least one of queries, query results, cryptographic keys and cryptographic conversations based on a specified set of security levels for each domain.

43. The method of claim 42, wherein the method further comprises configuring at least one server in the root KMS server layer, the intermediate KMS server layer and the resolver KMS server layer to respond to the security request if the at least one server contains a cached query result that corresponds to the security request or if the at least one server contains cryptographic information that corresponds to the security request and is configured to calculate a result based on the stored cryptographic information.

44. The method of claim 34, wherein the method further comprises providing a key store to at least one server in at least one of the root KMS server layer, the intermediate KMS server layer and the resolver KMS server layer and configuring the at least one server with the key store to perform computations required for a cryptographic conversation with the device or application.

45. The method of claim 34, wherein the method further comprises configuring at least one KMS local server to resolve domain names associated with the at least one KMS authority server to obtain direct access to the at least one KMS authority server thereby creating a two-level hierarchy within the system.

46. The method of claim 34, wherein the method further comprises configuring at least one server at a given layer to implement a PUSH operation to send cryptographic information comprising at least one cryptographic key or at least one cryptographic conversation to at least one server in a lower layer in the system provided the at least one server at the lower layer has an appropriate security level to receive the cryptographic information.

47. The method of claim 34, wherein the method further comprises configuring at least one server at a given layer beneath the KMS domain authority server layer to implement a PULL operation to receive cryptographic information comprising at least one cryptographic key or at least one cryptographic conversation from at least one server in a higher layer in the system provided the at least one server at the given layer has an appropriate security level to receive the cryptographic information.

48. The method of claim 32, wherein the method comprises associating a set of KMS root servers in the root KMS server layer.

49. The method of claim 32, wherein the system is used to provide cryptographic services for multiple domains and the method further comprises associating at least one KMS authority server with each domain.

50. The method of claim 34, wherein the first domain is a parent domain and the method further comprises associating a subsystem with a child domain, associating a second KMS domain authority server layer, a second root KMS server layer, a second intermediate KMS server layer and a second resolver KMS server layer with the subsystem, and connecting a KMS root server of the second root KMS server layer to a KMS distribute server of the intermediate KMS server layer associated with the parent domain, whereby the child domain is nestled within the parent domain.

51. The method of claim 50, wherein if any of the servers in the child domain cannot service the security request, the method further comprises configuring the KMS root server in the child domain to propagate the security request to KMS servers associated with the parent domain having a security level equal to or higher than the security level of the intermediate KMS server layer associated with the parent domain.

52. The method of claim 32, wherein the at least one KMS root server is connected to a KMS root server associated with a parent domain and if any of the servers in the first domain cannot service the security request, the method further comprises configuring the at least one KMS root server in the first domain to propagate the security request to the KMS root server associated with the parent domain and if the KMS root server associated with the parent domain cannot service the security request, the method further comprises configuring the KMS root server associated with the parent domain to propagate the request to a KMS root server associated with another domain.

53. The method of claim 32, wherein the method further comprises configuring the servers in the system to use one of a Hummingbird symmetric cipher, an Advanced Encryption Standard cipher, an Elliptic Curve Cryptographic cipher and an RSA encryption cipher.

54. The method of claim 32, wherein the method further comprises configuring the servers in the system to use any one of a symmetric cipher or an asymmetric cipher and a public cryptographic technique or a private cryptographic technique.

55. The method of claim 32, wherein the method further comprises providing the at least one KMS authority server with distribution access control lists that specifies cryptographic information that can be shared with certain servers associated with other layers in the system or certain servers, devices or applications associated with other domains.

56. The method of claim 55, wherein when the distribution control lists comprise a distribution white list, the method further comprises requiring all entities requesting data from the at least one authority server to be authenticated and to be on the distribution white list in order to receive the data.

57. The method of claim 55, wherein when the distribution control lists comprise a distribution black list, the method further comprises requiring all entities requesting data from the at least one authority server to be authenticated and to not be on the distribution black list in order to receive the data.

58. The method of claim 35, wherein the method further comprises configuring the at least one KMS local server to provide resolve services using at least one of a Domain Name System (DNS) and a Secure Domain Name System (DNSSEC).

59. The method of claim 32, wherein the method further comprises transmitting portions of cryptographic conversations between the layers of the system to anonymously authenticate the device that makes the security request.

60. A method of providing security services from a Key Management Services (KMS) system to a device requesting a service, wherein the method comprises:
sending a query from a server interface in the KMS system to the device;
obtaining an initialization vector (iv) and a device vector (dv) from the device at the server interface;
generating a Tag Authentication Request (TAR) packet at the server interface based on a unique session identifier (sid), a type code identifying a type of response expected, the iv, and the dv; and
sending the TAR packet from the interface server to a KMS server at a higher level in the KMS system to obtain the requested service.

61. The method of claim 60, wherein the method further comprises generating a secure session identifier (ssid) at the server interface and including the ssid in the query and the TAR packet.

62. The method of claim 60, wherein the method further comprises:
creating a session record at the KMS server in response to the TAR packet using the sid as a reference;
initiating a search of a key list at the KMS server using parameters in the TAR packet; and
sending an affirmative authentication (AA) packet from the KMS server to the server interface if the search was successful and a matching key was found, the AA packet having a type based on the type code.

63. The method of claim 62, wherein the method further comprises generating the AA packet at the KMS server by:
generating a random challenge vector;
generating a reader_rsp vector and a first tag_rsp vector as challenge response vectors using the matching key and a Hummingbird encryption algorithm initialized with the iv; and
including the sid, the challenge vector, the reader_rsp vector, and the first tag_rsp vector in the AA packet.

64. The method of claim 62, wherein upon receiving the AA packet sent from the KMS server to the server interface, the method further comprises:
canceling a retry timer at the server interface if the retry timer was set when the TAR packet was sent by the server interface; and
forwarding the challenge vector and reader_rsp vector from the server interface to the device.

65. The method of claim 64, wherein at the device the method further comprises:
generating a corresponding response vector using the challenge vector, the reader_rsp vector and a current encryption engine state at the device;
comparing the corresponding response vector with the reader_rsp vector; and
authenticating the server interface if the corresponding response vector and the reader_rsp vector match.

66. The method of claim 65, wherein the method further comprises:
generating a second tag_rsp vector based on the current state of the encryption engine at the device;
transmitting the second tag_rsp vector from the device to the server interface;
comparing the second tag_rsp vector from the device with the first tag_rsp vector received from the KMS server at the server interface; and
authenticating the device at the server interface if the first and second tag_rsp vectors match.

67. The method of claim 66, wherein method further comprises beginning a command phase when the first and second tag_rsp vectors match.

68. The method of claim 60, wherein the method further comprises transmitting the TAR packet using an IPsec transport mode AH.

69. The method of claim 62, wherein the method further comprises transmitting the AA packet from the KMS server using an IPsec transport mode ESP packet.

70. The method of claim 62, wherein the method further comprises using an IPsec AH digest at the KMS server to authenticate the TAR packet.

71. The method of claim 60, wherein the method further comprises employing a Hummingbird encryption protocol.

72. The method of claim 62, wherein the method further comprises generating the AA packet at the KMS server by:
generating a session key from a series of cipher text values using the iv, the dv and the matching key;
generating a random challenge vector;
generating a reader_rsp vector and a first tag_rsp vector as challenge response vectors using the matching key and a Hummingbird encryption algorithm initialized with the iv;
generating an encoded genSessionKey command using a Hummingbird decryption process; and
including the sid, the challenge response vector, the reader_rsp vector, the first tag_rsp vector, the session key and the encoded genSessionKey command in the AA packet.

73. The method of claim 72, wherein upon receiving the AA packet sent from the KMS server to the server interface, the method further comprises:
canceling a retry timer at the server interface if the retry timer was set when the TAR packet was sent by the server interface; and
forwarding the challenge vector and the reader_rsp vector from the server interface to the device.

74. The method of claim 72, wherein upon receiving the AA packet sent from the KMS server to the server interface, the method further comprising storing the session key at the server interface.

75. The method of claim 73, wherein at the device the method further comprises:
generating a corresponding response vector using the challenge vector, the reader_rsp vector and a current state of a first encryption engine at the device;
comparing the corresponding response vector with the reader_rsp vector; and
authenticating the server interface if the corresponding response vector and the reader_rsp vector match.

76. The method of claim 75, wherein the method further comprises:
generating a second tag_rsp vector based on the current state of the first encryption engine at the device;
transmitting the second tag_rsp vector from the device to the server interface;
comparing the second tag_rsp vector from the device with the first tag_rsp vector received from the KMS server at the server interface; and
authenticating the device at the server interface if the first and second tag_rsp vectors match.

77. The method of claim 76, wherein the method further comprises:
sending the encoded genSessionKey command from the server interface to the device;
decoding the encoded genSessionKey command at the device using a current state of a Hummingbird encryption engine at the device;
generating a second session key from a series of cipher text values at the device wherein the second session key matches the session key generated by the KMS server; and
loading the second session key into the Hummingbird encryption engine at the device and initializing the Hummingbird encryption engine using the iv to ready the device for subsequent data transformations.

78. The method of claim 77, wherein method further comprises loading an encryption engine at the server interface with the session key from the AA packet and initializing the encryption engine using the iv from the session record.

79. The method of claim 78, wherein the method further comprises using a current state of the encryption engine at the device to generate a first session key check vector and sending the first session key check vector to the server interface.

80. The method of claim 79, wherein the method further comprises:
using a current state of a second encryption engine at the server interface to generate a second session key check vector using a procedure similar to that used by the device;
comparing the second session key check vector with the first session key check vector received from the device at the server interface; and
validating the device if the first and second session key check vectors match.

81. The method of claim 80, wherein the method further comprises beginning a command phase when the first and second session key check vectors match.

82. The method of claim 62, wherein the method further comprises:
generating a first session key from a series of cipher text values at the device without reinitializing a first encryption engine at the device; and
loading the first session key into the first encryption engine at the device and initializing the first encryption engine using the iv to prepare the device for subsequent data transformations.

83. The method of claim 82, wherein the method further comprises generating the AA packet at the KMS server by:
generating a second session key from a series of cipher text values using the iv, the dv and the matching key, the second session key matches the first session key generated by the device; and
including the sid and the second session key in the AA packet.

84. The method of claim 83, wherein upon receiving the AA packet sent from the KMS server to the server interface, the method further comprises:
canceling a retry timer at the server interface if the retry timer was set when the TAR packet was sent by the server interface;
loading a second encryption engine at the server interface with the second session key;
initializing the second encryption engine using the iv from the session record;
generating a random challenge vector at the server interface;
generating a reader_rsp vector as a challenge response vector at the server interface using a Hummingbird encryption algorithm; and
sending the challenge vector and the reader_rsp vector from the server interface to the device.

85. The method of claim 84, wherein upon receiving the AA packet sent from the KMS server to the server interface, the method further comprising storing the session key at the server interface.

86. The method of claim 84, wherein at the device the method further comprises:
generating a corresponding response vector using the challenge vector, the reader_rsp vector and the current state of the first encryption engine at the device;
comparing the corresponding response vector with the reader_rsp vector; and
authenticating the server interface if the corresponding response vector and the reader_rsp vector match.

87. The method of claim 86, wherein the method further comprises:
generating a first tag_rsp vector based on the current state of the first encryption engine at the device;
transmitting the first tag_rsp vector from the device to the server interface;
generating a second tag_rsp vector at the server interface;
comparing the first tag_rsp vector from the device with the second tag_rsp vector; and
authenticating the device at the server interface if the first and second tag_rsp vectors match.

88. The method of claim 87, wherein the method further comprises beginning a command phase when the first and second session key check vectors match.

89. The method of claim 62, wherein the method further comprises generating the AA packet at the KMS server by:
generating a first session key from a series of cipher text values using the iv, the dv and the matching key;
generating a random challenge vector;
generating a reader_rsp vector and a first tag_rsp vector as challenge response vectors using the matching key and a Hummingbird encryption algorithm initialized with the iv;
formatting a setSessionKey tag command containing the first session key as a parameter;
encoding the setSessionkey tag command using a preserved state of the Hummingbird encryption algorithm and a Hummingbird decryption algorithm; and
including the sid, the challenge vector, the reader_rsp vector, the first tag_rsp vector, the first session key and the encoded setSessionKey tag command in the AA packet.

90. The method of claim 89, wherein upon receiving the AA packet sent from the KMS server to the server interface, the method further comprises:
canceling a retry timer at the server interface if the retry timer was set when the TAR packet was sent by the server interface; and
forwarding the challenge vector and the reader_rsp vector from the server interface to the device.

91. The method of claim 90, wherein at the device the method further comprises:
generating a corresponding response vector using the challenge vector, the reader_rsp vector and the current state of a first encryption engine at the device;
comparing the corresponding response vector with the reader_rsp vector; and
authenticating the server interface if the corresponding response vector and the reader_rsp vector match.

92. The method of claim 91, wherein the method further comprises:
generating a second tag_rsp vector based on the current state of the first encryption engine at the device;
transmitting the second tag_rsp vector from the device to the server interface;
generating a third tag_rsp vector at the server interface;
comparing the second tag_rsp vector from the device with the third tag_rsp vector at the server interface; and
authenticating the device at the server interface if the second and third tag_rsp vectors match.

93. The method of claim 92, wherein the method further comprises sending the encoded setSessionKey tag command from the server interface to the device if the second and third tag_rsp vectors match.

94. The method of claim 93, wherein the method further comprises:
encrypting the encoded setSessionKey tag command at the device which causes decoding of the command and the session key contained therein; and
executing the setSessionKey tag command at the device by loading the session key into a Hummingbird encryption engine at the device and initializing the engine using the iv.

95. The method of claim 94, wherein the method further comprises:
loading the session key into a Hummingbird encryption/decryption engine at the device;
initializing the Hummingbird encryption/decryption engine at the server interface using the iv that was previously stored in the session record;
using a current state of the encryption engine at the device to generate a first session key check vector and sending the first session key check vector to the server interface;
using a current state of the encryption engine at the server interface to generate a second session key check vector using a similar procedure as was used by the device;
comparing the first and second session key check vectors; and
validating the device if the first and second key check vectors match.

96. The method of claim 95, wherein the method further comprises beginning a command phase when the first and second session key check vectors match.

97. The method of claim 62, wherein the method further comprises generating the AA packet at the KMS server by including the sid and the matching key which is a secret key of the device.

98. The method of claim 97, wherein upon receiving the AA packet sent from the KMS server to the server interface, the method further comprises:
canceling a retry timer at the server interface if the retry timer was set when the TAR packet was sent by the server interface;
storing the secret key in a session record referenced by the sid;
loading a first encryption engine at the server interface with the secret key;
initializing the first encryption engine using the iv from the session record;
generating a random challenge vector at the server interface;
generating a reader_rsp vector as a challenge response vector at the server interface using a Hummingbird encryption algorithm; and
sending the challenge vector and the reader_rsp vector from the server interface to the device.

99. The method of claim 98, wherein at the device the method further comprises:
generating a corresponding response vector using the challenge vector, the reader_rsp vector and a current state of the encryption engine at the device;
comparing the corresponding response vector with the reader_rsp vector; and
authenticating the server interface if the corresponding response vector and the reader_rsp vector match.

100. The method of claim 99, wherein the method further comprises:
generating a first tag_rsp vector based on a current encryption engine state at the device;
transmitting the first tag_rsp vector from the device to the server interface;
generating a second tag_rsp vector at the server interface;
comparing the first tag_rsp vector from the device with the second tag_rsp vector; and
authenticating the device at the server interface if the first and second tag_rsp vectors match.

101. The method of claim 100, wherein the method further comprises beginning a command phase when the first and second session key check vectors match.

102. The method of claim 60, wherein the KMS server is an intermediate KMS server and the method further comprises:
creating a session record at the intermediate KMS server in response to the TAR packet using the sid as a reference;
initiating a search of a first key list at the intermediate KMS server using parameters in the TAR packet; and
propagating the TAR packet to a root KMS server if the search fails.

103. The method of claim 102, wherein the method further comprises:
creating a second session record at the root KMS server in response to the TAR packet using the sid as a reference;
initiating a search of a second key list at the root KMS server using the parameters in the TAR packet; and
propagating the TAR packet to an authority KMS server if the search fails.

104. The method of claim 103, wherein the method further comprises:
creating a third session record at the authority KMS server in response to the TAR packet using the sid as a reference;
initiating a search of a third key list at the authority KMS server using the parameters in the TAR packet; and
sending an affirmative authentication (AA) packet to the root KMS server if the search was successful and a matching key was found, the AA packet having a type based on the type code.

105. The method of claim 104, wherein the method further comprises generating the AA packet at the authority KMS server by including the sid, and the matching key in the AA packet, wherein the matching key is the secret key of the device.

106. The method of claim 105, wherein upon receiving the AA packet sent from the authority KMS server to the root KMS server, the method further comprises at the root KMS server:
canceling a first retry timer at the root KMS server if the retry timer was set when the TAR packet was sent by the root KMS server;
storing the secret key at the root KMS server if the root KMS server is a caching server; and
transmitting the AA packet to the intermediate KMS server.

107. The method of claim 106, wherein upon receiving the AA packet sent from the root KMS server to the intermediate KMS server, the method further comprises at the intermediate KMS server:
canceling a second retry timer at the intermediate KMS server if the second retry timer was set when the TAR packet was sent by the intermediate KMS server;
storing the secret key at the intermediate KMS server if the intermediate KMS server is a caching server;
generating a session key from a series of cipher text values using the iv, the dv and the matching key;
generating a random challenge vector;
generating a reader_rsp vector and a tag_rsp vector as challenge response vectors using the matching key and a Hummingbird encryption algorithm initialized with the iv;
formatting a setSessionKey tag command containing the session key as a parameter;
encoding the setSessionkey tag command using a preserved state of the Hummingbird encryption algorithm and a Hummingbird decryption algorithm;
including the sid, the challenge vector, the reader_rsp vector, the tag_rsp vector, the first session key and the encoded setSessionKey tag command in a second AA packet; and
sending the second AA packet to the server interface.

108. The method of claim 102, wherein the method further comprises:
creating a second session record at the root KMS server in response to the TAR packet using the sid as a reference;
initiating a search of a second key list at the root KMS server using the parameters in the TAR packet; and
sending a negative acknowledge packet to the intermediate KMS server since the root KMS server is an authoritative KMS server for this domain and is unable to find a matching key.

109. The method of claim 108, wherein the method further comprises:
consulting a list of alternate domains at the intermediate KMS server to check with for authorization; and
sending the TAR packet to a second authority KMS server in the list of alternate domains to attempt for authentication when the negative acknowledge packet is received at the intermediate KMS server.

110. The method of claim 109, wherein the method further comprises:
generating a third session record at the second authority KMS server in response to the TAR packet using the sid as a reference;
initiating a search of a third key list at the second authority KMS server using the parameters in the TAR packet; and
sending an affirmative authentication (AA) packet to the intermediate KMS server if the search was successful and a matching key was found, the AA packet having a type based on the type code.

111. The method of claim 110, wherein the method further comprises generating the AA packet at the second authority KMS server by including the sid, and the matching key in the AA packet, wherein the matching key is the secret key of the device.

112. The method of claim 111, wherein upon receiving the AA packet sent from the second authority KMS server to the intermediate KMS server, the method further comprises at the intermediate KMS server:
canceling a retry timer at the intermediate KMS server if the retry timer was set when the TAR packet was sent by the intermediate KMS server;
storing the secret key if the intermediate KMS server is a caching server;
generating a session key from a series of cipher text values using the iv, the dv and the matching key;
generating a random challenge vector;
generating a reader_rsp vector and a tag_rsp vector as challenge response vectors using the matching key and a Hummingbird encryption algorithm initialized with the iv;
formatting a setSessionKey tag command containing the session key as a parameter;
encoding the setSessionkey tag command using a preserved state of the Hummingbird encryption algorithm and a Hummingbird decryption algorithm;
including the sid, the challenge vector, the reader_rsp vector, the tag_rsp vector, the session key and the encoded setSessionKey tag command in a second AA packet; and
sending the second AA packet to the server interface.

113. The method of claim 60, wherein the method further comprises:
generating a random challenge vector, a reader_rsp response vector and a first tag_rsp response vector at the KMS server using a matching key that corresponds to the device;
generating a corresponding response vector and a second tag_rsp vector at the device;
comparing the corresponding response vector with the reader_rsp vector at the device to authenticate the server interface; and
comparing the second tag_rsp vector and the first tag_rsp vector at the server interface to authenticate the device.

114. The method of claim 113, wherein the method further comprises:
generating a session key and an encoded genSessionKey command at the KMS server using the matching key;
decoding the encoded genSessionKey command at the device to generate a second session key at the device;
generating a first session key check vector at the device;
generating a second session key check vector at the server interface; and
validating the device at the server interface if the first and second session key check vectors match.

115. The method of claim 60, wherein the method further comprises:
generating a first session key at the device;
generating a second session key at the KMS server using a matching key that corresponds to the device;
generating a random challenge vector, a reader_rsp response vector and a first tag_rsp response vector based on the second session key at the server interface;
generating a corresponding response vector and a second tag_rsp vector at the device based on the first session key;
comparing the corresponding response vector with the reader_rsp vector at the device to authenticate the server interface; and
comparing the second tag_rsp vector and the first tag_rsp vector at the server interface to authenticate the device.

116. The method of claim 113, wherein the method further comprises:
generating a session key and an encoded setSessionKey command at the KMS server using the matching key;
decoding the encoded setSessionKey command at the device to generate a second session key at the device;
generating a first session key check vector at the device;
generating a second session key check vector at the server interface; and
validating the device at the server interface if the first and second session key check vectors match.

117. The method of claim 60, wherein the method further comprises:
sending the matching key that corresponds to the device from the KMS server to the server interface;
generating a random challenge vector, a reader_rsp response vector and a first tag_rsp response vector based on the matching key at the server interface;
generating a corresponding response vector and a second tag_rsp vector at the device based on the challenge vector;
comparing the corresponding response vector with the reader_rsp vector at the device to authenticate the server interface; and
comparing the second tag_rsp vector and the first tag_rsp vector at the server interface to authenticate the device.

118. The method of claim 60, wherein the method further comprises:
sending the TAR packet along a path to successively higher security level KMS servers according to a hierarchy of the KMS system until a matching key is found that corresponds to the device;
generating an affirmative authentication packet at the higher security level KMS server at which the matching key was located; and
propagating the affirmative authentication packet along the path to the server interface.

119. The method of claim 60, wherein the method further comprises:
sending the TAR packet to a higher security level KMS server to locate a matching key that corresponds to the device;
consulting a list of alternate domains if a negative acknowledge packet is received from the higher security level KMS server in order to identify a KMS server in an alternate domain;
sending the TAR packet to the KMS server in the alternate domain to locate the matching key; and
repeatedly performing the consulting and sending steps until the matching key is located or every KMS server in the list of alternate domains has been checked.

120. The method of claim 119, wherein the method further comprises:
generating an affirmative authentication packet at the KMS server in the list of alternate domains if the matching key is located; and
sending the affirmative authentication packet to the server interface if the matching key is located.

121. The method of claim 60, wherein the method comprises using a KMS local server, a KMS distribute server or a KMS root server as the server interface.

122. A computer readable medium comprising a plurality of instructions executable on a processor of an electronic device for adapting the electronic device to implement a method of providing cryptographic key management servers (KMS) in a system wherein the method is defined according to claim 60.
